(19) United States
(12) Patent Application Publication
(10) Pub. No.: US 2023/0289211 A1
(43) Pub. Date: Sep. 14, 2023

(54) Techniques for Scalable Load Balancing of Thread Groups in a Processor

(71) Applicant: NVIDIA Corporation, Santa Clara, CA (US)

(72) Inventors: Gentaro HIROTA, San Jose, CA (US); Tanmoy MANDAL, Saratoga, CA (US); Jeff TUCKEY, Saratoga, CA (US); Kevin STEPHANO, San Francisco, CA (US); Chen MEI, Shanghai (CN); Shayani DEB, Seattle, WA (US); Naman GOVIL, Sunnyvale, CA (US); Rajballav DASH, San Jose, CA (US); Ronny KRASHINSKY, Portola Valley, CA (US); Ze LONG, San Jose, CA (US); Brian PHARRIS, Cary, NC (US)

(21) Appl. No.: 17/691,872

(22) Filed: Mar. 10, 2022

(51) Int. Cl. G06F 9/48; G06F 9/50

(52) U.S. Cl. CPC G06F 9/4843; G06F 9/505

(57) ABSTRACT

A processor supports new thread group hierarchies by centralizing work distribution to provide hardware-guaranteed concurrent execution of thread groups in a thread group array through speculative launch and load balancing across processing cores. Efficiencies are realized by distributing grid rasterization among the processing cores.

### CROSS-REFERENCES TO RELATED APPLICATIONS

This application is related to the following commonly-assigned copending US patent applications, the entire contents of each of which are incorporated by reference:
U.S. application Ser. No. 17/691,276 (Atty. Dkt. No. 6610-91//20-SC-0403US01) filed Mar. 10, 2022, titled “Method And Apparatus For Efficient Access To Multidimensional Data Structures And/Or Other Large Data Blocks”;
U.S. application Ser. No. 17/691,621 (Atty. Dkt. No. 6610-92//20-AU-0519US01) filed Mar. 10, 2022, titled “Cooperative Group Arrays”;
U.S. application Ser. No. 17/691,690 (Atty. Dkt. No. 6610-93//20-AU-0561US01) filed Mar. 10, 2022, titled “Distributed Shared Memory”;
U.S. application Ser. No. 17/691,759 (Atty. Dkt. No. 6610-94//20-SC-0549US01) filed Mar. 10, 2022, titled “Virtualizing Hardware Processing Resources in a Processor”;
U.S. application Ser. No. 17/691,288 (Atty. Dkt. No. 6610-97//20-SC-0612US01) filed Mar. 10, 2022, titled “Programmatically Controlled Data Multicasting Across Multiple Compute Engines”;
U.S. application Ser. No. 17/691,296 (Atty. Dkt. No. 6610-98//20-SH-0601US01) filed Mar. 10, 2022, titled “Hardware Accelerated Synchronization With Asynchronous Transaction Support”;
U.S. application Ser. No. 17/691,303 (Atty. Dkt. No. 6610-99//20-WE-0607US01) filed Mar. 10, 2022, titled “Fast Data Synchronization In Processors And Memory”;
U.S. application Ser. No. 17/691,406 (Atty. Dkt. No. 6610-102//21-DU-0028US01) filed Mar. 10, 2022, titled “Efficient Matrix Multiply and Add with a Group of Warps”;
U.S. application Ser. No. 17/691,808 (Atty. Dkt. No. 6610-106//21-SC-1493US01) filed Mar. 10, 2022, titled “Flexible Migration of Executing Software Between Processing Components Without Need For Hardware Reset”; and
U.S. application Ser. No. 17/691,422 (Atty. Dkt. No. 6610-115//20-SC-0403US02) filed Mar. 10, 2022, titled “Method And Apparatus For Efficient Access To Multidimensional Data Structures And/Or Other Large Data Blocks”.

### STATEMENT REGARDING FEDERALLY SPONSORED RESEARCH OR DEVELOPMENT

None.

### BACKGROUND & SUMMARY

Users want deep learning and high performance computing (HPC) compute programs to continue to scale as graphics processing unit (GPU) technology improves and the number of processing core units increases per chip with each generation. What is desired is a faster time to solution for a single application, not scaling only by running N independent applications.

The modern GPU is a multi-processor system. The number of processors (we call them “streaming multiprocessors” or “SMs”, but other vendors may call them by other names such as “execution units” or “cores”) per GPU increases from generation to generation and it is becoming more challenging to scale the application program performance proportional to the size of GPU. FIG. 1A shows example deep learning (DL) networks comprising long chains of sequentially-dependent compute-intensive layers. Each layer is calculated using operations such as e.g., multiplying input activations against a matrix of weights to produce output activations. The layers are typically parallelized across a GPU or cluster of GPUs by dividing the work into output activation tiles each representing the work one SM or processing core will process.

Due to the potentially massive number of computations deep learning requires, faster is usually the goal. And it makes intuitive sense that performing many computations in parallel will speed up processing as compared to performing all those computations serially. In fact, the amount of performance benefit an application will realize by running on a given GPU implementation typically depends entirely on the extent to which it can be parallelized. But there are different approaches to parallelism.

Conceptually, to speed up a process, one might have each parallel processor perform more work or one might instead keep the amount of work on each parallel processor constant and add more processors. Consider an effort to repave a highway several miles long. You as the project manager want the repaving job done in the shortest amount of time in order to minimize traffic disruption. It is obvious that the road repaving project will complete more quickly if you have several crews working in parallel on different parts of the road. But which approach will get the job done more quickly—asking each road crew to do more work, or adding more crews each doing the same amount of work? It turns out that the answer depends on the nature of the work and the resources used to support the work.

The weak scaling example of FIG. 1B shows the activation tile each processing core runs growing in size, signifying that each processing core does more work. The strong scaling example of FIG. 1C meanwhile keeps the amount of work each processing core performs constant (a fixed size network is indicated by a fixed tile size) and increases the number of processing cores operating in parallel (as indicated by the ellipsis). An application that exhibits linear strong scaling has a speedup equal to the number of processors used. See https://docs.nvidia.com/cuda/cuda-c-best-practices-guide/index.html; https://hpc-wiki.info/hpc/Scaling_tests. For some applications such as DL training, the problem size will generally remain constant and hence only strong scaling is applicable.

Users of such applications thus typically want strong scaling, which means a single application can achieve higher performance without having to change its workload—for instance, by increasing its batch size to create more inherent parallelism. Users also expect increased speed performance when running existing (e.g., recompiled) applications on new, more capable GPU platforms offering more parallel processors. As detailed below, GPU development has met or even exceeded the expectations of the marketplace in terms of more parallel processors and more coordination/cooperation between increased numbers of parallel execution threads running on those parallel processors—but further performance improvements to achieve strong scaling are still needed.

Increased GPU Computation Parallelism and Complexity

Over the years, GPU hardware has become increasingly more complex and capable to achieve increased parallelism. For example, FIG. 2A shows an older GPU architecture providing a streaming execution model with 16 SMs in clusters (GPCs) of four SMs each, with each SM representing a substantial portion of the GPU real estate. In this context, an SM or “streaming multiprocessor” means a processor architected as described in U.S. Pat. No. 7,447,873 to Nordquist including improvements thereto and advancements thereof, and as implemented for example in many generations of NVIDIA GPUs. In many cases, such SMs have been constructed to provide fast local shared memory enabling data sharing/reuse and synchronization between all threads executing on the SM.

In contrast, the FIG. 2B illustration of a more recent GPU shows a dramatic increase in parallel computation ability including a very large number of (e.g., 128 or more) SMs each representing only a small portion of the GPU real estate—with both math computation hardware and number of parallel processing cores within each SM also growing over time.

FIG. 2C shows an example architectural diagram of a modern SM including advanced compute hardware capabilities comprising many parallel math cores including multiple tensor cores in addition to texture processing units. For example, the 2017 NVIDIA Volta GV100 SM is partitioned into four processing blocks, each with 16 FP32 Cores, 8 FP64 Cores, 16 INT32 Cores, two mixed-precision Tensor Cores for deep learning matrix arithmetic, an L0 instruction cache, one warp scheduler, one dispatch unit, and a 64 KB Register File—and future GPU designs are likely to continue this trend. Such increased compute parallelism enables dramatic decreases in compute processing time.

Meanwhile, FIGS. 3 and 4 illustrate that modern GPUs may provide a variety of different hardware partitions and hierarchies. In these examples, SMs within a GPU may themselves be grouped into larger functional units. For example, Graphics Processing Clusters (GPCs) of a GPU may comprise plural Texture Processing Clusters (TPCs) and an additional array of Streaming Multiprocessors (SMs) (e.g., for compute capabilities) along with other supporting hardware such as ray tracing units for real time ray tracing acceleration. Each SM in turn may be partitioned into plural independent processing blocks, each with one or several different kinds of cores (e.g., FP32, INT32, Tensor, etc.), a warp scheduler, a dispatch unit, and a local register file.

FIGS. 5 and 5A show how some GPU implementations (e.g., NVIDIA Ampere) may enable plural partitions that operate as micro GPUs such as μGPU0 and μGPU1, where each micro GPU includes a portion of the processing resources of the overall GPU. When the GPU is partitioned into two or more separate smaller μGPUs for access by different clients, resources—including the physical memory devices 165 such as local L2 cache memories—are also typically partitioned. For example, in one design, a first half of the physical memory devices 165 coupled to uGPU0 may correspond to a first set of memory partition locations and a second half of the physical memory devices 165 coupled to uGPU1 may correspond to a second set of memory partition locations. Performance resources within the GPU are also partitioned according to the two or more separate smaller processor partitions. The resources may include level two cache (L2) resources 170 and processing resources 160. One embodiment of such a Multi-Instance GPU (“MIG”) feature allows the GPU to be securely partitioned into many separate GPU Instances for CUDA (“Compute Unified Device Architecture”) applications, providing multiple users with separate GPU resources to accelerate their respective applications.

For more information on such prior GPU hardware and how it has advanced, see for example U.S. Pat. Nos. 8,112,614; 7,506,134; 7,836,118; 7,788,468; U.S. Ser. No. 10/909,033; US20140122809; Lindholm et al, “NVIDIA Tesla: A Unified Graphics and Computing Architecture,” IEEE Micro (2008); https://docs.nvidia.com/cuda/parallel-thread-execution/index.html (retrieved 2021); Choquette et al, “Volta: Performance and Programmability”, IEEE Micro (Volume: 38, Issue: 2, March/April 2018), DOI: 10.1109/MM.2018.022071134.

Cooperative Groups API Software Implementation

To take advantage of increased parallelism offered by modern GPUs, NVIDIA in CUDA Version 9 introduced a software-based “Cooperative Groups” API for defining and synchronizing groups of threads in a CUDA program to allow kernels to dynamically organize groups of threads. See e.g., https://developer.nvidia.com/blog/cooperative-groups/ (retrieved 2021); https://developer.nvidia.com/blog/cuda-9-features-revealed/ (retrieved 2021); Bob Crovella et al, “Cooperative Groups” (Sep. 17, 2020), https://vimeo.com/461821629; US2020/0043123.

Before Cooperative Groups API, both execution control (i.e., thread synchronization) and inter-thread communication were generally limited to the level of a thread block (also called a “cooperative thread array” or “CTA”) executing on one SM. The Cooperative Groups API extended the CUDA programming model to describe synchronization patterns both within and across a grid or across multiple grids and thus potentially (depending on hardware platform) spanning across devices or multiple devices.

The Cooperative Groups API provides CUDA device code APIs for defining, partitioning, and synchronizing groups of threads—where “groups” are programmable and can extend across thread blocks. The Cooperative Groups API also provides host-side APIs to launch grids whose threads are all scheduled by software-based scheduling to be launched concurrently. These Cooperative Groups API primitives enable additional patterns of cooperative parallelism within CUDA, including producer-consumer parallelism and global synchronization across an entire thread grid or even across multiple GPUs, without requiring hardware changes to the underlying GPU platforms.

For example, the Cooperative Groups API provides a grid-wide (and thus often device-wide) synchronization barrier (“grid.sync( )”) that can be used to prevent threads within the grid group from proceeding beyond the barrier until all threads in the defined grid group have reached that barrier. Such device-wide synchronization is based on the concept of a grid group (“grid_group”) defining a set of threads within the same grid, scheduled by software to be resident on the device and schedulable on that device in such a way that each thread in the grid group can make forward progress. Thread groups could range in size from a few threads (smaller than a warp) to a whole thread block, to all thread blocks in a grid launch, to grids spanning multiple GPUs. Newer GPU platforms such as NVIDIA Pascal and Volta GPUs enable grid-wide and multi-GPU synchronizing groups, and Volta's independent thread scheduling enables significantly more flexible selection and partitioning of thread groups at arbitrary cross-warp and sub-warp granularities.

The Cooperative Groups API thus provided for cooperative/collaborative threads across or even beyond a grid, but had certain limitations. For example, Cooperative Groups API used software rather than hardware to provide concurrent execution. Without concurrency guarantees on the hardware level, additional API calls were typically necessary to assess GPU occupancy in order to predict whether a grid group could launch—and determining SM occupancy was thus in many cases left up to the software application. Additionally, while certain hardware support for system-wide synchronization/memory barriers were provided on some platforms, high performance mechanisms for efficiently sharing data bandwidth across thread blocks running on different SMs and thus across a device or devices were lacking. As one significant example, the inability to leverage data reads efficiently across multiple SMs often would result in redundant data retrievals—creating performance bottlenecks in which data bandwidth could not keep up with computation bandwidth. Because the Cooperative Groups API was software based, it could not solve these challenges on the hardware level. See e.g., Zhang et al, A Study of Single and Multi-device Synchronization Methods in NVIDIA GPUs, (arXiv:2004.05371v1 [cs.DC] 11 Apr. 2020); Lustig et al, “A Formal Analysis of the NVIDIA PTX Memory Consistency Model”, Proceedings of the Twenty-Fourth International Conference on Architectural Support for Programming Languages and Operating Systems, Pages 257-270 (April 2019) https://doi.org/10.1145/3297858.3304043; Weber et al, “Toward a Multi-GPU Implementation of the Modular Integer GCD Algorithm Extended Abstract” ICPP 2018, August 13-16, Eugene, Oreg. USA (ACM 2018); Jog et al, “OWL: Cooperative Thread Array Aware Scheduling Techniques for Improving GPGPU Performance” (ASPLOS' 13, Mar. 16-20, 2013, Houston, Tex., USA).

Data Bandwidth has not Kept Up with Processing Bandwidth

While it has been possible to increase the math throughput for each generation of new GPU hardware, it is becoming increasingly more difficult to feed the SMs or other collection of processing core(s) (e.g., tensor cores) in new GPU hardware with enough data to maintain strong scaling. FIG. 6 compares math bandwidth (number of multiply-add calculations per clock per SM) for different types of math calculations (e.g., tensor floating point 32-bit precision, floating point 16 precision, “brain” floating point 16-bit precision, integer 8-bit precision, integer 4-bit precision, and binary) for various different GPU generations and also for different data presentations (sparse and dense). The left-hand side of FIG. 6 shows how theoretical math compute bandwidth has increased exponentially as GPU computation hardware capability increased (e.g., by adding massively parallel SMs with tensor or other cores to the GPU). Meanwhile though, the right-hand side of FIG. 6 shows that a corresponding data bandwidth requirement to keep the GPU computation hardware supplied with data has not kept pace.

Experience has shown that memory bandwidth and interconnect bandwidth (e.g., from the memory system into the SMs) do not scale as well as processing bandwidth. The FIG. 7 flowchart of basic data flows within a GPU system (i.e., from interconnects to system DRAM memory to L2 cache memory to shared memory in L1 cache to math compute processors within SMs) to support tensor core and other math calculations demonstrates that to achieve strong scaling, it is necessary to improve speeds & feeds and efficiency across all levels (end to end) of the compute and memory hierarchy.

Various techniques such as memory management improvements, caching improvements, etc. have been tried and implemented to increase data bandwidth. However, adding more data bandwidth via wires costs area and power. Adding more caches costs area and power. What is needed is a way to harness more parallelism inherent in the algorithm(s) while more efficiently using the processing cores and cache/interconnect hierarchies that are available today and in the future—without requiring radical overhauling and complicating of the memory access/management hierarchy. Meanwhile, once a new hardware platform is provided that solves such data bandwidth problems, it would be highly desirable to provide efficient load balancing of work across the hardware platform's concurrent parallel processing resources.

### BRIEF DESCRIPTION OF THE DRAWINGS

FIG. 1A shows an example application running on a GPU.

FIG. 1B shows a weak scaling deep learning scenario.

FIG. 1C shows a strong scaling deep learning scenario.

FIGS. 2A and 2B illustrate increased GPU hardware parallelism.

FIG. 2C is a block architectural diagram of a recent streaming multiprocessor within a GPU.

FIG. 3 shows example prior art GPU hardware partitions.

FIG. 4 shows an example prior art GPU hardware with graphics processing clusters.

FIG. 5 shows example prior art μGPC partitions.

FIG. 5A is a block architectural diagram of a recent GPU architecture including streaming multiprocessors and associated interconnects partitioned in to different μGPC partitions.

FIG. 6 shows example increased math throughput and associated data bandwidths for different GPU generations.

FIG. 7 shows example need to improve speeds & feeds and efficiency across all levels of compute and memory hierarchy to achieve strong scaling.

FIG. 8 shows an example prior art grid of CTAs.

FIG. 9 shows an example of how the prior art grids of CTAs map onto GPU hardware partitions.

FIG. 10A illustrates an example prior art grid of CTAs.

FIG. 10B illustrates an example new CGA hierarchy.

FIG. 11A shows an example prior art grid of CTAs.

FIG. 11B shows an example new CGA hierarchy that groups CTAs into CGAs.

FIGS. 12, 12A show example CGA grid arrangements.

FIG. 13 shows a block diagram including a compute work distributor circuit interacting with other related circuits.

FIG. 14 shows an example compute work distributor circuit block diagram including an improved CGA load balancer.

FIG. 15 shows a hierarchical compute work distributor circuit including hardware work distributor circuits used to distribute CTAs to SMs within different hardware partition levels.

FIGS. 16-1, 16-2 show example non-limiting flowchart of hardware-implemented operational steps including speculative or “shadow state” launch of CGAs to provide hardware-based concurrency guarantees.

FIG. 16A shows an example flow chart showing speculative or “shadow state” launch using load balancing.

FIG. 16B shows an example CGA launch operation including speculative or shadow state launch to a hardware-based query model, saving reservation information if the speculative or shadow state launch is successful, and then actually launching the CGA (on real hardware as opposed to the query model) using the saved reservation information.

FIG. 17 shows example communication between source and target SMs.

FIGS. 18A-18D show inter-SM communications.

FIG. 19 is another view of inter-SM communications.

FIG. 20 is a flowchart of non-program counter error checking.

FIG. 21 shows an example non-limiting load balancing scenario.

FIGS. 21A-21Z, 21AA-21II are together a flip chart animation (I) showing how the compute work distributor can distribute CTAs within a CGA to SMs.

FIGS. 22 and 23 are a continuation of the flip chart animation showing load balanced distribution of the last CTAs of an example grid.

FIGS. 24, 25A-25G, 26 & 27 are together another flip chart animation (II) showing how the compute work distributor can distribute CTAs within a CGA to SMs within example embodiments.

FIGS. 28A-28C together are a flip chart animation (III) that shows how the compute work distributor can load balance distribution of CTAs within a CGA across multiple partitions or hierarchies of GPU hardware.

### DETAILED DESCRIPTION OF EXAMPLE NON-LIMITING EMBODIMENTS

One way to achieve or aim toward scaling is through load distribution and load balancing. Generally speaking, load balancing is a process whereby a fixed amount of (e.g., processing) resources are allocated to an arbitrary amount of incoming tasks. A simple example of load balancing is what many of us experience each time we refuel our cars. We drive into a fueling station and pull up to a fuel pump that currently does not have a car next to it. When we are finished pumping fuel into our car, we pull away and another car can take our place. If the fueling station is busy, some cars may need to wait in line for a pump to become available. Cars sometimes change from one line to another depending on how long it takes for different motorists to finish pumping fuel into their respective cars, complete credit card or other payment transactions, etc. In the busy fueling station, the idea is keep every pump nearly 100% occupied pumping fuel—even though for various reasons this is not always possible (e.g., different vehicles have differently sized fuel tanks and so can take longer or shorter times to fuel, some drivers quickly pay outside with a credit card while others pay inside in cash, some drivers want to check their oil or wash their windshields, etc.).

Similar load balancing considerations apply to the loading of SMs or other processing resources in the highly parallel system of a modern GPU—although the techniques used to load balance work in a modern GPU are typically more complex than managing cars at a fueling station. In particular, it is desirable to distribute compute work evenly across the SMs or other processing resources so that all such resources keep busy executing instructions and all resources free up for more work at about the same time. However, for various reasons, one execution thread or set of threads may take longer to process than another execution thread or set of threads. The ability of the GPU to maximize use of processing resources by exploiting characteristics of the work and dynamically allocating the work as capacity becomes available can have a huge impact on overall efficiency and processing time. See e.g., Chen et al, “Dynamic load balancing on single- and multi-GPU systems”, 2010 IEEE International Symposium on Parallel & Distributed Processing (IPDPS), 2010, pp. 1-12, doi: 10.1109/IPDPS.2010.5470413; Lin et al, “Efficient Workload Balancing on Heterogeneous GPUs using Mixed Integer Non-Linear Programming”, Journal of Applied Research and Technology Volume 12, Issue 6, Pages 1176-1186 (December 2014), https://doi.org/10.1016/S1665-6423(14)71676-1; U.S. Pat. Nos. 9,715,413; 9,524,138; 9,069,609; 8,427,474; 8,106,913; 8,087,029; 8,077,181; 7,868,891; US20050041031.

For starters, to scale the performance, uniform utilization across SMs is typically very helpful. The load balancing in example GPU embodiments is therefore desirably centralized at a single unit such as a CWD (=Compute Work Distributor). Because the CWD is centralized, it can compare the workload of all SMs at once to achieve the ideal uniformity. However, in example embodiments, the nature of the work and amount of concurrent parallelism is changed significantly as compared to prior GPU architectures. Specifically, the concept of a “Cooperative Group Array” introduces substantial additional complexity in load balancing but also substantial additional opportunities for effective load balancing to dramatically increase the overall processing efficiency and throughput of the GPU.

Prior CTA Grid Hierarchy

The granularity of “work” to be load balanced in one example context can be the “cooperative thread array” or CTA (=Cooperative Thread Array). Prior CUDA programming models use the CTA as the fundamental building block of parallelism for GPU software (SW). In one such model, a CTA can have up to 1024 threads and all threads are guaranteed to launch and execute simultaneously on the same SM. In such model, because one SM runs all threads in the CTA, the threads can take advantage of the shared memory resources within and/or connected to the SM to share data, synchronize, communicate, etc. between threads—assuring data locality and data re-use across the concurrently-executing threads. In such model, each thread of the CTA may be allocated its own resources such as private memory, and synchronization typically occurs on the thread level.

In such SM-based programming models, a CTA declares some amount of shared memory local to the SM on which the CTA runs. This shared memory exists for the lifetime of the CTA and is visible to all the threads in the CTA. Threads within a CTA can communicate with each other through this shared memory for both data sharing and synchronization. Shader instructions (e.g., “_syncthreads( )”) exist to do barrier synchronization across all threads in a CTA. For example, to coordinate the execution of threads within the CTA, one can use barrier instructions to specify synchronization points where threads wait until all other threads in the CTA have arrived. See e.g., U.S. Pat. No. 10,977,037.

Meanwhile, an SM's warp scheduler schedules all warps in a CTA for concurrent execution on the SM to guarantee that all threads in a CTA execute concurrently. In modern GPUs, an SM has parallel compute execution capacity that meets or exceeds the maximum number of threads in a CTA—meaning that the entire CTA (or in some cases, plural CTAs) can execute simultaneously on the same SM.

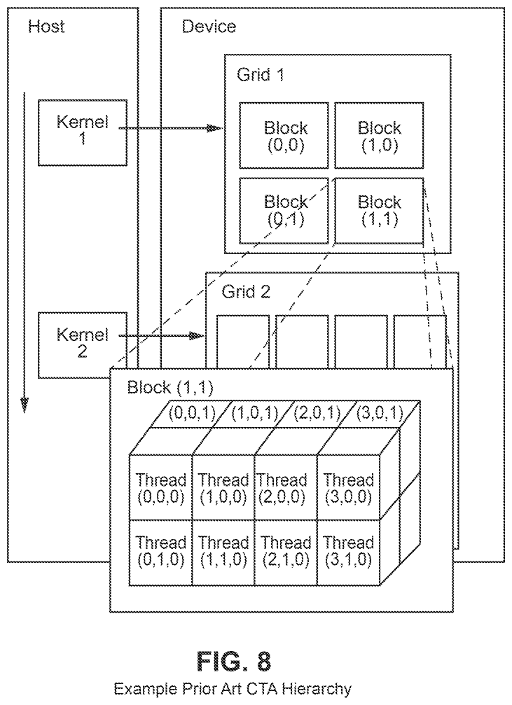

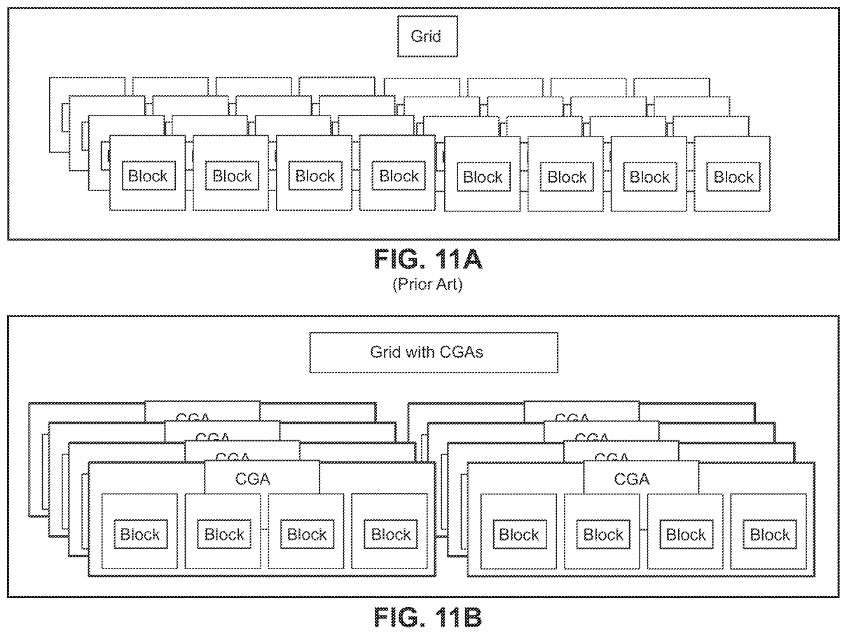

Because many applications require more than 1024 threads, an original CUDA programming model for compute applications is based on a “grid” (a collection of CTAs is called a “grid” because it is or can be represented by a multi-dimensional array). FIGS. 8 and 11A show an example hierarchy in which a grid comprises plural CTAs. Each SM schedules concurrent execution of a number of (e.g., 32 or other programmable value) threads grouped together as “warps” (using a textile analogy). Generally, a warp executes in a SIMD fashion on an SM, i.e., all threads in the warp share the same instruction stream and execute together in lockstep (this is sometimes referred to as single-instruction multiple-threads, or SIMT).

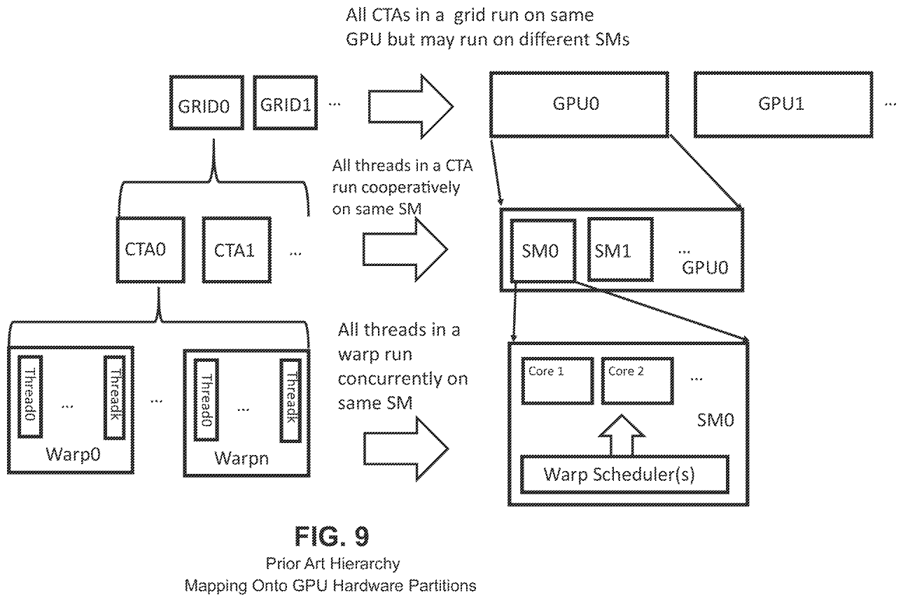

Inasmuch as a single CTA executing on a single SM is the fundamental unit of parallelism for software in the prior model, the GPU hardware in the prior model does not guarantee any cooperation at a higher level (e.g., the Grid level) across CTAs. As FIG. 9 shows, all CTAs in a grid run on the same GPU, share the same kernel and can communicate via global memory. But in the prior model, the different CTAs of a Grid may execute all at the same time on the GPU hardware, or they may run sequentially—depending for example on the size of the GPU and the load caused by this Grid or other Grids. By the prior model executing these CTAs independently on different SMs potentially at different times, it is not possible to share operations (e.g., memory data retrieval, synchronization, etc.) efficiently between them. And even if they do execute concurrently (such as under the Cooperative Groups API), they may not be able to efficiently share memory or data bandwidth to provide tight cooperative coupling across the group. For example, if a grid were split into plural CTAs, it would be legal from a hardware standpoint for the machine to run those CTAs non-concurrently—causing deadlock if an algorithm needed both or all CTAs to run concurrently and pass information back and forth.

The CTA programming model described above has served developers well, providing data locality and data re-use at the SM level, for many years and many generations of GPUs. However, as discussed above, over time GPUs have become much larger, for example containing over 100 SMs per GPU, and the interconnect to L2 cache and the memory system is no longer a flat crossbar but is hierarchical and reflective of hierarchical hardware domain levels (e.g., GPU, μGPU, GPC, etc.). In such more advanced GPUs, mechanisms defining the SM as the basic unit of data locality are often too small of a granularity. To maximize performance and scalability, what is needed is a new programming/execution model that allows software to control locality and concurrency at a unit much larger than a single SM (which is now <1% of the GPU) while still maintaining the ability to share data and synchronize across all threads like a CTA. An application should be able to control data locality and data re-use to minimize latency. This is especially true for Deep Learning and HPC applications that want to do strong scaling (see above) by creating a cooperating set of threads across large sections of GPU hardware.

Cooperative Group Arrays

The example non-limiting embodiments herein provide a new level(s) of hierarchy—“Cooperative Group Arrays” (CGAs)—and an associated new programming/execution model and supporting hardware implementation that provides efficient load balancing that distributes all the concurrent work of such as CGA efficiently across available processing and other hardware resources. See above-identified U.S. application Ser. No. 17/691,621 (Atty. Dkt. No. 6610-92//20-AU-0519US01) filed Mar. 10, 2022, titled “Cooperative Group Arrays”.

In one embodiment, a CGA is a collection of CTAs where hardware guarantees that all CTAs of the CGA are launched to the same hardware organization level the CGA specifies or is associated with. The hardware is configured to make sure there are enough processing resources in the target hardware level to launch all CTAs of the CGA before launching any, and load balances the CTAs across such processing resources to maximize overall execution speed and throughput.

As FIG. 11B shows, a grid is an array of CGAs, and each CGA is an array of CTAs. In this context, “CGA” and “cluster” are synonymous and “CTAs” are a kind of “thread block”. Such CGAs provide co-scheduling, e.g., control over where CTAs are placed/executed in the GPU, relative to the memory required by an application and relative to each other. This enables applications to see more data locality, reduced latency, and better synchronization between all the threads in tightly cooperating clusters or arrays of CTAs.

For example, CGAs let an application take advantage of the hierarchical nature of the interconnect and caching subsystem in modern GPUs and make it easier to scale as chips grow in the future. By exploiting spatial locality, CGAs allow more efficient communication and lower latency data movement. GPU hardware improvements guarantee that threads of plural CTAs the new CGA hierarchical level(s) define will run concurrently for desired spatial localities, by allowing CGAs to control where on the machine the concurrent CTA threads will run relative to one another.

As discussed above, in one embodiment, CGAs are composed of CTAs that are guaranteed by hardware to launch and execute simultaneously/concurrently. The CTAs in a CGA may—and in the general case will—execute on different SMs within the GPU. Even though the CTAs execute on different SMs, the GPU hardware/system nevertheless provides a cross-SM guarantee that the CTAs in a CGA will be scheduled to execute concurrently. Such a high performance parallel launch capability of all CTAs of a CGA can, as explained in detail below, be supported by load balancing algorithms to further increase performance and throughput. The GPU hardware/system also provides efficient mechanisms by which the concurrently-executing CTAs can communicate with one another. This allows an application to explicitly share data between the CTAs in a CGA and also enables synchronization between the various threads of the CTAs in the CGA.

In example embodiments, the various threads within the CGA can read/write from common shared memory—enabling any thread in the CGA to share data with any other thread in the CGA. Sharing data between CTAs in the CGA saves interconnect and memory bandwidth which is often the performance limiter for an application. CGAs thus increase GPU performance. As explained above, in prior programming models it was generally not possible to directly share data between two CTAs because there was no guarantee that both CTAs would be running simultaneously in the same relevant hardware domain. Without CGAs, if two CTAs needed to share the same data, they generally would each have to fetch it from memory—using twice the bandwidth. This is like two parents each going to the store to buy milk. In contrast, effectively exploiting data locality is known to be important to GPU performance. See e.g., Lal et al, “A Quantitative Study of Locality in GPU Caches”, in: Orailoglu et al (eds), Embedded Computer Systems: Architectures, Modeling, and Simulation, (SAMOS 2020), Lecture Notes in Computer Science, vol 12471. Springer, Cham. https://doi.org/10.1007/978-3-030-60939-9_16

Now, using the concurrent execution and additional shared memory supported by hardware, it is possible to directly share data between threads of one CTA and threads of another CTA—enabling dependencies across CTAs that can bridge hardware (e.g., cross-SM) partitions.

Because CGAs guarantee all their CTAs execute concurrently with a known spatial relationship, other hardware optimizations are possible such as:
Load balancing across a GPU or a partition of a GPU
Efficiently communicating certain information such as grid identifiers by broadcasting the identifiers to all SMs that are concurrently executing CTAs of a CGA Sharing memory within one SM with another (or a plurality of other) SMs
Multicasting data returned from memory to multiple SMs (CTAs) to save interconnect bandwidth
Direct SM-to-SM communication for lower latency data sharing and improved synchronization between producer and consumer threads in the CGA
Hardware barriers for synchronizing execution across all (or any) threads in a CGA
and more (see copending commonly-assigned patent applications listed above).

These features provide higher performance by more efficiently using processing resources, amplifying memory and interconnect bandwidth, reducing memory latency, and reducing the overhead of thread-to-thread communication and synchronization. Thus, all of these features ultimately lead to strong scaling of the application.

New Levels of Hierarchy—CGAs

In example embodiments, a CGA is made up of plural CTAs—that is, plural collections or bundles of threads structured to execute cooperatively. Each such collection or bundle of threads provides all of the advantages and structure that have long been provided by prior CTAs—such as for example running on the same SM. However, the additional overlay the CGA provides defines where and when the CTAs will run, and in particular, guarantees that all CTAs of a CGA will run concurrently within a common hardware domain that provides dynamic sharing of data, messaging and synchronization between the CTAs, and the possibility of load balancing the CTAs across a collection of processing resources that may span an arbitrary number of SMs.

Example embodiments support different types/levels of CGAs directed to different GPU hardware domains, partitions or other organization levels. Specifically, a CGA can define or specify the hardware domain on which all CTAs in the CGA shall run. By way of analogy, just as local high school sports teams might compete in local divisions, regions, or statewide, a CGA could require the CTAs it references to all run on the same portion (GPC and/or μGPU) of a GPU, on the same GPU, on the same cluster of GPUs, etc. Meanwhile, load balancing hardware in the form of a centralized work distributor can be used to balance the loading by the CTAs within the CGA of all SMs within that collection of hardware such as a GPC and/or μGPU, GPU and/or cluster of GPUs.

Example Hierarchical Hardware Collections/Partitioning

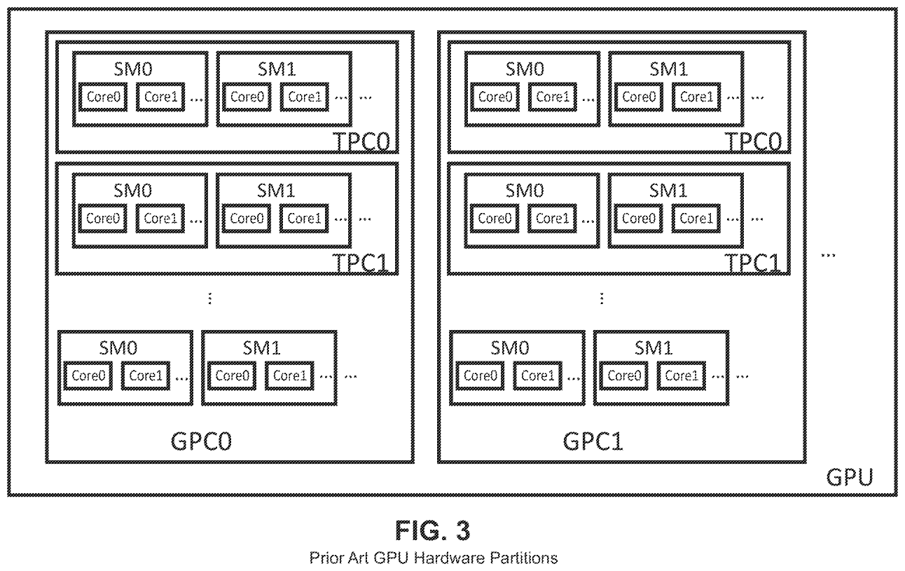

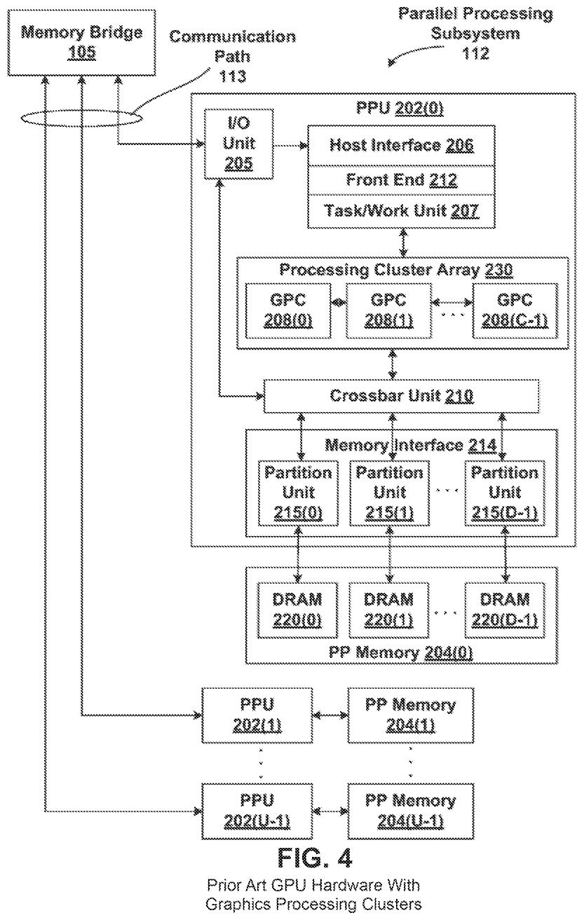

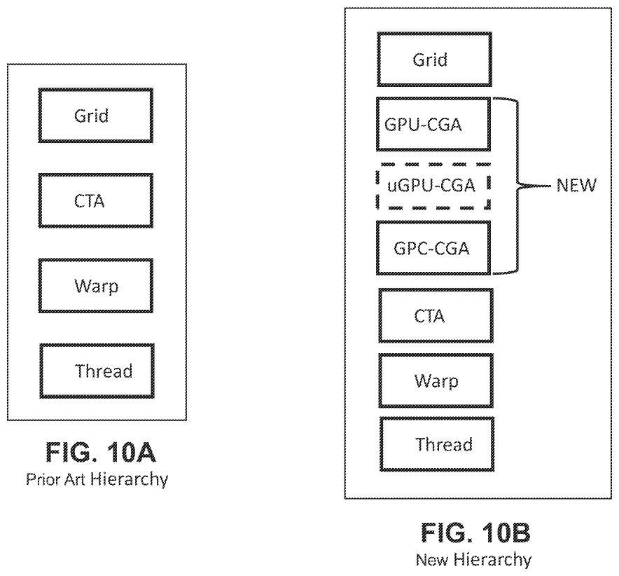

In example embodiments, the hierarchies the CGAs define/specify, are tied to or otherwise reflect GPU hardware partitions reflective of memory access and/or communications capabilities, in order to provide desired resource and data re-use and data locality. For example, just as a GPU may comprise plural GPCs as FIGS. 3 and 4 show, a GPU_CGA may be made up of plural GPC_CGAs. FIG. 10B shows an example CGA hierarchy providing additional nested hierarchy levels reflective of different hardware domains relative to the prior art FIG. 10A situation, for example:
GPU_CGAs
μGPU-CGAs
GPC_CGAs.

In example non-limiting embodiments, hardware guarantees concurrent launch of all of the CTAs within a certain CGA onto SMs that are part of a hardware domain specified by a hardware domain specifier associated with that certain CGA, for example:
all the CTAs for a GPU_CGA are launched onto SMs that are part of the same GPU;
all the CTAs for a μGPU_CGA are launched onto SMs that are part of the same
all the CTAs for a GPC_CGA are launched onto SMs that are part of the same GPC.
   Furthermore, the same launch hardware can load-balance the CTAs of the CGA across the processing resources of a GPU, μGPU and/or GPC to achieve higher processing efficiencies and throughput.

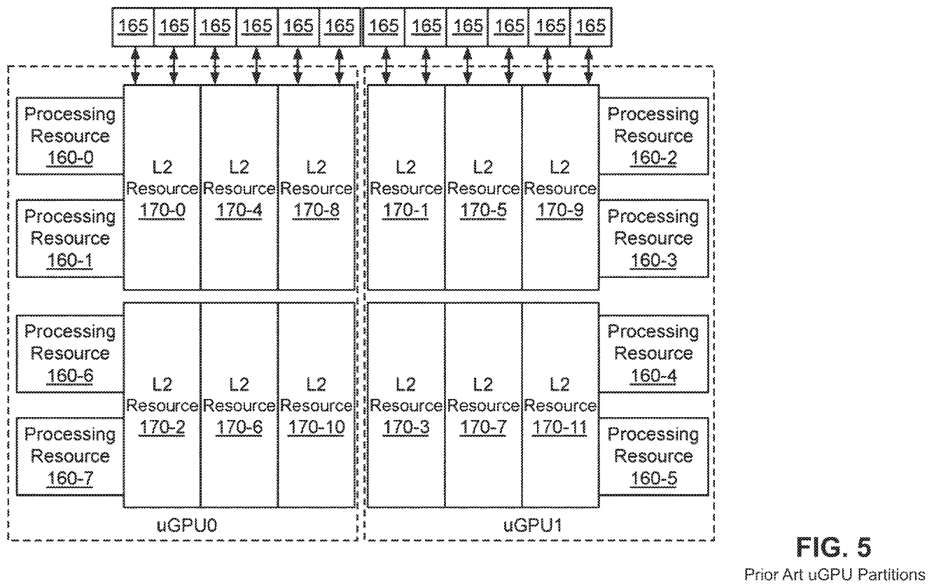

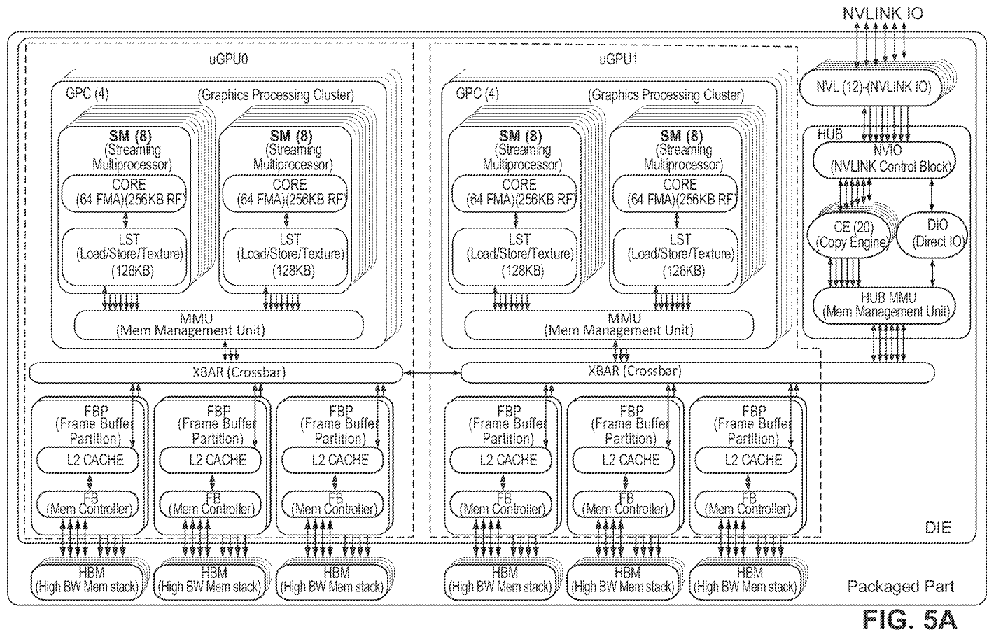

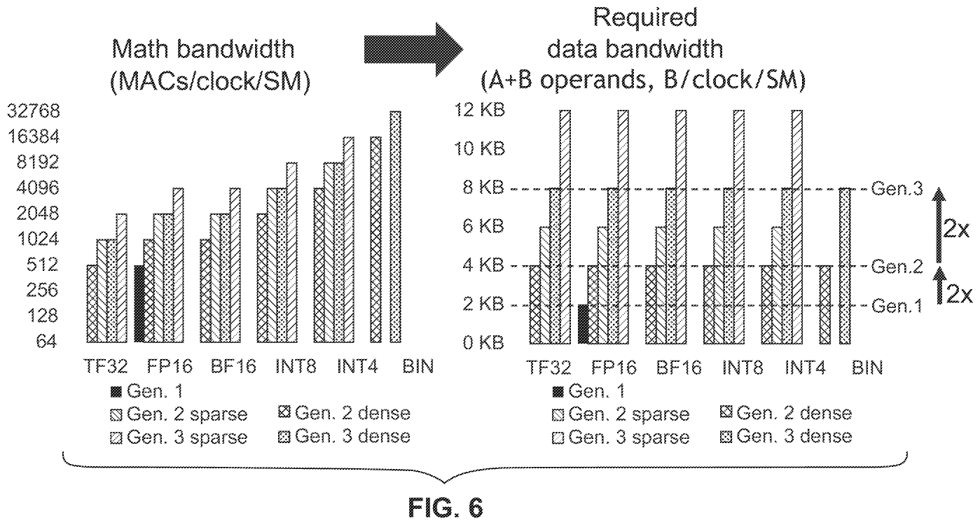

In more detail, some embodiments of CGAs also support μGPU partitions such as shown in FIGS. 5, 5A and provide several new capabilities and hardware guarantees such as:
CGAs provide new levels of hierarchy for threads between the Grid (kernel) level and CTA level
GPC_CGAs place all CTAs within the same GPC
μGPU_CGAs place all the CTAs within SMs of the same μGPU, which in some implementations matches the memory interconnect hierarchy within large GPUs
GPU_CGAs place all CTAs within the same GPU
ABC_CGAs place all CTAs within the ABC hardware domain where “ABC” is any GPU hardware domain, organization or hierarchy within or across the GPU architecture(s).

These example levels (Grid, GPU_CGA, μGPU_CGA, GPC_CGA, and CTA—see FIG. 10B)) can be nested to further control the placement of SM resources at each level. For example, a GPU_CGA can be made up of μGPU_CGAs, which is made of GPC_CGAs, which is made of CTAs. Such nesting can support conventional dynamic parallelism for each and all levels of the hierarchy. See e.g., https://developer.nvidia.com/blog/cuda-dynamic-parallelism-api-principles/

Example Cooperative Group Array Grids

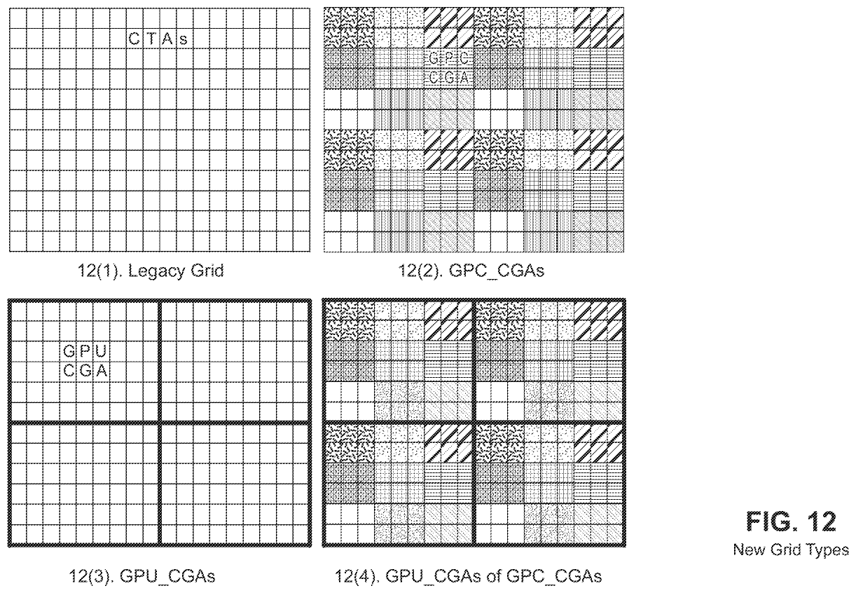

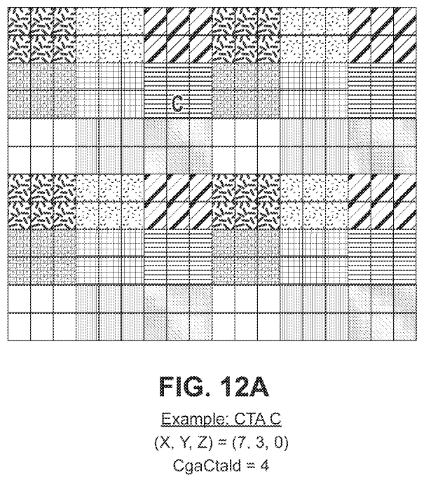

With the addition of CGAs, there are now many more possible Grid types examples of which are shown in FIGS. 12, 12A, with each grid type specifying or otherwise being associated with a particular hardware domain:

FIG. 12(1): Grid of CTAs—This is a legacy grid. In an embodiment, this grid represents a three-dimensional grid (X×Y×Z) of CTAs. An example dimension for the grid could for example be 18×12×1 CTAs.

FIG. 12(2): GPC_CGA Grid of CTAs—a three-dimensional grid of CTAs for each GPC_CGA are launched together and always placed on the same GPC. Thus, the hardware domain this type of grid specifies is “GPC”. The commonly-patterned adjacent squares in the grid constitute CGAs that will be scheduled to run at the same time. Thus, the six CTAs marked “G P C C G A” will all be launched together on the same GPC, and none will launch until they can all be launched together. An example grid dimension is 6×6×1 GPC CGAs, with each GPC CGA having dimensions of 3×2×1 CTAs. In one example, a GPC_CGA supports SM-to-SM communication, CGA linear memory in global memory, and a hardware-based CGA barrier.

FIG. 12(3): Grid of GPU_CGAs of CTAs—This is a grid where the CTAs for each GPU_CGA are launched together and always placed on the same GPU. Thus, the hardware domain specified by this type of grid is “GPU.” In some environments, plural GPUs can be configured as clusters of GPUs; in such case, the FIG. 12(3) grid forces all CTAs of a GPU_CGA to run on a common GPU. This grid is meant as a replacement for CUDA's Cooperative Group API feature, but with coscheduling now guaranteed by hardware. Example grid dimensions are 2×2×1 GPU CGAs, each GPU CGA sub-grid comprising 9×6×1 CTAs.

FIG. 12(4): Grid of GPU_CGAs of GPC_CGAs of CTAs. This is a grid with two levels of CGA hierarchy. The GPU_CGAs have the capabilities described in FIG. 12(3) and the GPC_CGAs have the capabilities described in FIG. 12(2). Thus, this type of grid specifies two nested hardware levels: GPU and GPC. This example for example allows a developer to schedule a GPU CGA to run on a single GPU, and each GPC CGA within that GPU CGA to run on the same GPC within that GPU. Example grid size is 2×2×1 GPU CGAs, each GPU CGA sub-grid comprising 3×3×1 GPC CGAs, each GPC CGA sub-sub-grid comprising 3×2×1 CTAs.

Hardware-Based CGA Launch Guarantee & Load Balancing

In example embodiments, all CTAs in each of the CGA types described above are co-scheduled. This means the GPU hardware will not permit any CTAs in a CGA to launch unless/until there is room on the relevant GPU hardware domain for all the CTAs in the CGA to launch. This hardware guarantee allows software to count on the fact that all the threads in the CGA will be executing simultaneously, so that things like barrier synchronization and data sharing across all the threads are possible. No single CTA in a CGA can be stuck indefinitely waiting to launch—in one embodiment, either the whole CGA is launched or none of it. Furthermore, by using a centralized hierarchical CTA launch facility or circuit which we call “CWD”, it becomes possible to load balance the CTAs across the SMs of the GPU or other relevant hardware domain.

In one example arrangement, hardware maintains a count of the number of running CTAs in the CGA (i.e. CTAs that have not exited), and software may perform barrier synchronization across all threads in all running CTAs in the CGA. In example embodiments, each CGA has a (at least one) hardware barrier allocated to it, and all the CTAs in a CGA may reference that CGA hardware barrier(s). See above-identified U.S. application Ser. No. 17/691,296 (Atty. Dkt. No. 6610-98//20-SH-0601US01) filed Mar. 10, 2022, titled “Hardware Accelerated Synchronization With Asynchronous Transaction Support”. This hardware barrier is useful for example to bootstrap all the CTAs and confirm they have all been launched.

Improved Centralized Work Distributor

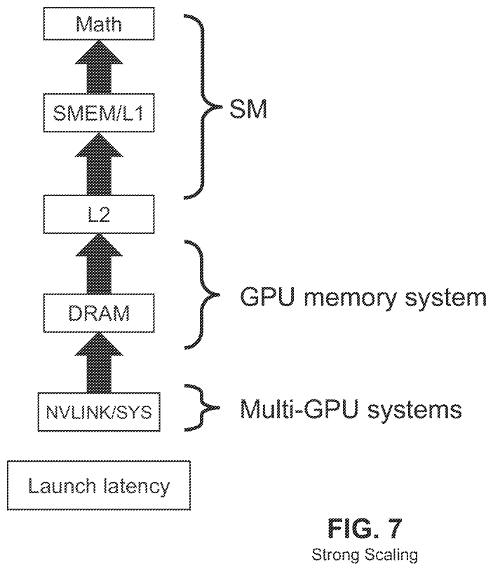

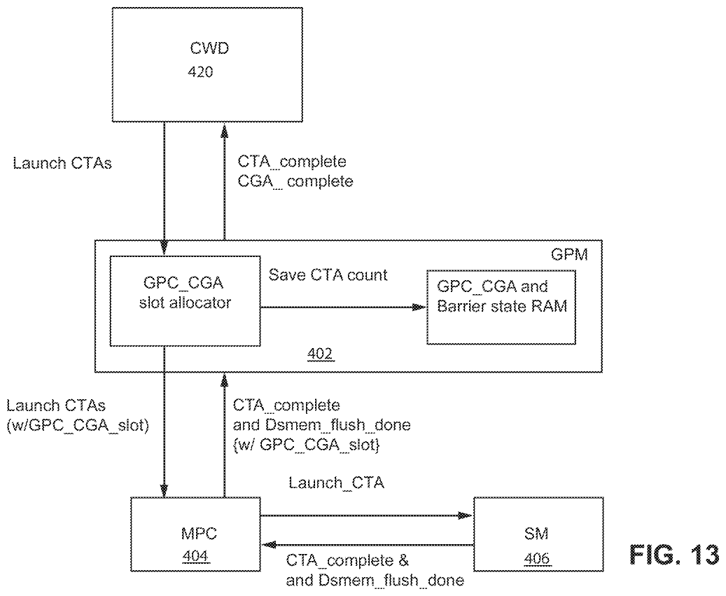

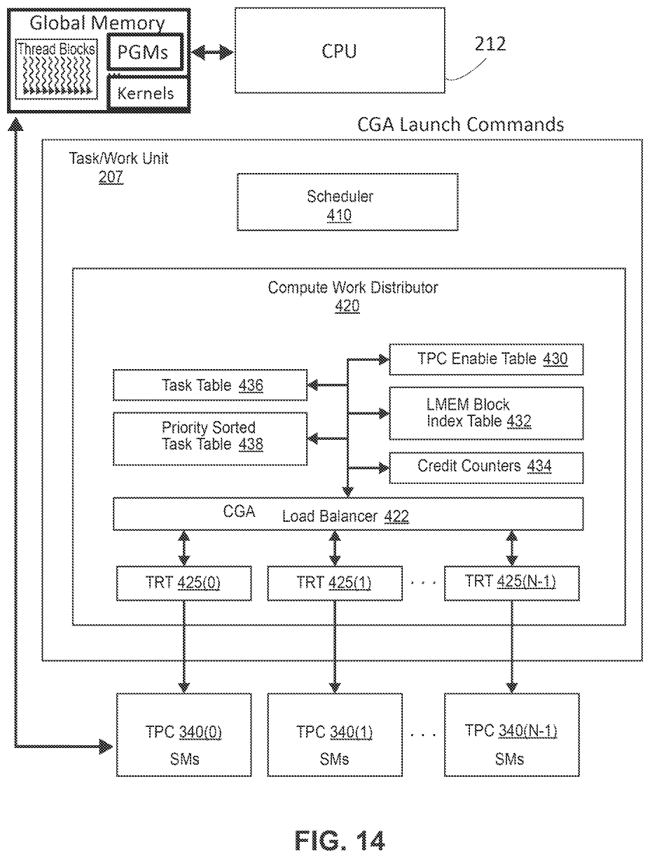

In an embodiment(s) shown in FIGS. 13, 14 & 15, a main compute work distributor (“CWD”) hardware circuit 420 is used to launch CGAs on the GPU while providing a hardware-based guarantee that all CTAs of a CGA can be launched at the same time. See for example 20200043123 and in particular FIG. 7 and associated description of that prior patent publication for more information on an example prior art GPU CWD and MPC for scheduling work and see also e.g., U.S. Pat. Nos. 10,817,338 and 9,069,609. This conventional CWD 420 while successfully used in the past has three scaling issues:
1) Load balancing: Each CTA must be launched to the least utilized SM. It is conventionally done one CTA at a time. CWD 420 compares utilization metrics among all SMs to select an SM for a CTA then CWD starts over the process for the next CTA. To launch CTAs to many SMs, this process can become very inefficient. Furthermore, the prior CWD had no good way to handle launches to different scopes of hierarchical hardware domains.
2) Rasterization throughput: Once the load balancing problem #1 is solved, the mathematical operations to generate many multi-dimensional IDs (see discussion below) would become the bottleneck.
3) CTA transmission bandwidth: Even if the above problems #1 and #2 are solved, it would be hard to transmit many multi-dimensional IDs to SMs that are physically far from CWD 420. For example, in compute APIs like CUDA, a CTA ID is 3D and expressed as a 32b-16b-16b tuple. Transmitting 64b data to many (potentially hundreds of) SMs would require massive bandwidth.

It is worth mentioning that higher CTA launch throughput is desirable in terms of grid launch overhead as well. For example, if an SM has enough resource to accommodate 8 CTAs, the prior art CWD would need more than 1000 cycles to fill all 128 SMs. This takes a long time, introducing latency and reducing efficiency.

Another issue to be addressed is load balancing of the new type of work unit described above called CGA (=Cooperative Group Array). As discussed above, a CGA can be regarded as a collection of CTAs that are co-scheduled and confined within a “GPC” (as one example). As discussed above, a GPC is a group of SMs within a GPU. For example, one example GPU architecture is made of 8 GPCs, each of which is made of 18 SMs. As discussed above, the concept of the CGA can be extended to multiple levels of hierarchy. For example, a GPC can be made of multiple “CPCs” each comprising a certain number of SMs. The example non-limiting technology herein provides a load balancing algorithm to multiple levels of CGA nesting and associated hierarchical hardware domains and scopes.

Enhanced CWD Structure and Function with Load Balancing and Speculative/Shadow State Launch

In an embodiment herein, the improved CWD 420 shown in FIGS. 13, 14 and 15 is a centralized circuit that is expanded/enhanced to provide a load-balanced speculative or shadow state CGA-based hardware launch capability to confirm that resources are available to launch all CTAs in a CGA across a relevant hardware domain. If all CTAs of a CGA cannot be launched at the same time, then the CWD 420 does not launch any of the CTAs of the CGA, but instead waits until sufficient resources of the relevant GPU hardware domain become available so that all CTAs of the CGA can be launched so they run concurrently. In example embodiments, the CWD 420 supports nesting of multiple levels of CGAs (e.g., multiple GPC-CGAs within a GPU-CGA) using a multi-level work distribution architecture that provides load balancing. Because the CWD 420 is centralized, it can look at the states of all of the SMs and make good load balancing decisions based on those states.

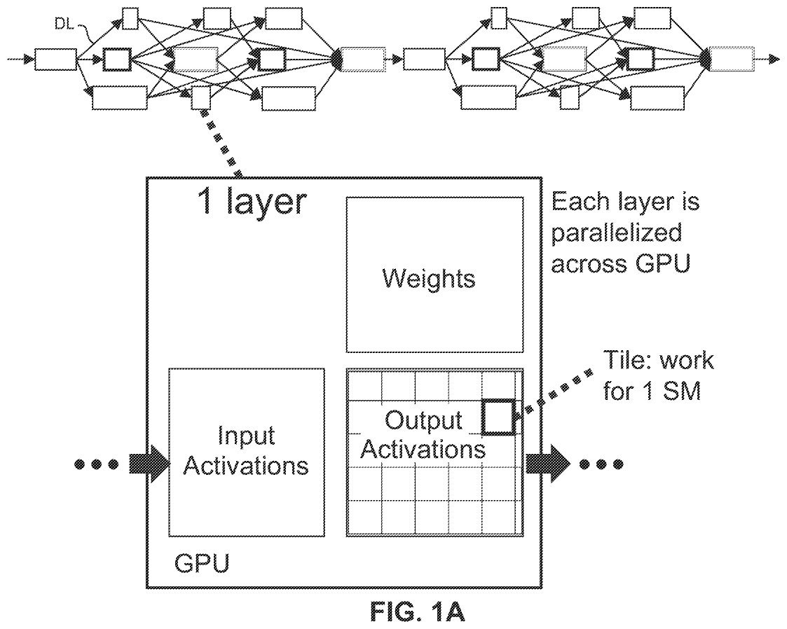

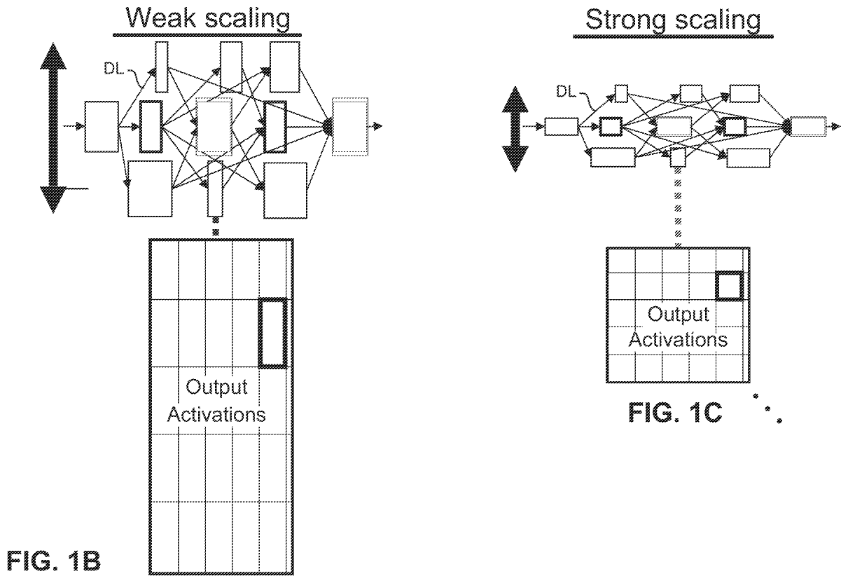

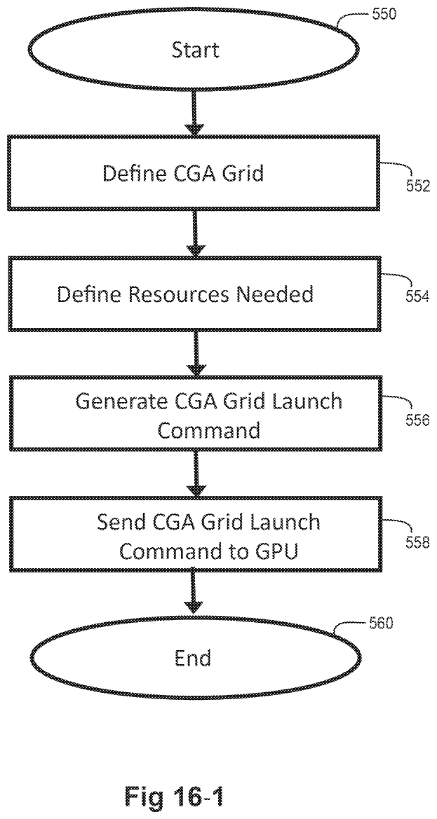

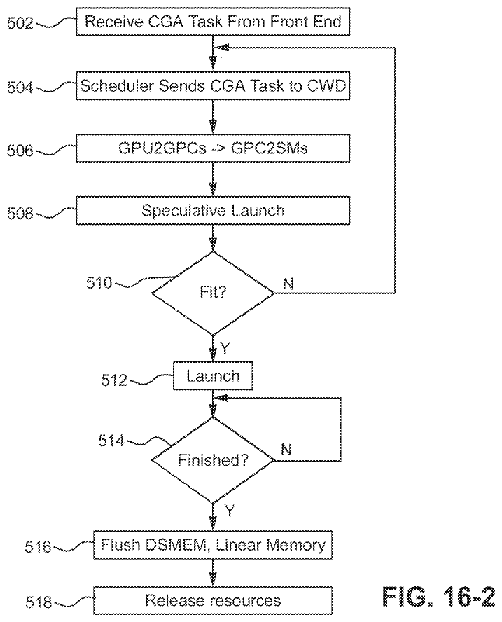

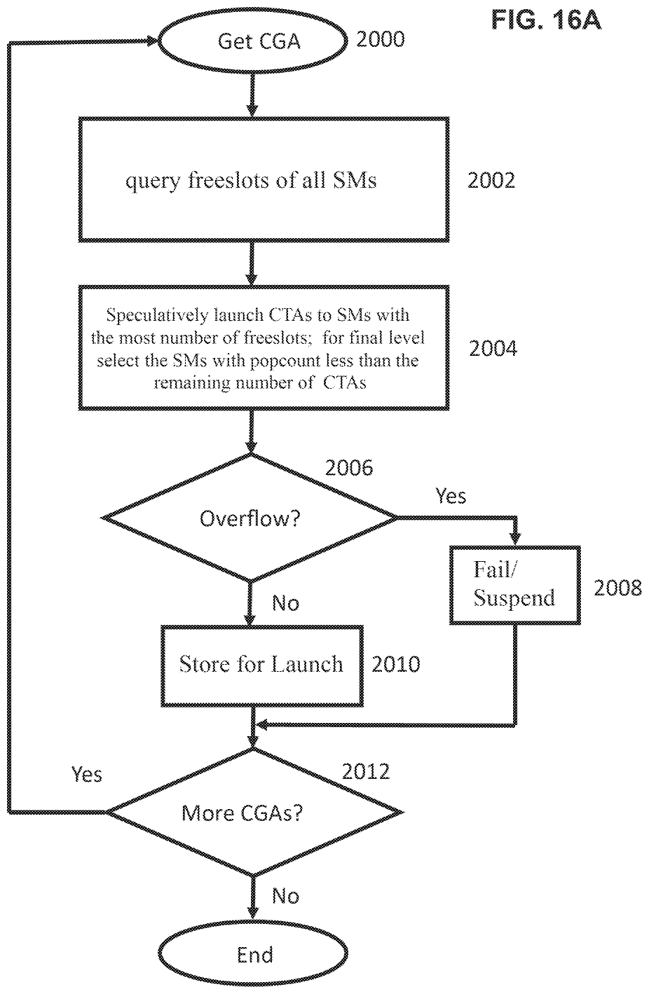

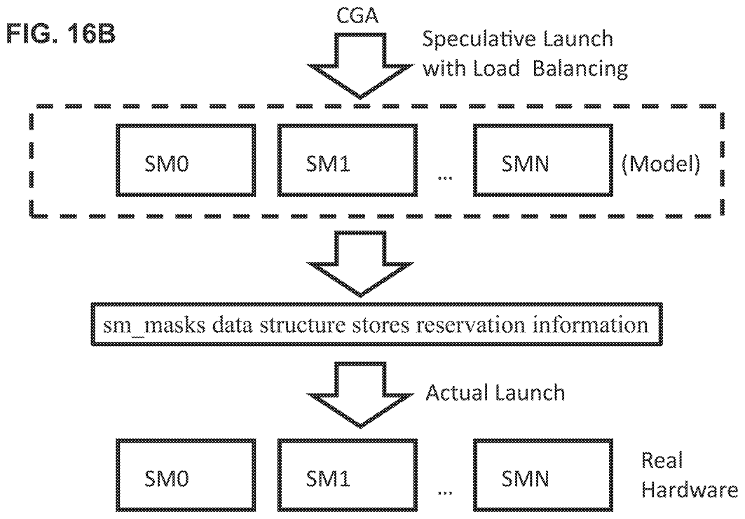

In more detail, CWD 420 shown in FIGS. 13 & 14 launches the CTAs in a CGA after determining, using a speculative or shadow state launch technique, that all CTAs of the CGA can fit on the hardware resources available in the specified hardware domain. In this way, CWD 420 in one example mode makes sure there are enough resources across all GPCs or other relevant hardware domain for all CTAs of the CGA before launching any. In one embodiment, the algorithm to launch CTAs of a CGA can borrow some techniques from legacy (non CGA) grid launch while first confirming that all CTAs of a CGA can be launched in a way that ensures they will run simultaneously. See also FIG. 16-1 showing an example flowchart for a CPU to perform operations 550-560 to generate a grid launch command and send it to the GPU for processing by CWD 420.

FIG. 14 shows a basic architecture of CWD 420, which includes a load balancer 422, resource trackers (TRTs) 425(0), 425(1), . . . 425(N−1), a TPC enable table 430, a local memory (LMEM) block index table 432, credit counters 434, a task table 436, and a priority-sorted task table 438. Each of the TRTs 425(0), 425(1), . . . 425(N−1) communicates with a corresponding TPC 340(0), 340(1), . . . 340(N−1). For more detail concerning legacy operation of these various structures, see e.g., U.S. Pat. No. 10,817,338; US20200043123; US20150178879; U.S. Pat. Nos. 10,217,183; and 9,921,873. In example embodiments, functionality of these and other structures is enhanced in example embodiments along the following lines to accommodate CGAs:

| Function/Operation | Units Enhanced |
|---|---|
| Distributed CTA rasterization | M-Pipe Controllers (MPCs) |
| New launch packets for legacy | Compute Work Distributor |
| grids/queues and CGAs | (CWD), GPM, MPC, SM |
| Wider Bundles in compute pipe & | Compute Pipe, CWD, GPM, MPC, |
| new QMD format | SM |
| Parallel load balancer for CGAs | CWD |
| CTA complete bandwidth | GPM, SMCARB |
| improvements | |
| CGA tracking and barriers | CWD, GPM, MPC, SM |
| CGA completions and DSMEM flush | GPM, MPC, SM |
| New S2R registers for multi- | SM |
| dimensional IDs | |
| Error handling for SM2SM traffic | SM |
| New GPC/TPC numbering | CWD, GPM, MPC, SM, CTXSW |
| Compute Instruction Level | MPC, SM, Trap handler |
| Preemption changes | |

Example Load Balancing

The example technology herein addresses the load balancing issue by doing load balancing for all SMs at once (e.g., as opposed to the prior approach of load balancing one SM at a time). CWD 420 first queries free slots of all SMs. The number of free slots of an SM is defined as “how many more CTAs can fit in the remaining resource (e.g. shared memory, registers, and warp IDs) of the SM”. See U.S. Pat. No. 9,921,873. The SMs can each report the number of free slots it has at the beginning of the rasterization of a grid. A count of such free slots can be maintained in the task table 436 shown in FIG. 14 (e.g., a multibit value that assigns up to a predetermined number of tasks to associated task IDs). The free slots may abstract the resource requirements the CTAs of a CGA or grid need to run on the GPU processing hardware (for example, the resources each CTA needs to run can be defined by a grid to be uniform for all CTAs in the grid such as number of execution threads, number of registers, memory allocation, etc.). The more free slots, the less the SM is utilized/occupied, which indicates that a future CTA launched to the SM will have less competition over mathematical logic and memory bandwidth, which typically results in faster execution. So free slots is a metric of the expected “speed” of the would-be-launched CTA.

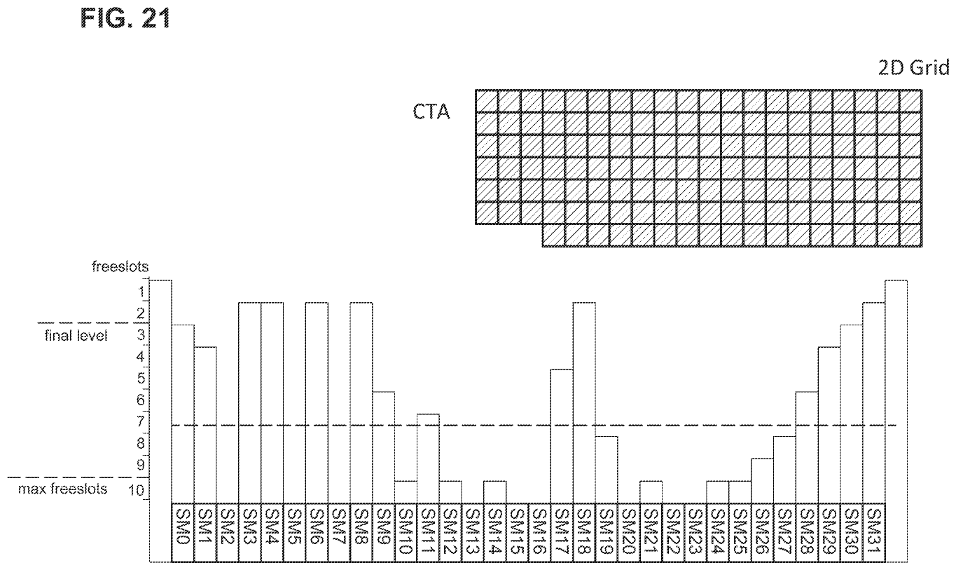

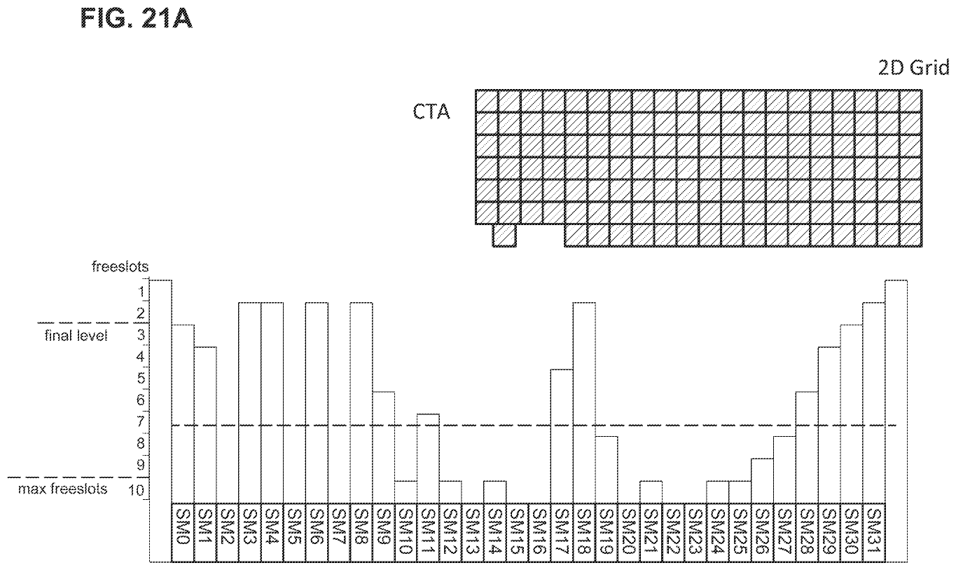

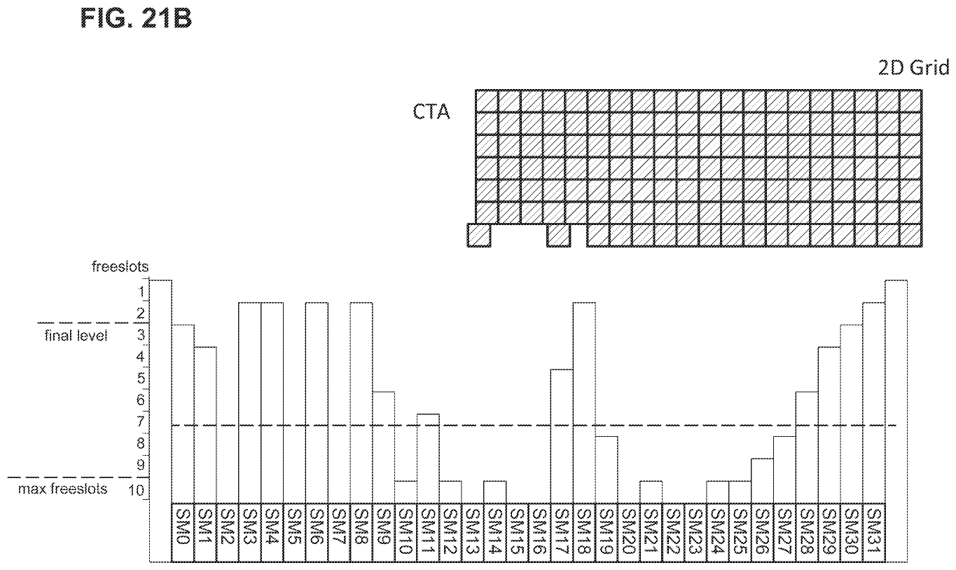

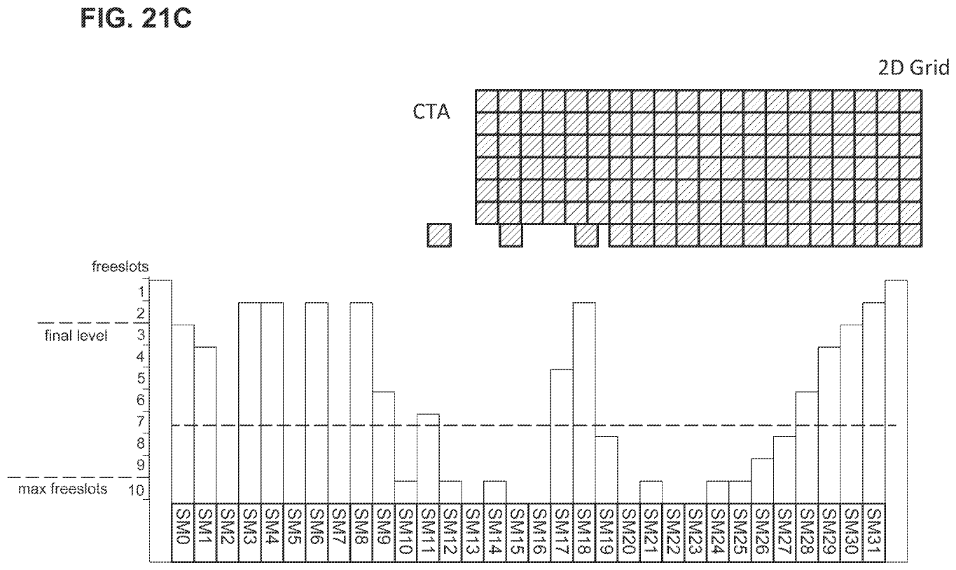

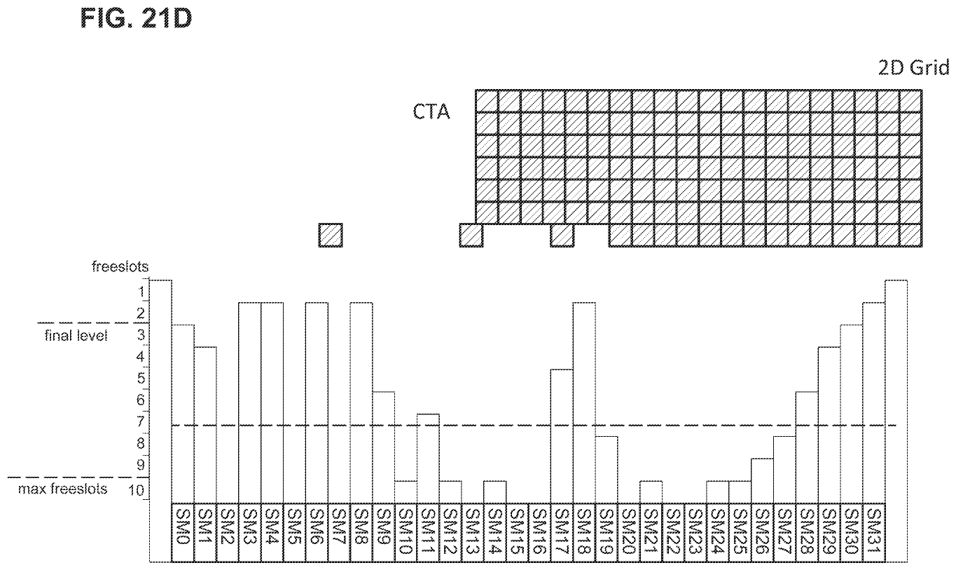

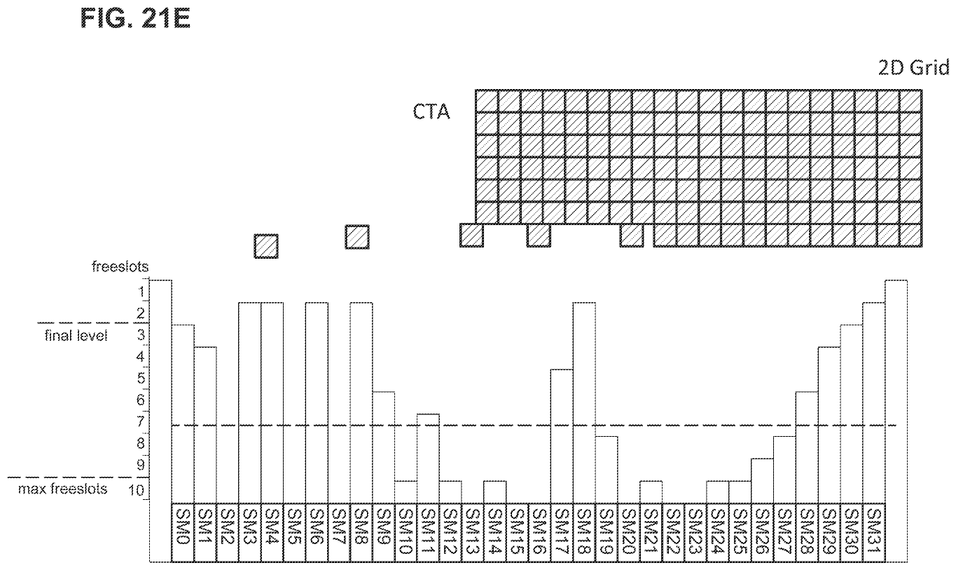

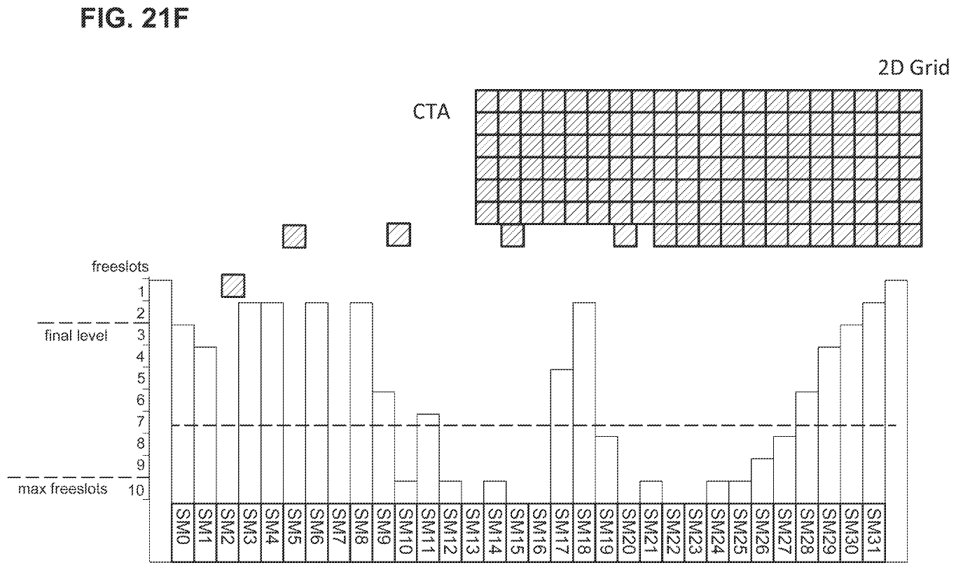

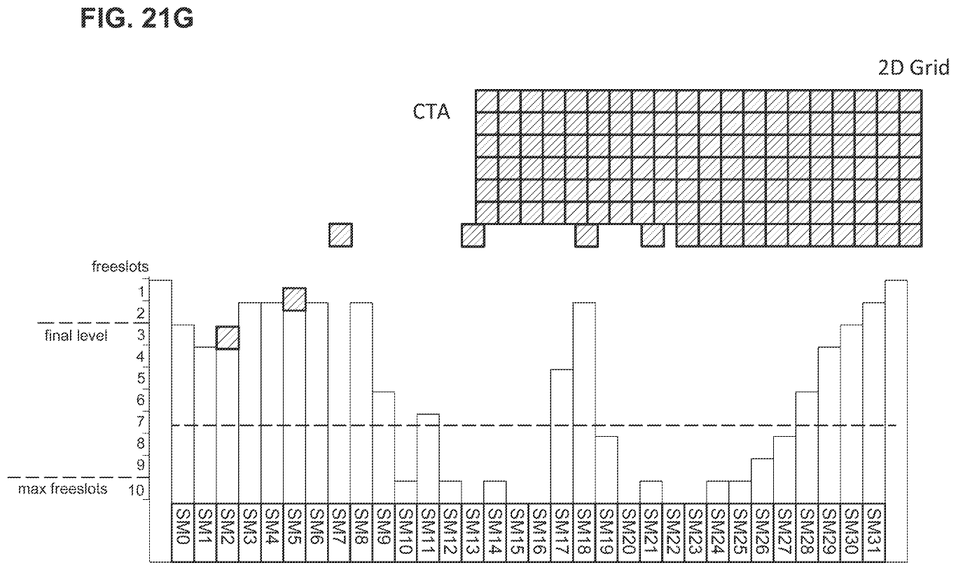

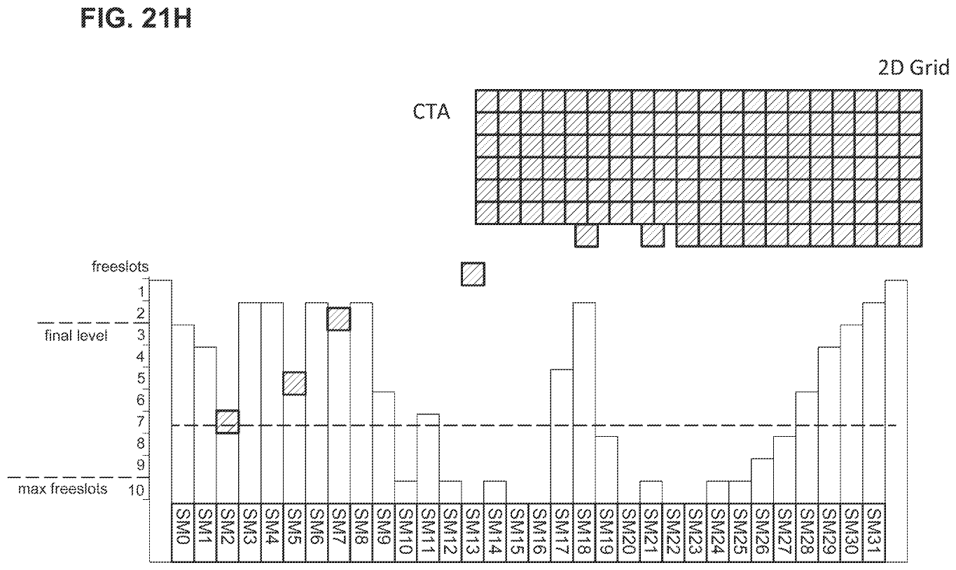

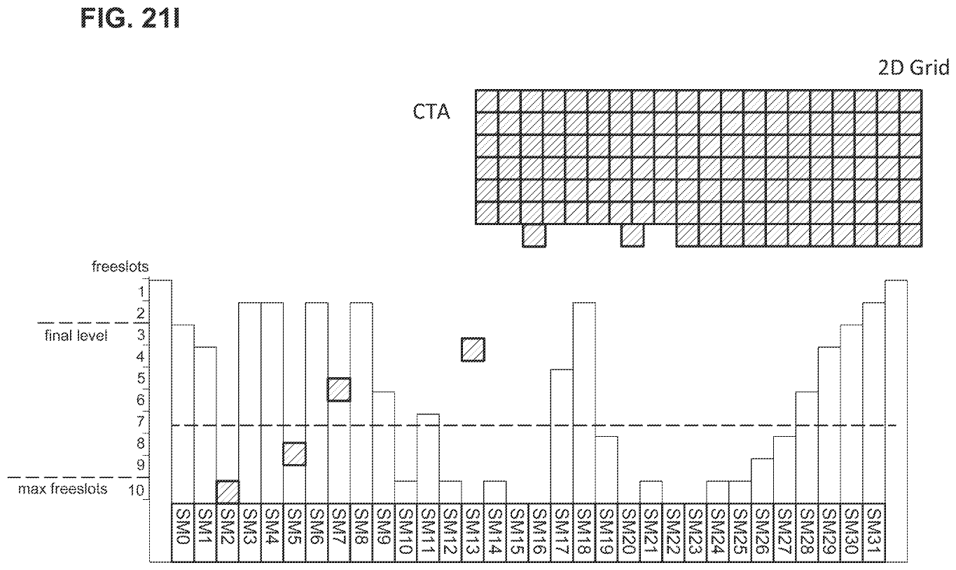

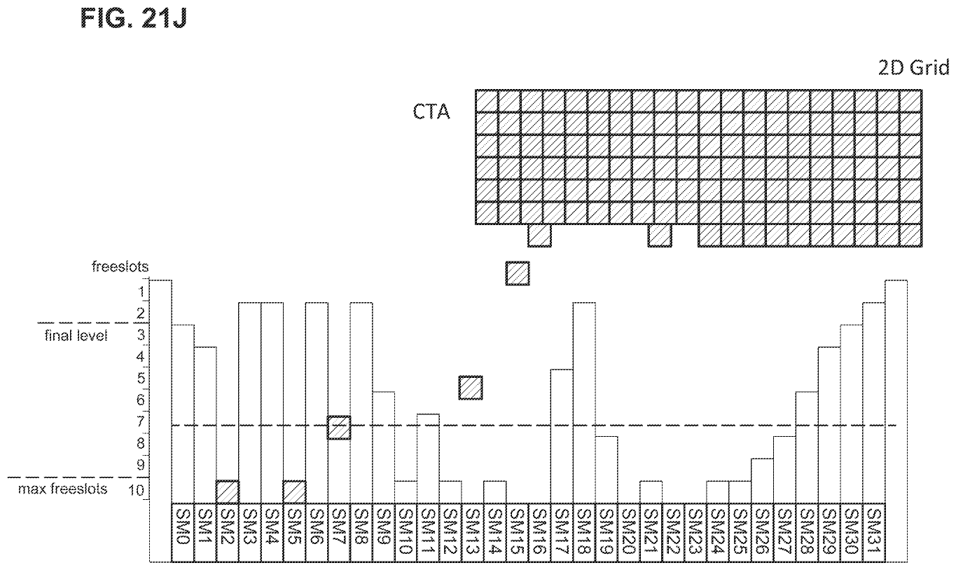

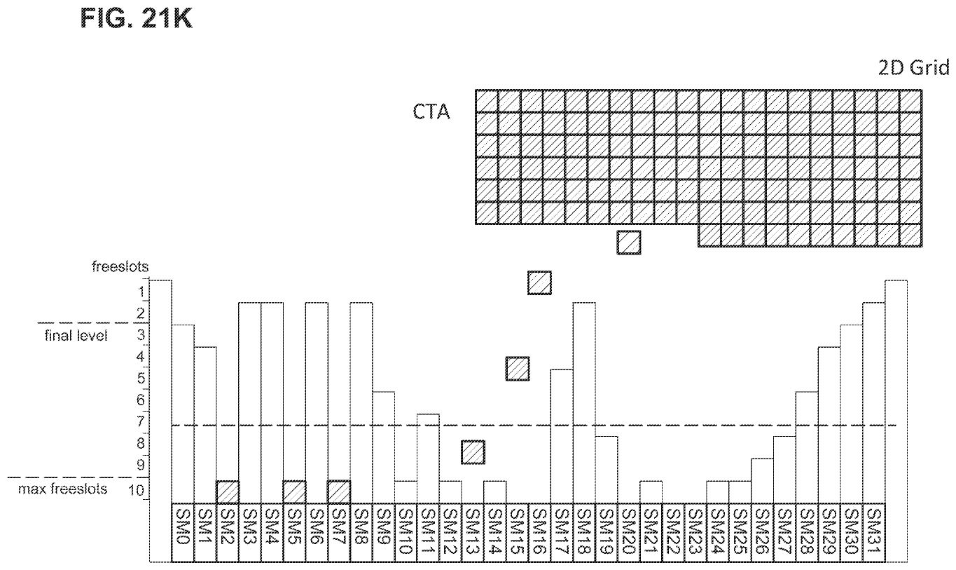

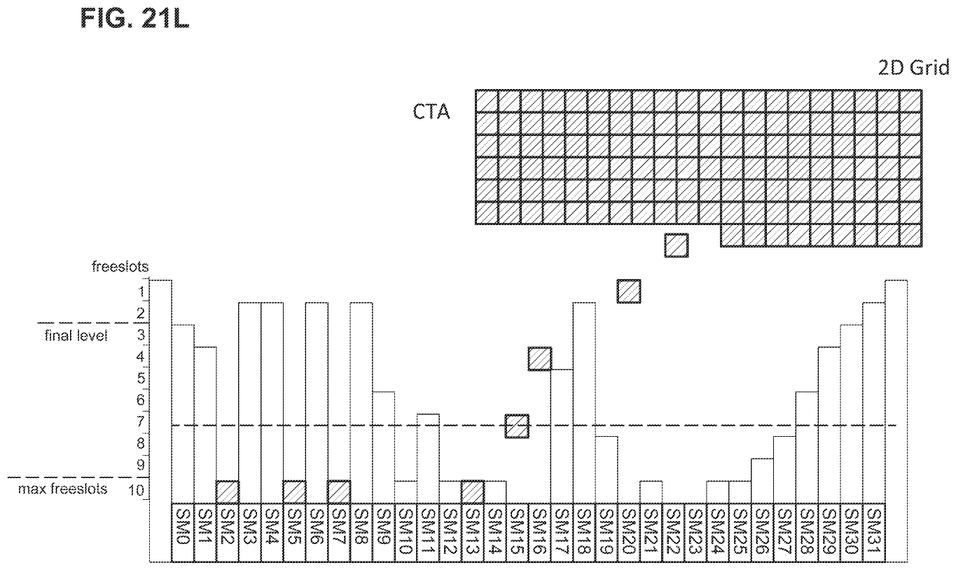

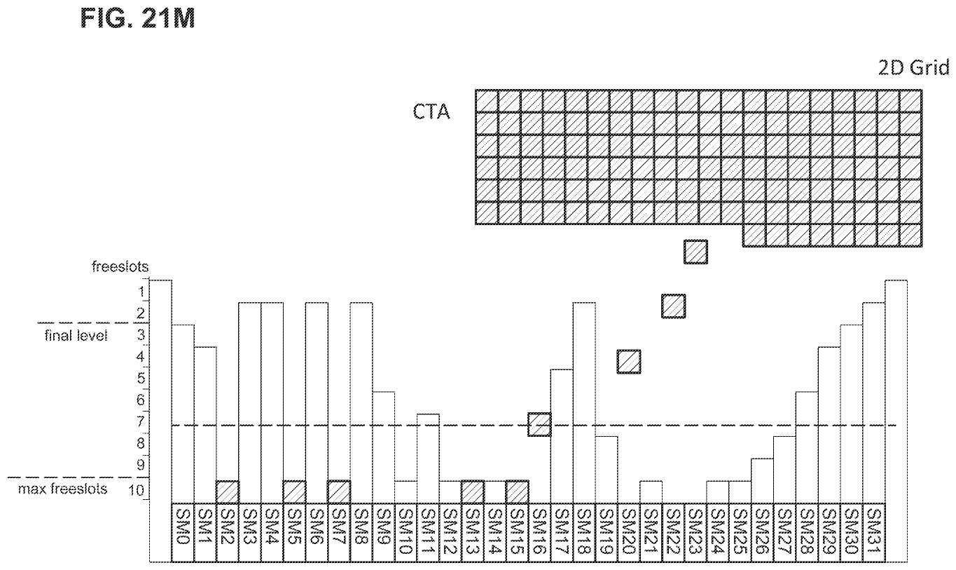

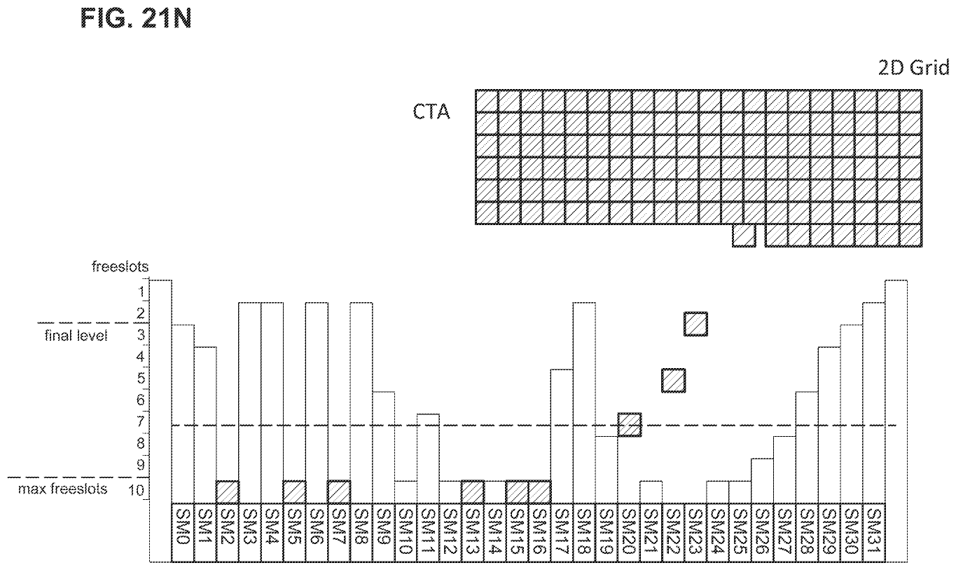

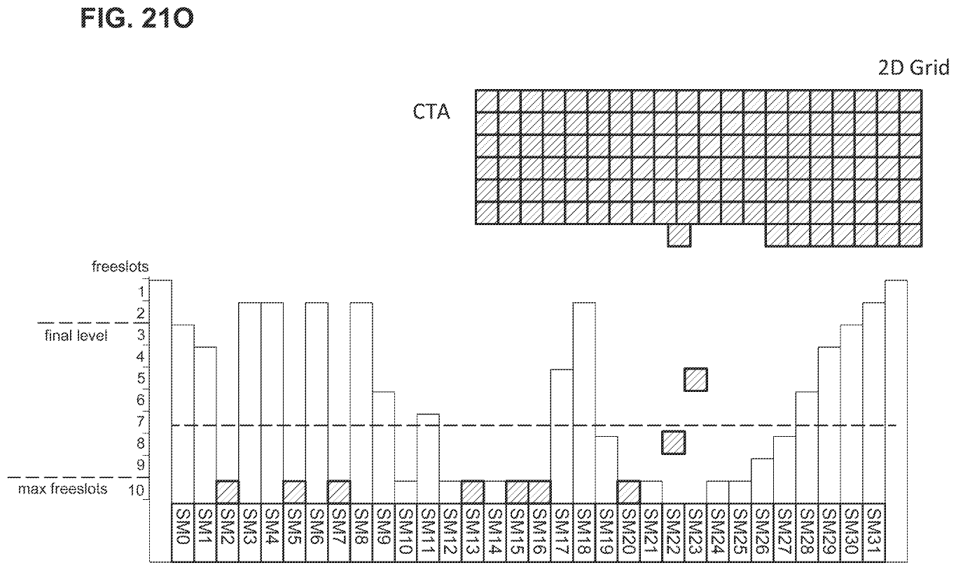

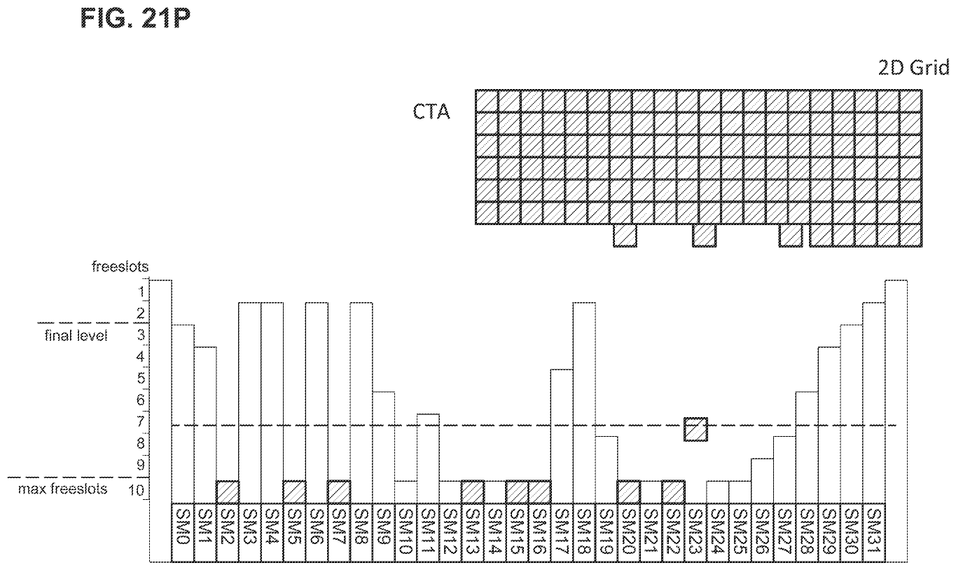

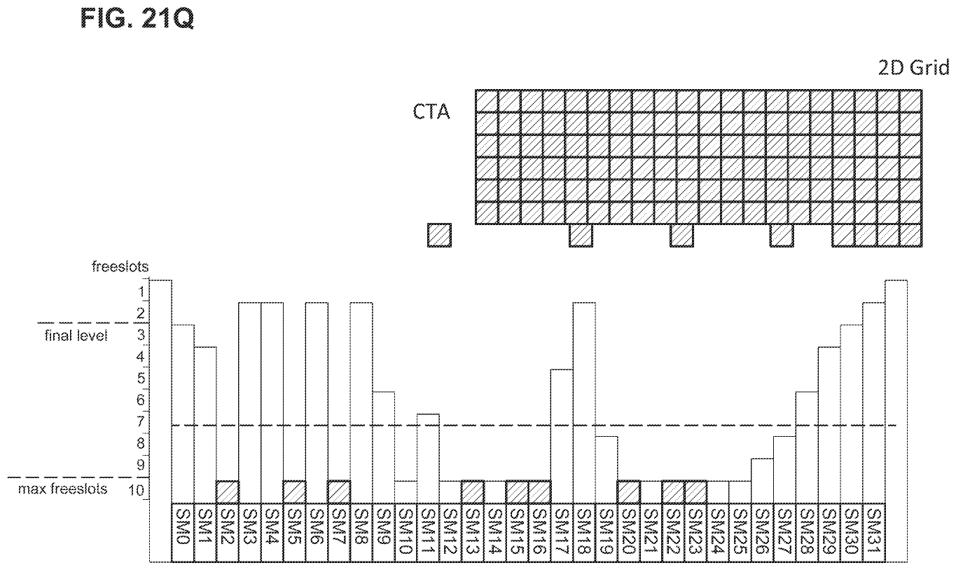

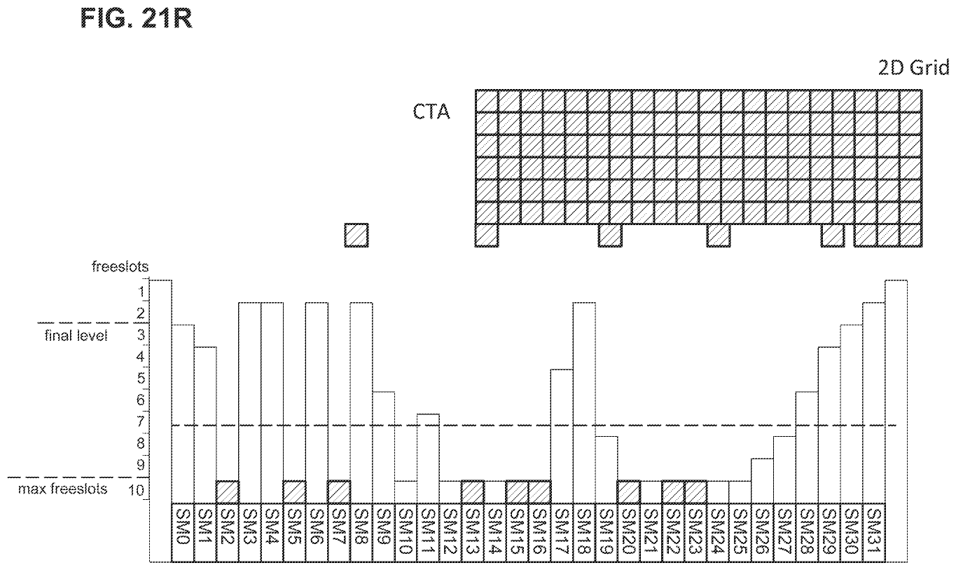

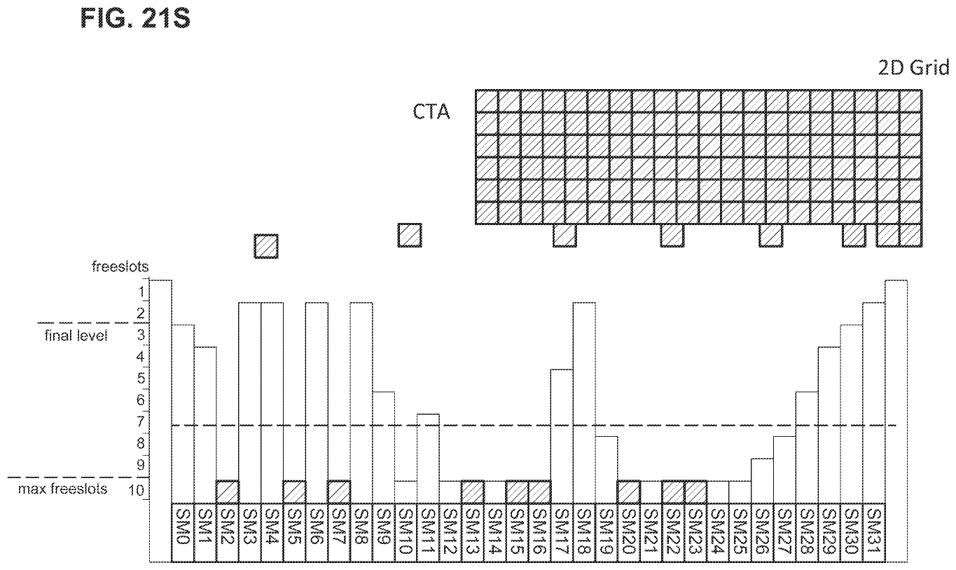

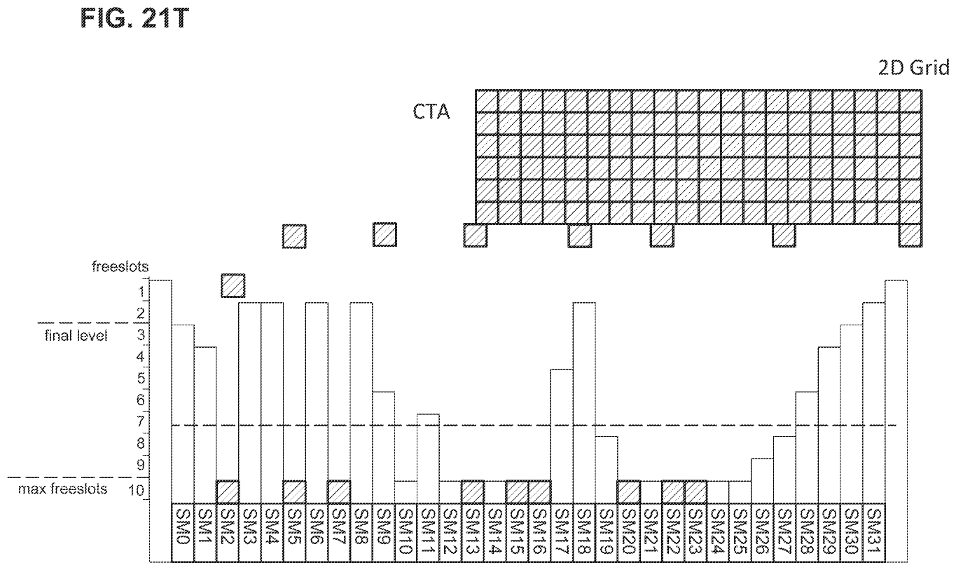

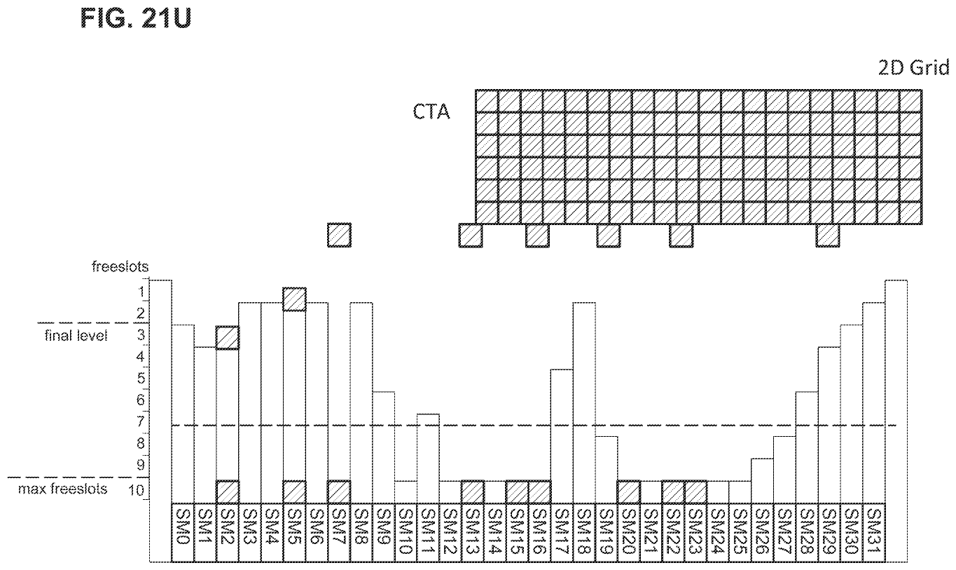

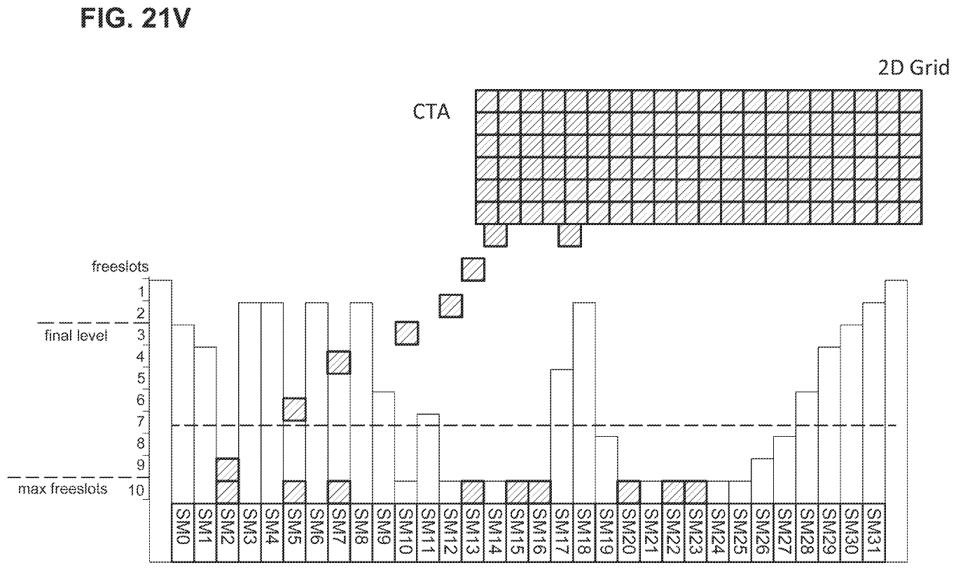

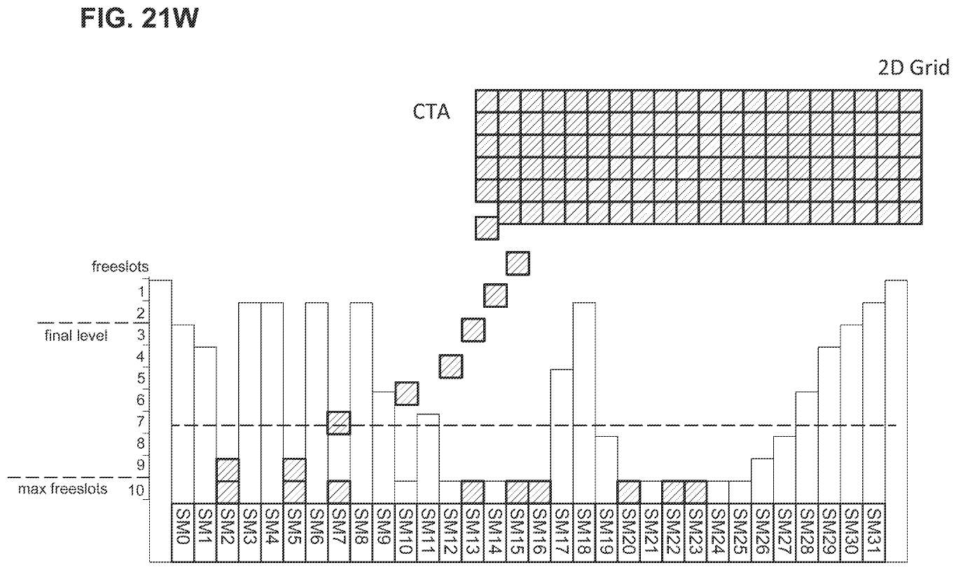

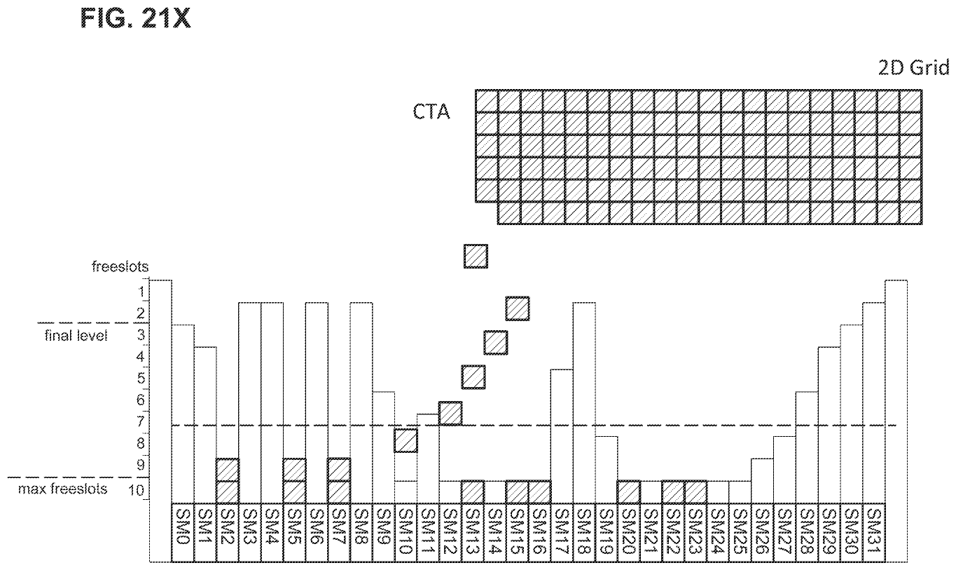

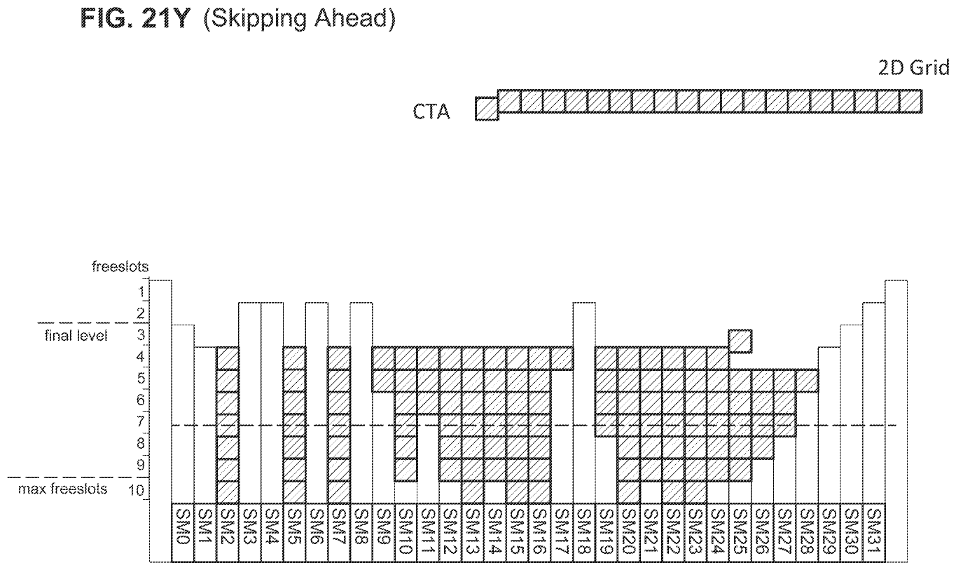

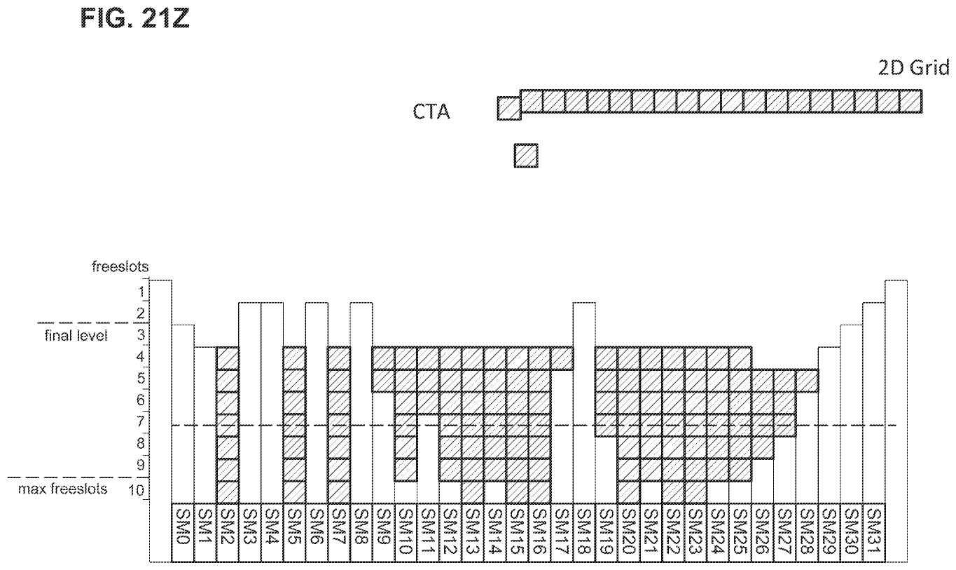

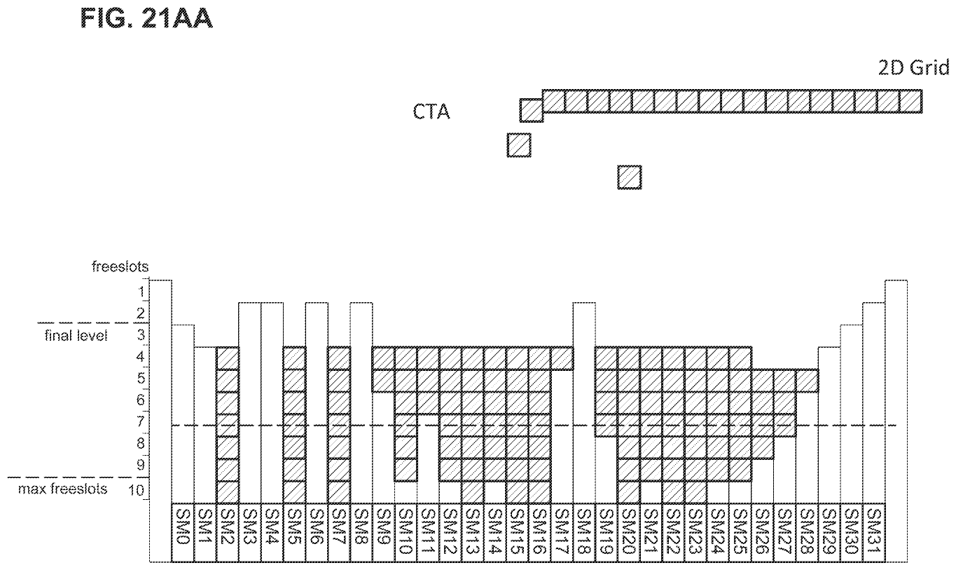

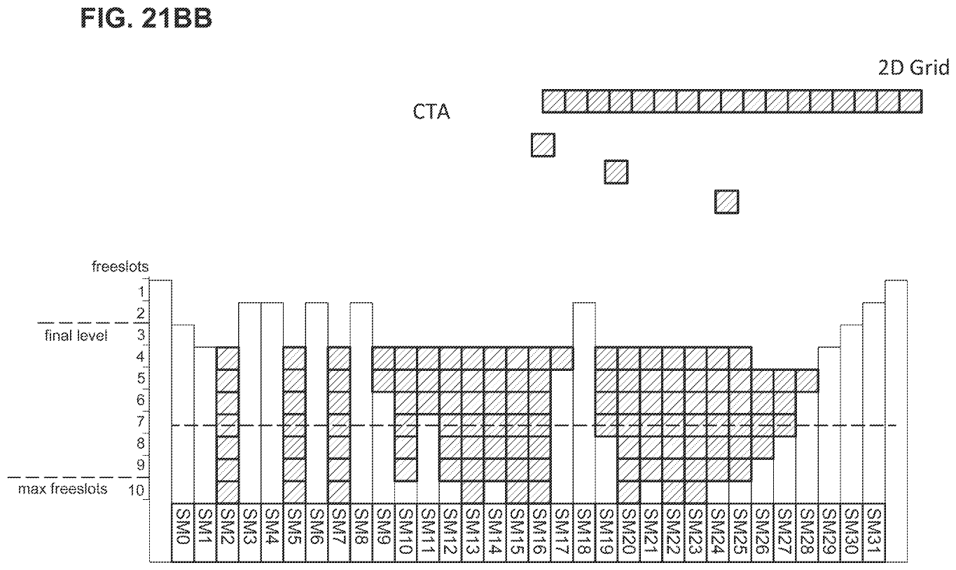

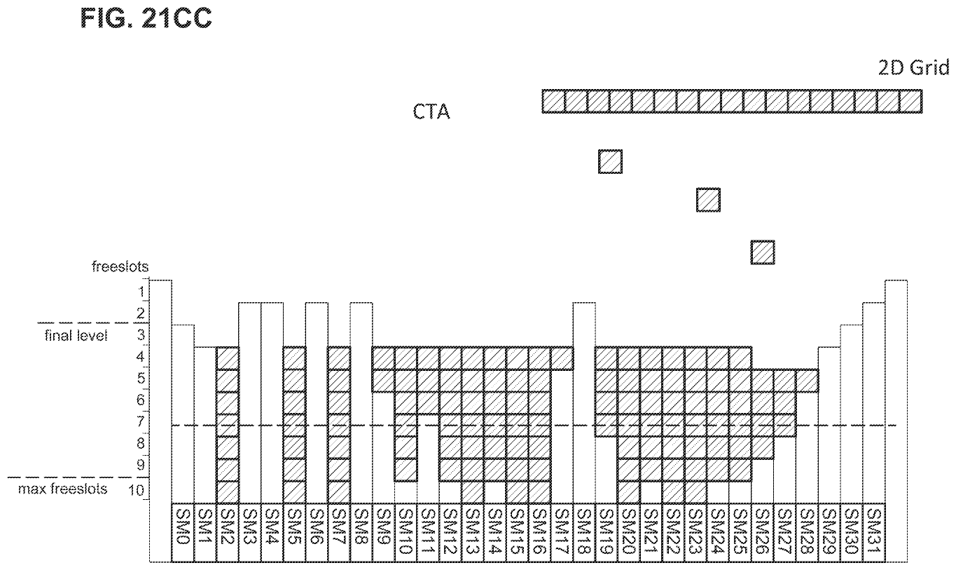

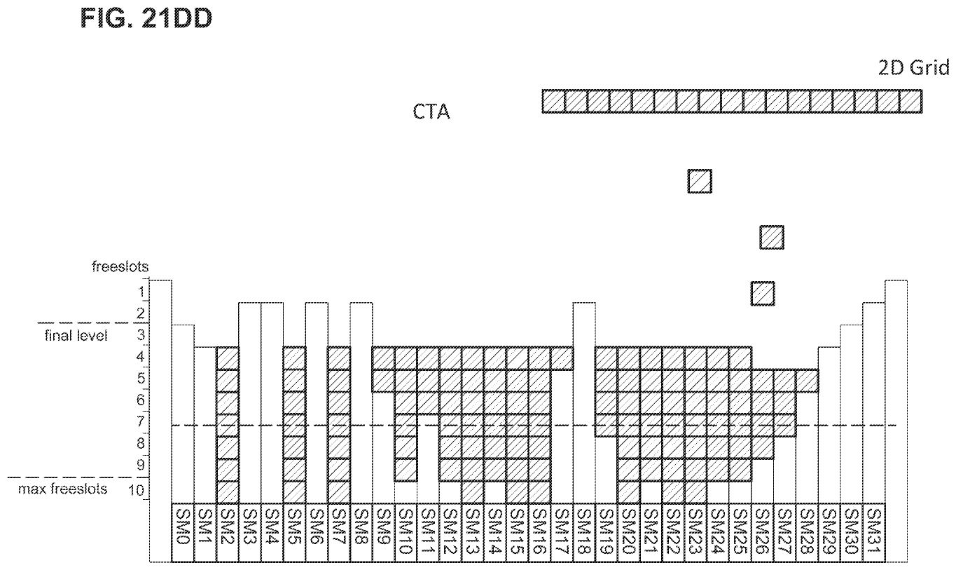

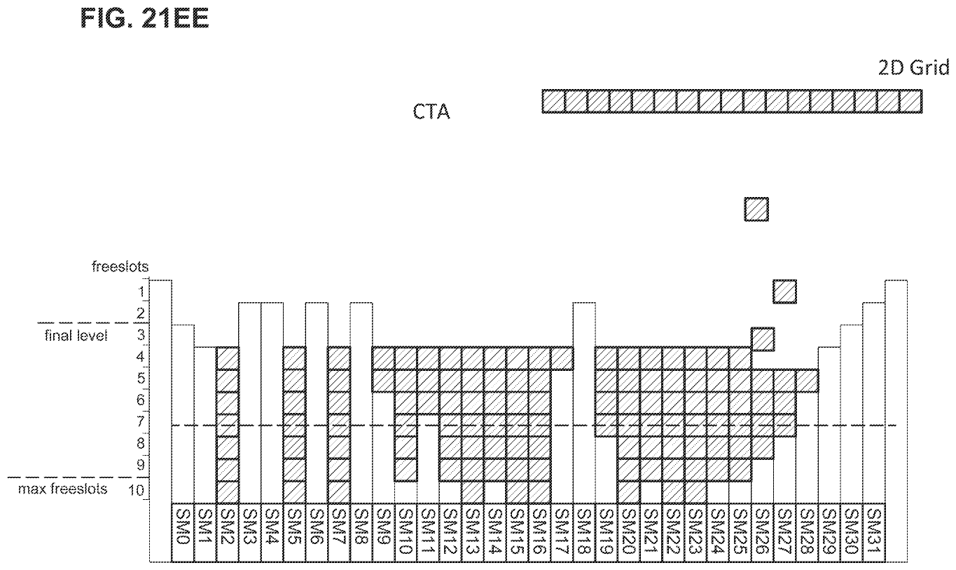

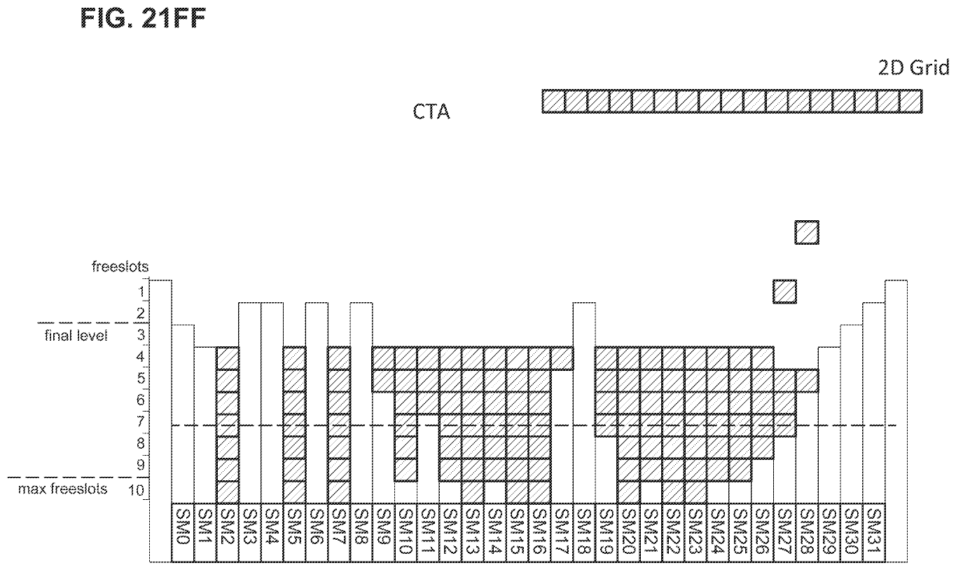

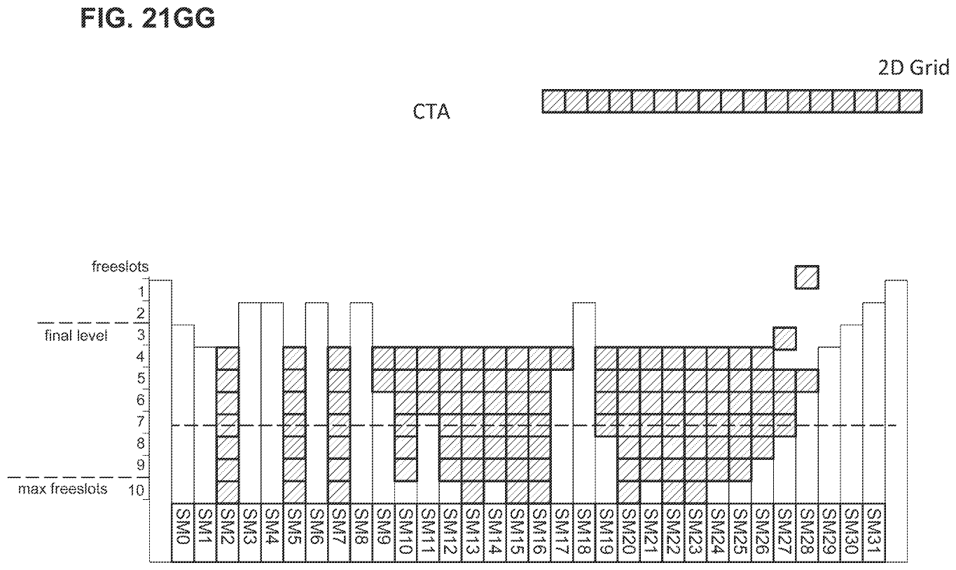

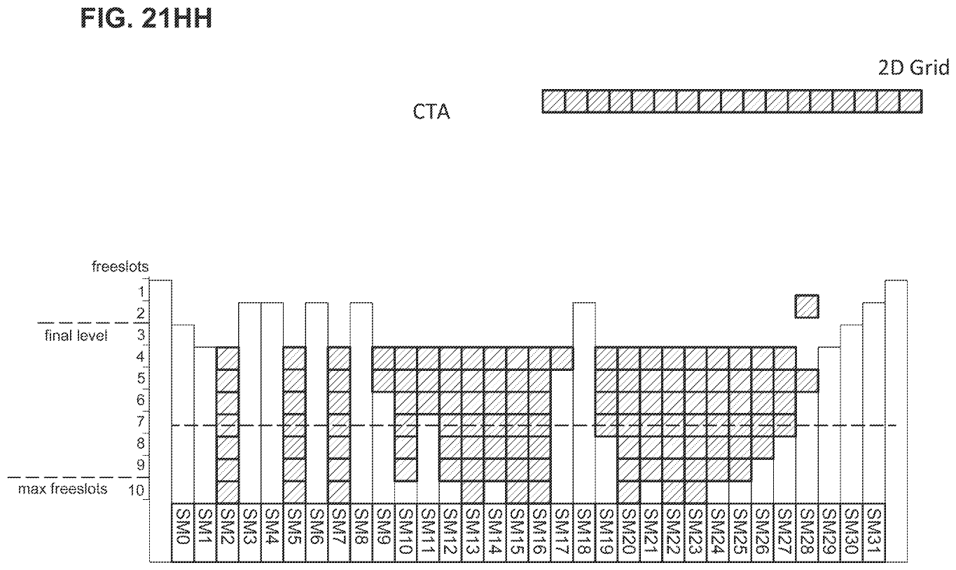

In one embodiment there are (at least) two load balanced distribution modes inside a GPC:
A) Load Balancing Mode: It is the one used in FIG. 21 discussed below. It is the equivalent of the distribution when a grid with the same number of CTAs as the CGA is launched to a GPU with the same number of SMs as a GPC.
B) Multicast Mode: This is a load balancing mode but with a constraint: only one CTA to the same SM from this CGA (it is ok to launch multiple CTAs to an SM, but not from the same CGA). This can be used to ensure the CGA can enjoy a multicast memory load mechanism, since in certain embodiments providing programmatic multicasting, only one CTA in the same CGA running on the same SM may be able to access multicast data from the memory system. In other embodiments, such constraints may not be present but there may still be advantages to allocating only one CTA of a CGA to each SM instead of doubling up, tripling up or so on.

These two load balancing modes are discussed below in more detail. The following algorithm description is for the “Load Balancing Mode.”

Example Non-Limiting Load Balancing Algorithm

The load balancing of a large number of CTAs looks a lot like pouring water (CTAs) into a dried-up lake whose depth is proportional to the free slots. See FIGS. 21, 21A-21Z, 21AA-21II, 22, 23, which together are a flip chart animation showing an example allocation of CTAs to free slots of SMs by CWD 420. In the example shown, there are 32 SMs in the relevant hardware partition but any number of SMs may be present in a given GPU or partition.

In this particular example, some of the SMs such as SM3, SM4, SM6, SM8, SM18 and SM 31 are already nearly or completely fully occupied with previously assigned work. These SMs can accept no additional work. They have no available free slots to take on new work (it may be desirable in some implementations not to fully load any SM because the more work the SM tries to do at the same time, the slower it will perform each piece of work).

Some of the SMs such as SM10, SM11, SM12, SM17, SM18, etc. are already executing some previously assigned work but have open free slots meaning more processing resources that can potentially be used to execute new work. They have some free slots but are not unoccupied.

Some of the SMs such as SM2, SM5, SM7 and so forth are not executing any previously assigned work and so are completely available for new work. They have many (all) free slots open.

The example utilization state of the relevant hardware partition as shown in FIG. 21 where some SMs have many free slots and some SMs have no free slots can occur for example due to dynamic GPU operation. When a GPU first starts after a reset or other major initialization event, the SMs are doing no work and all SMs have the maximum number of free slots. When CWD 420 distributes the work of a first CGA across this collection of totally unoccupied SMs, it could distribute the work freely across all the SMs without any special load balancing algorithms to achieve efficient load balancing. However, as the GPU continues to operate, some CTAs in a CGA may complete before others, thereby freeing up slots that can be reused by newly launched CGAs. Just like the fuel station analogy described above, the fuel station does not need to be completely empty to accept new cars that need refueling—it can instead allocate fueling slots to cars on a dynamic basis as the fueling slots become available. However, CGAs present a more difficult scheduling challenge than CTAs since CGAs require parallel allocation of multiple resources (i.e. one SM free slot for each CTA in the CGA). An analogy could be scheduling projects across multiple teams of workers (CGAs) vs. scheduling tasks across a group of individual workers (CTAs). Thus, the load balancing that CWD 420 performs in example embodiments is more complex than and different from the simple “first come first served” load balancing of a fueling station or even load balancing of CTAs.

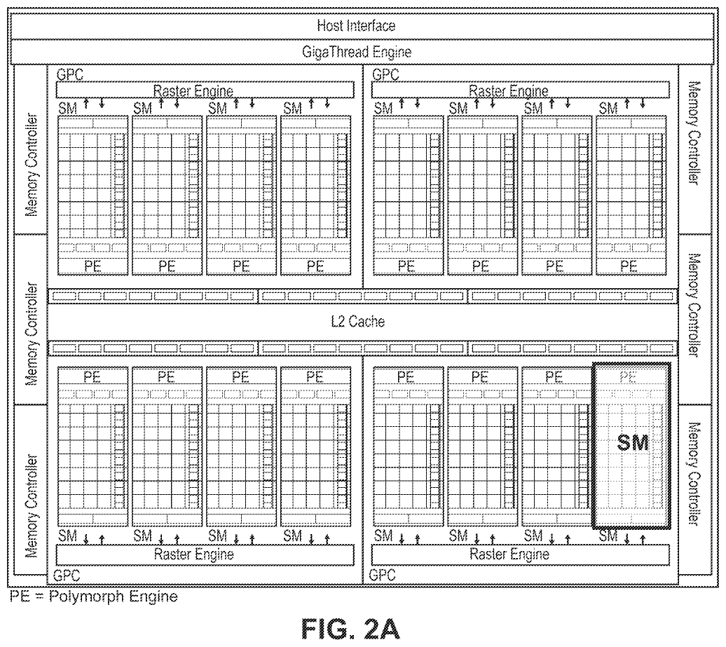

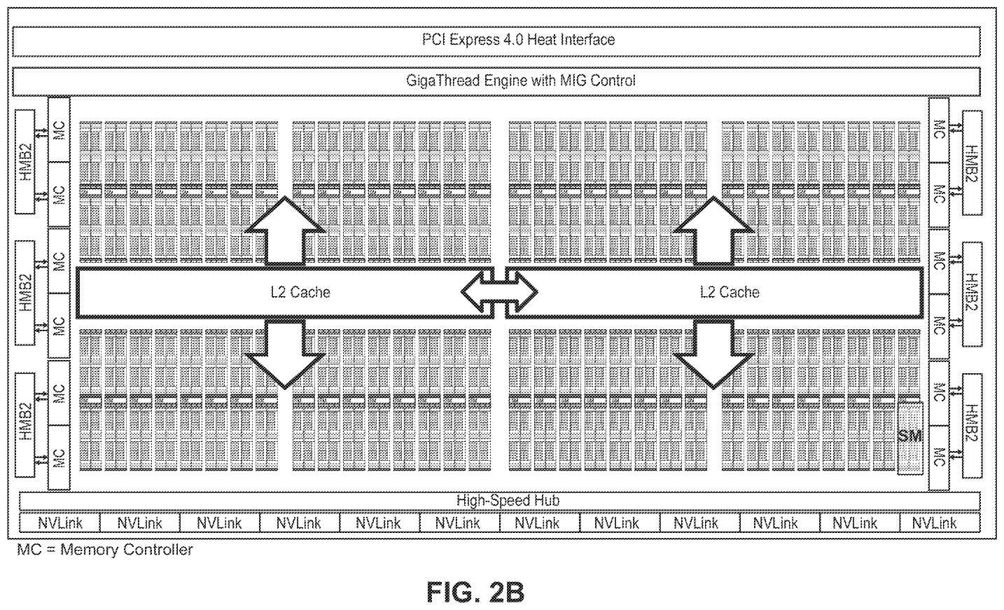

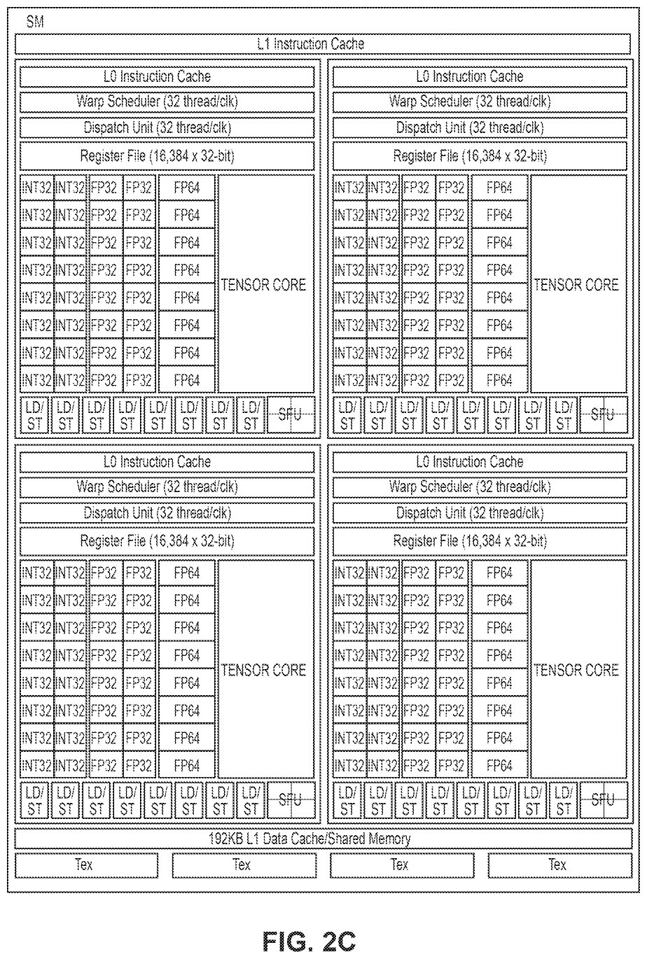

FIG. 21 shows an example CGA (represented by a 2D grid) containing 137 CTAs, that is to be distributed for execution on a GPU comprising 32 SMs or other core processors. Because of the hierarchical way CWD 420 is structured in one embodiment (details below), this abstract collection of 32 SMs can be spread across one or more GPU hardware domains within the GPU such as within a GPC or multiple GPCs, within a CPC or multiple CPCs, etc. In one embodiment, they could even be spread across multiple GPUs. In this example, the job of the CWD 420 is to (a) guarantee (in hardware) that all 137 CTAs will launch and run concurrently, and (b) load balance the CTAs across a collection of SMs in a way that will maximize speed and throughput. CWD 420 performs these tasks one all of the CTAs in the CGA as a whole (not one by one) by using a speculative or shadow state launch mechanism (see below) to prestage all the launches of all the CTAs, and then (assuming the concurrent execution guarantee holds for this collection of SM hardware with their current loading at this time), launching all CTAs “at the same time.” Here, “at the same time” is not restricted to literally launching all CTAs to all SMs in a single processing cycle since as a practical matter it may take some time for the CWD 420 to communicate appropriate pointer information and instructions to each of many SMs that may be distributed across the surface of a semiconductor wafer (see FIG. 2B).

Load Balancing Flip Chart Animation I

FIG. 21 and following are a flip chart animation (I). To view this flip chart animation using an electronic copy of this patent on your computer or other device, please size FIG. 21 to just fill the screen and view it in landscape instead of portrait orientation (e.g., by using a “rotate” clockwise), and then repeatedly depress the “Page Down” button on your computer to advance to FIGS. 21A-21Z, 221AA-21II in sequence. You will then see an animation of how CWD 420 fills the free slots of SM0-SM31. Of course, you can also flip through paper copies of these figures. This animation shows CWD 420 appearing to process each CTA one at a time for speculative/shadow state launch purposes. However, even there CWD 420 is acting in a centralized manner to take the current loading of all SMs in the collection of SMs into account when assigning CTAs to SMs for speculative/shadow state launch.

As you can see from these Figures, CTAs “fill” the SMs of the GPU (meaning each CTA is scheduled to execute on an SM), The CTAs are scheduled to execute on the SMs with the largest number of free slots first and gradually fill the “lake” upward (FIG. 16A blocks 202, 204). The amount of the available “water” to fill the “lake” (work to fill processing resources) corresponds to the number of CTAs in the grid. Notice that as the flip chart animation proceeds, the CWD 420 assigns work to SMs that have the most number of free slots first.

In one embodiment, CWD 420 is not allowed to launch more CTAs than the SMs can accept (FIG. 16A block 2006), so if the “lake” becomes full before the grid runs out of CTAs, the process is suspended (FIG. 16 block 2008) and waits for the completion of already launched CTAs to free up more free slots. If there is more “lake” capacity (total number of free slots) than CTAs, then the “water” level raises up to a certain level and stops.

There are several options to implement this in a concrete logic. One is the binary search. If maximum free slots (max lake depth) is N, CWD 420 tentatively tries the final water level of N/2, and sees if the amount of water (#of launched CTAs) would be greater than remaining CTAs in the grid. If yes, since CWD 420 does not have enough CTAs for this water level, CWD tries N/4 next. If no, CWD 420 tries 3N/4. And it repeats this process until it finds the equilibrium.

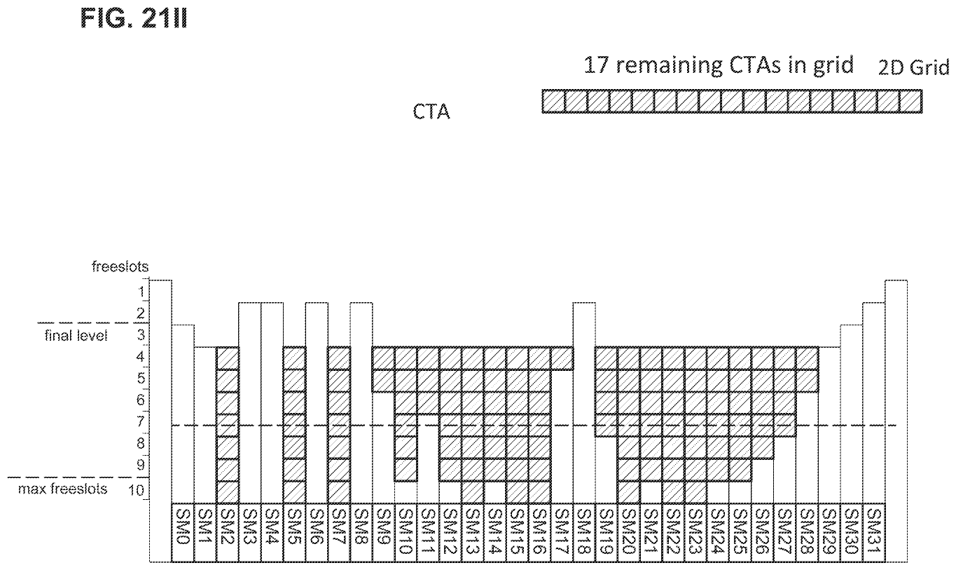

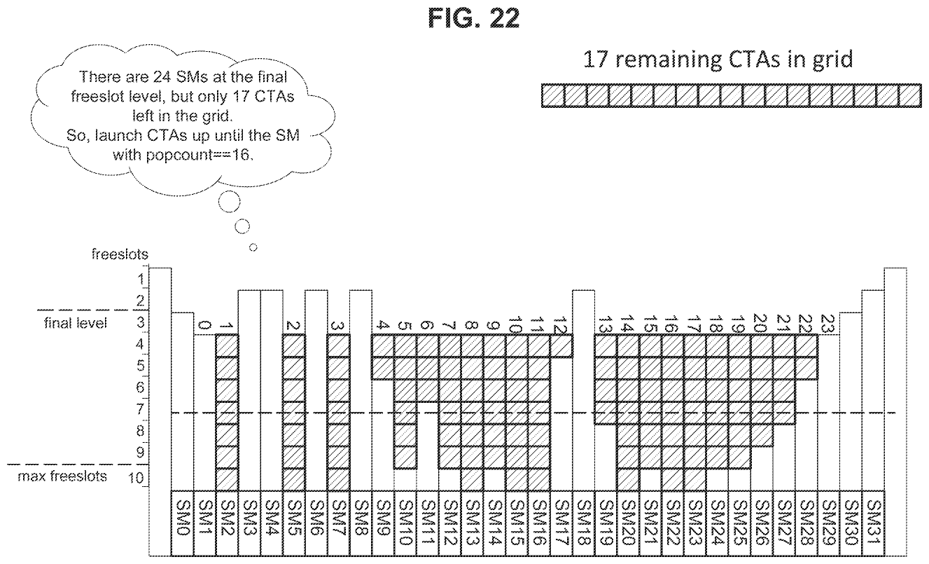

The method above is efficient for a large value of N, but for a smaller value, CWD 420 can simply scan SMs from maximum free slots to lower values (upward in FIG. 21). At each iteration, CWD 420 speculatively (shadow state) launches CTAs to the SMs with the current free slots. If this approach is used, special attention is paid to the final free slot level as shown in FIG. 22. This is where the fluid analogy breaks down, since CTA units of work are discrete, and a CTA in one embodiment will thus not be spread across multiple SMs.

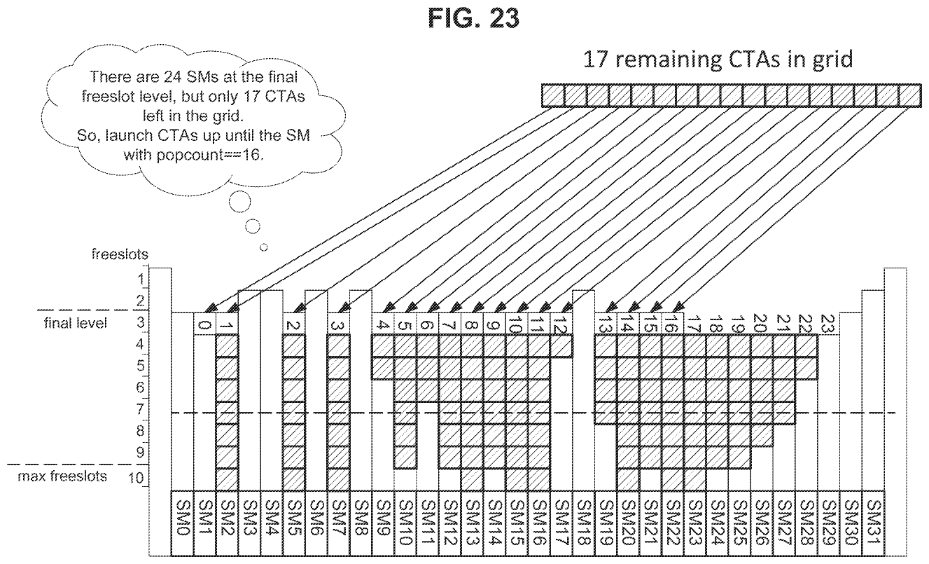

CWD 420 in one embodiment concurrently selects a subset of SMs to assign work to by applying an additional criterion for this final free slot level shown in FIG. 22. The criterion in one embodiment is a predetermined or other priority among SMs. In the FIG. 22 example, SM0 has the highest priority and the SM priority decreases as SM #increases to the right. CWD 420 concurrently calculates the “popcount” (population count) of each SM with the final free slot level from left to right, then selects the SMs with popcount less than the remaining number of CTAs. The “popcounts” are in one embodiment obtained in O(log N) time by a bottom-up reduction and a top-down accumulation (FIG. 16A block 2004). FIG. 23 shows one example result, which in one embodiment simultaneously selects a number of SMs to launch CTAs onto rather than selecting such SMs one at a time. SM priorities can be assigned in any order, and the “filling of the lake” need not be performed from left to right (it could be performed from right to left or in any other predetermined or non-predetermined order).

Flip Chart Animation II

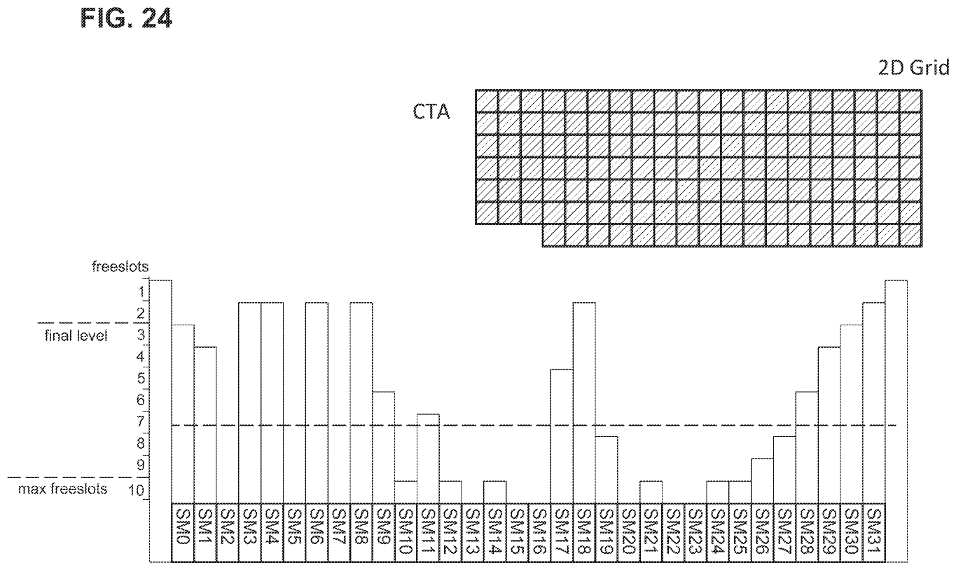

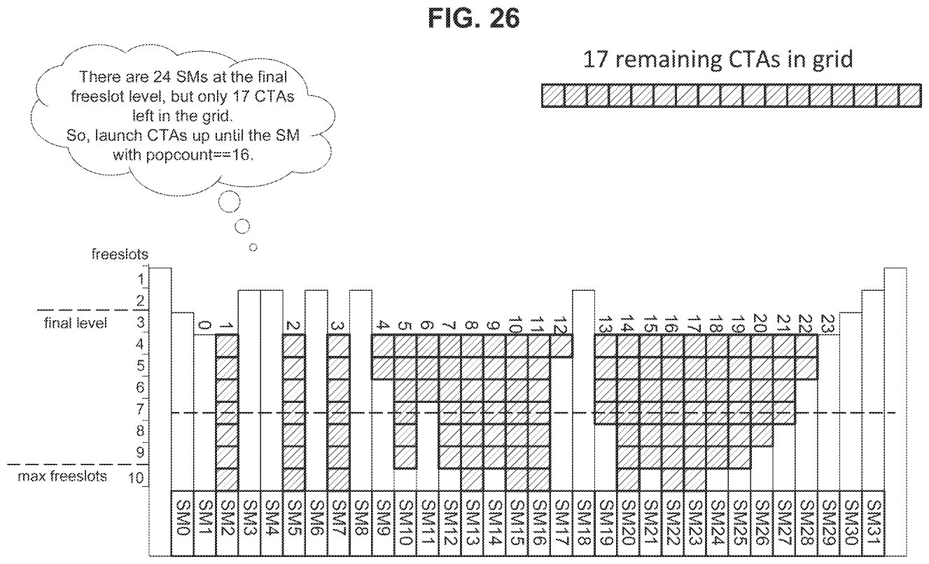

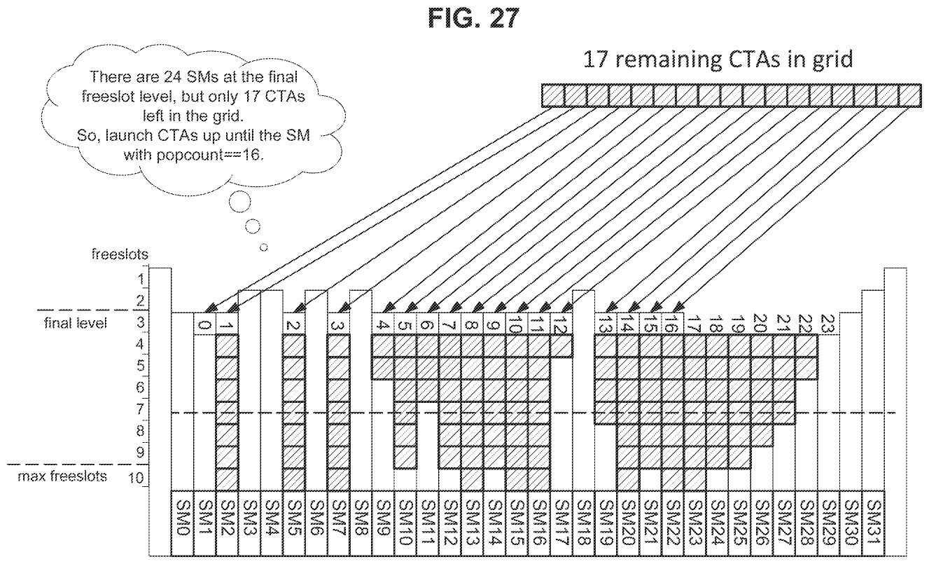

FIGS. 24, 25A-25G, 26 & 27 are together another flip chart animation (II) showing another way that the compute work distributor can distribute CTAs within a CGA to SMs within example embodiments. In this embodiment, CWD 420 does not distribute CTAs one at a time, but rather distributes the CTAs one row or level at a time. As discussed above, for smaller values of N, CWD 420 can simply scan SMs from maximum free slots to lower values (upward in FIG. 24). At each iteration, CWD 420 speculatively launches CTAs to the SMs with the current free slots. Basically, instead of showing CTAs' descending one by one, this embodiment fills “the lake” one whole row at a time. Parallel loading of CTAs into SMs (TPCs) can be performed after speculative launch succeeds (see below). The binary search algorithm described above also works. For CGA, multiple CGAs are launched at once, too.

Alternative Endings for Flip Chart Animations I & II—Speculative Launch Fails

On the other hand, if a speculative or shadow state launch should determine a CGA is too big to launch on the available processing resources (FIG. 16A, “Yes” exit to block 2006), CWD 420 would determine there are not enough SM free slots available to launch all CTAs concurrently, and therefore would issue a “fail” indication for this CGA at this time (FIG. 16A, block 2008). No CTAs of that CGA are actually launched, and the system must try at a later time to launch this CGA (e.g., when more SM slots are free) but may try to instead launch a smaller CGA, again using the load balancing algorithm discussed above (FIG. 16A blocks 2012, 2000). Of course, if a grid consists of normal (i.e. non-CGA) CTAs, if CWD 420 has more CTAs than total free slots, then simply all free slots should be filled by CTAs immediately and CWD will launch remaining CTAs as more CTAs complete.

GPC Organization for Load Balancing

As discussed above, many GPUs have partitions or other subdivisions such as GPCs. In one embodiment, CWD 420 takes these partitions or other subdivisions into account when load balancing. To launch a CGA, CWD 420 selects a GPC, and then selects SMs in the GPC for the CTAs in the CGA. The goal of the selections is maximizing performance: which GPC and SMs would most likely let the CGA run fastest and complete the soonest? An assumption here is that CTAs in a CGA synchronize frequently and make a lock step progress, so the slowest CTA determines the execution speed of the CGA.

Additional Flip Chart Animation III

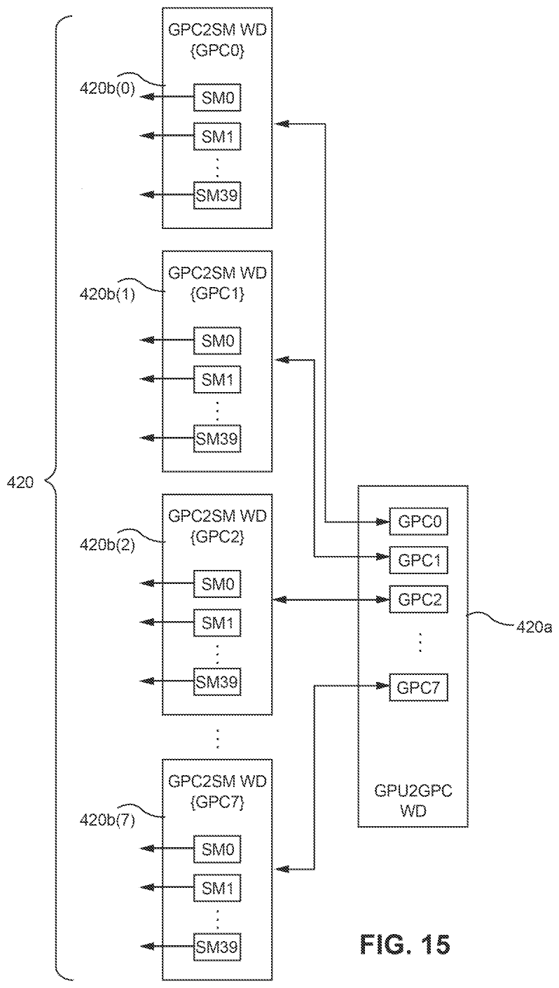

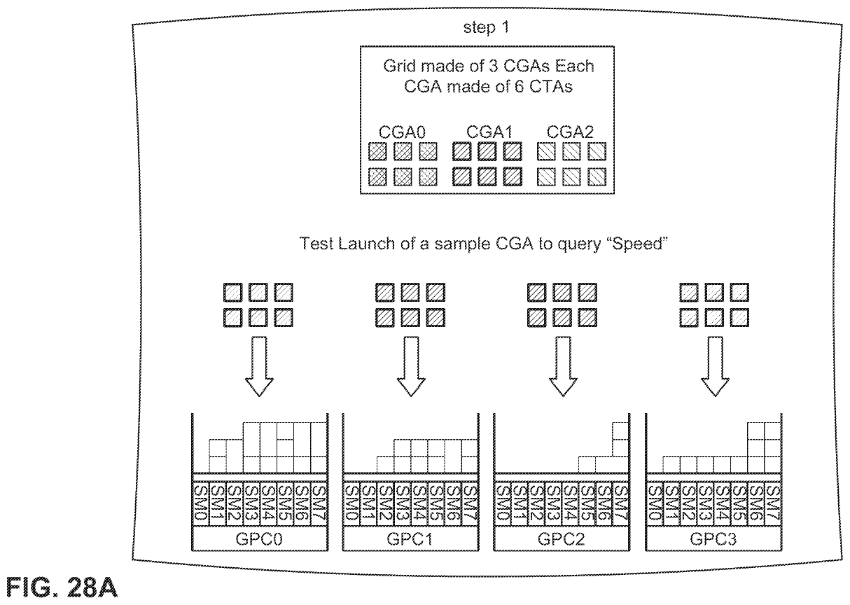

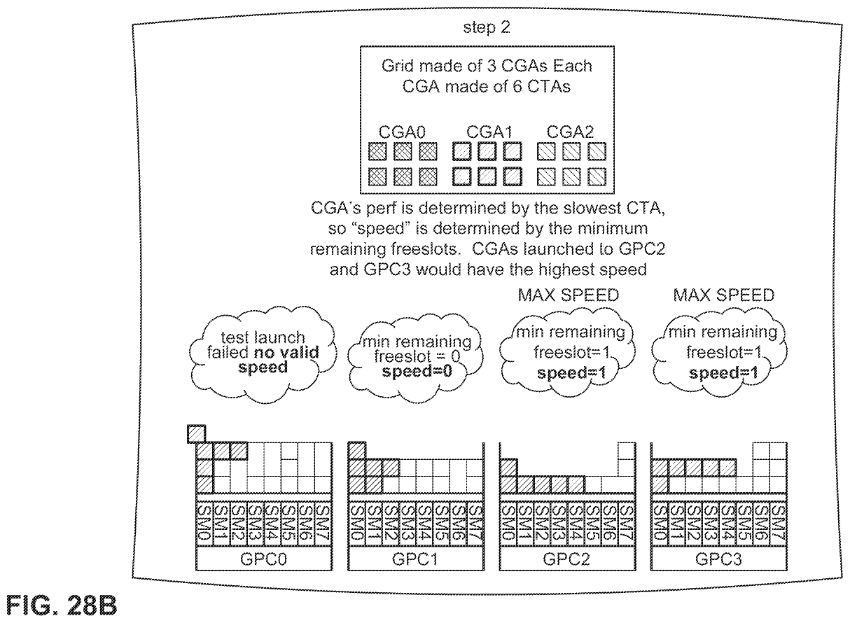

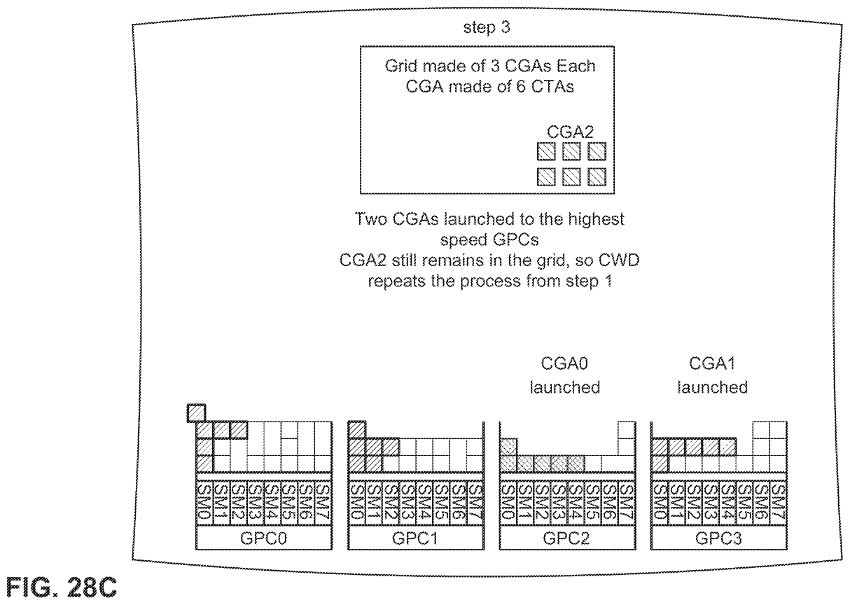

FIGS. 28A, 28B, 28C are a flip chart animation (III) that illustrates the CGA scheduling algorithm for a hierarchy of hardware domains—in this case multiple GPCs each comprising SMs, where a CGA-GPC must run on a single GPC and cannot cross the border between GPCs. In example embodiments, the algorithm also operates in a hierarchical manner. At the top level (FIG. 15 block 420a), the “best” GPCs are chosen, and CGAs are launched in parallel. CWD's next pipeline stage (FIG. 15 block 420b) selects SMs for the CTAs in the CGAs. Thus, the CTAs are launched in parallel and again issue #1 is properly addressed.

Now, how are the best GPCs selected? In one embodiment it is done by querying “speed” from each GPC as shown in FIG. 28A. As mentioned above, we want to send CGAs to the “fastest” GPCs. But in one embodiment, “GPC” is not the real GPC. The round-trip latency from CWD to GPC is large and queries of that distance should be avoided. Instead, in one embodiment, CWD 420 instances a set of mock-up GPCs internally, and sends the query to them. Such mockup models the free slots that the SMs report to CWD 420 (see above discussion) so that CWD thus takes into account the current loading of each SM in each GPC. In the example shown in FIG. 28A, GPC0 includes 8 SMs five of which (SM3-SM7) are fully loaded, two of which (SM1, SM2) are partially loaded, and one of which (SM0) is fully unoccupied. And so on.

Such mockup or model of the GPCs allows CWD 420 to provide a speculative or shadow state launch capability that is tailored for the CGA grids discussed above. Each query comes as a form of a sample CGA. Upon receiving the sample CGA (in this illustration, CGA1), the mock GPC tries its best to launch CTAs of the CGA to SMs. The mock GPC has two modes for load balancing CTAs across SMs—one is a simple load balancing, the other is “multicast” mode. After a mock GPC tries CTA launch, if it does not find enough free slots, it then replies “failure” to the top level. If it does find enough free slots, using one of load balancing modes, it distributes CTAs, then calculates the minimum remaining free slots among the SMs that received the CTAs. As mentioned above, the remaining free slots is the indication of the “speed” of the prospective CTA. And the slowest CTA in the CGA becomes the bottleneck. So, the minimum remaining free slots is the “speed” of the CGA.

The top level repeats this query-launch process until either CGAs in the grid or free slots runs out.

The algorithm can be extended to multiple levels of CGA hierarchy. FIGS. 28A, 28B, 28C shows the case when we have three levels of hierarchy: a grid is made of GPC CGAs, which are made of a predefined number of CPC CGAs, each made of CTAs. At the top level, the algorithm queries each mock-GPC for the speed of a GPC CGA (FIG. 15A). Then, each mock-GPC repeatedly queries each CPC (in the GPC) for the speed of a CPC CGA and “speculatively” launches CPC CGAs until all CPC CGAs of a GPC CGA are launched (FIG. 15B). The speed of the GPC CGA is the speed of the last query because the speed of the GPC CGA will be the speed of the slowest CTA in the GPC CGA. Once the top level decides to accept the GPC CGA speed and sends a launch message to the mock GPC, the free slots reserved for the speculative GPC CGA are committed and the GPC CGA is launched for real on the actual hardware. Otherwise, the reservation is canceled. More levels of hierarchy can be accommodated with additional CWD 420 hardware layers and/or by recursively reusing the available hardware for each hierarchy layer (e.g., to save chip real estate and associated power).

In this illustration, because GPC0 is already rather occupied, none of the GPC-CGAs can be launched on GPC0. GPC1 meanwhile does have sufficient resources available to launch a GPC-CGA, but such launch will use up all the available processing resources of the GPC. Meanwhile however, GPC2 and GPC3 each can launch a GPC-CGA with free slots to spare, meaning that the load balancing algorithm by selecting GPC2 and/or GPC3 is able to maximize the speed at which the launched GPC-CGAs will run. In the example shown, CWD 420 will not necessarily prefer GPC2 over GPC3 even though GPC2 is more lightly loaded than GPC3, but other example embodiments can take such differences into account depending e.g., on how many (and what characteristics of) GPC-CGAs are waiting to run. The scenario after FIG. 28C is that CWD 420 will launch GCA2 to GPC2 so that two CGAs will be running on the same GPC.

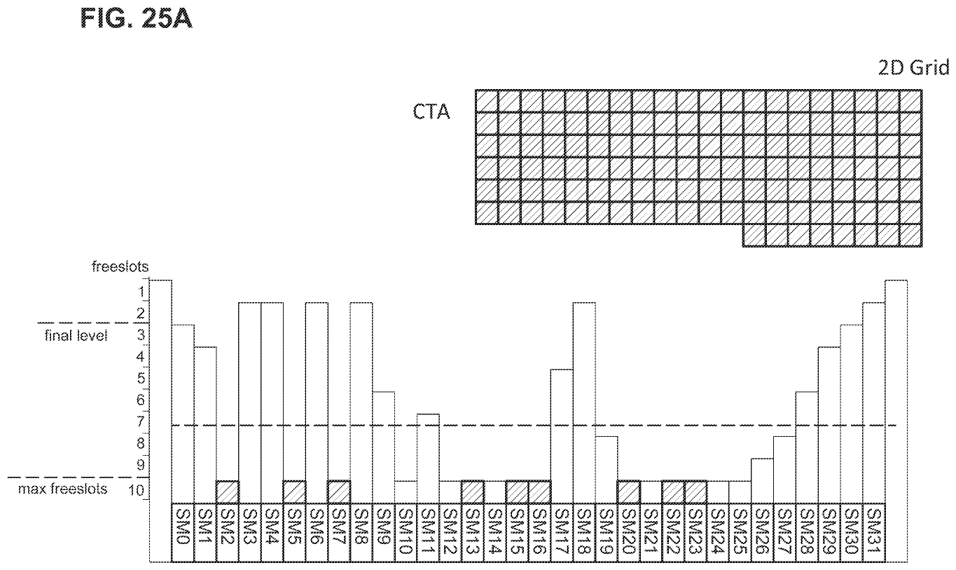

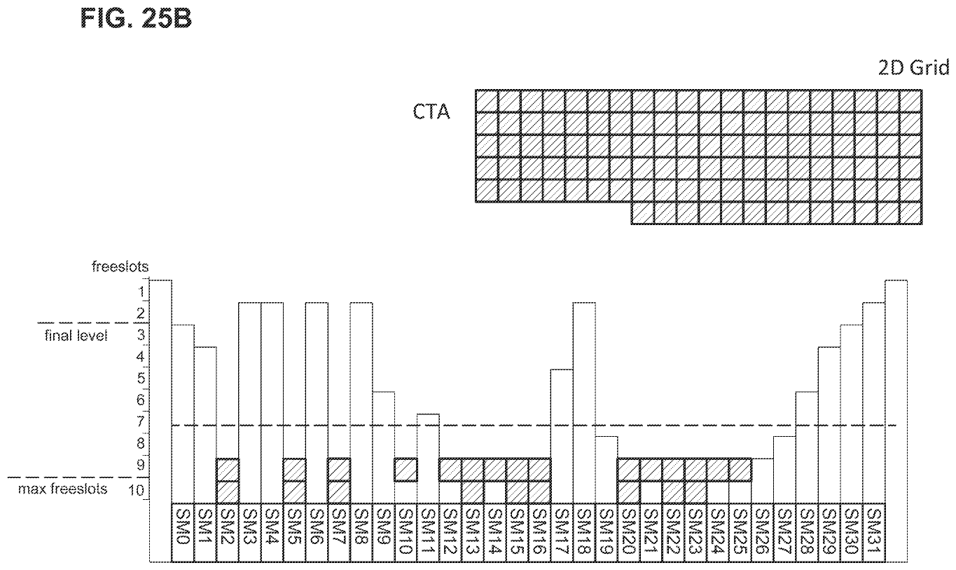

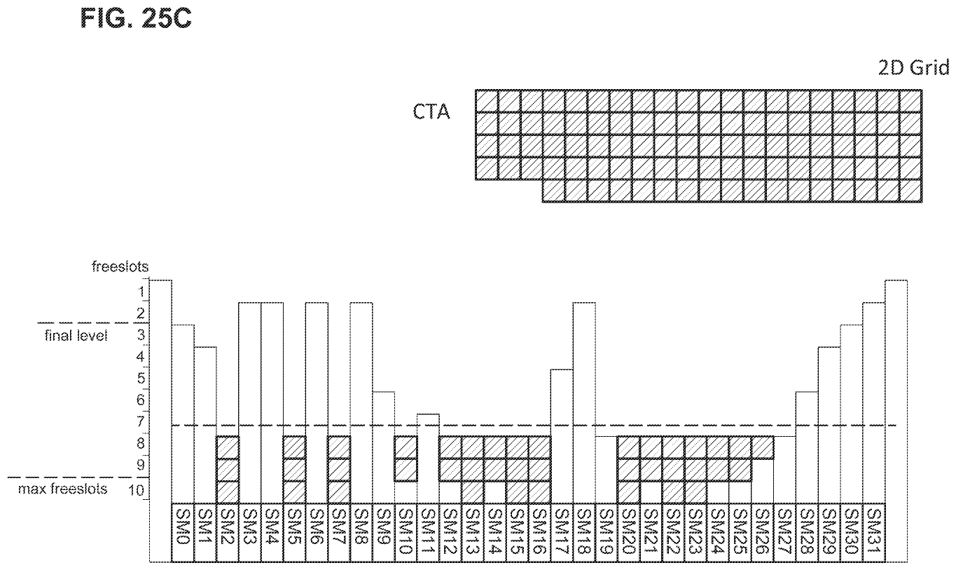

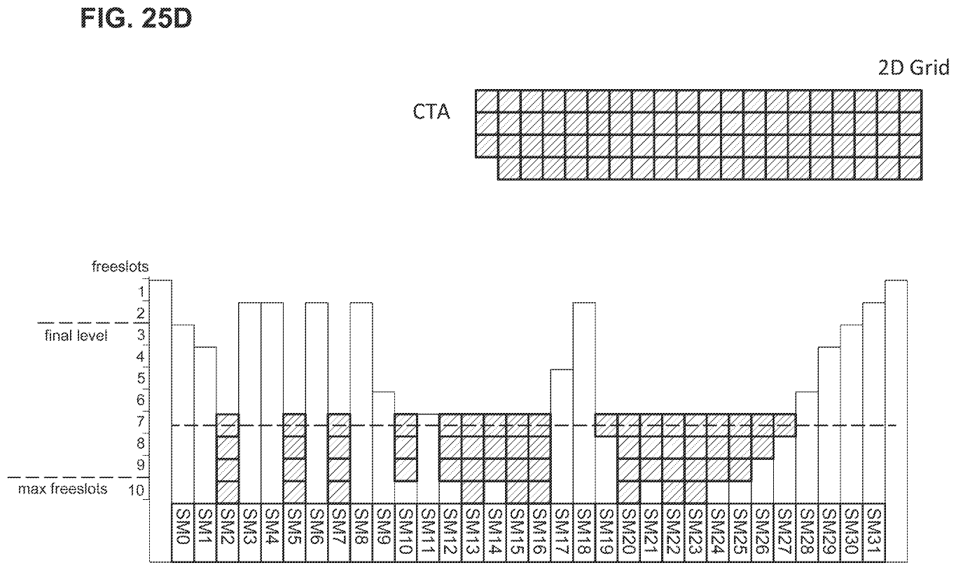

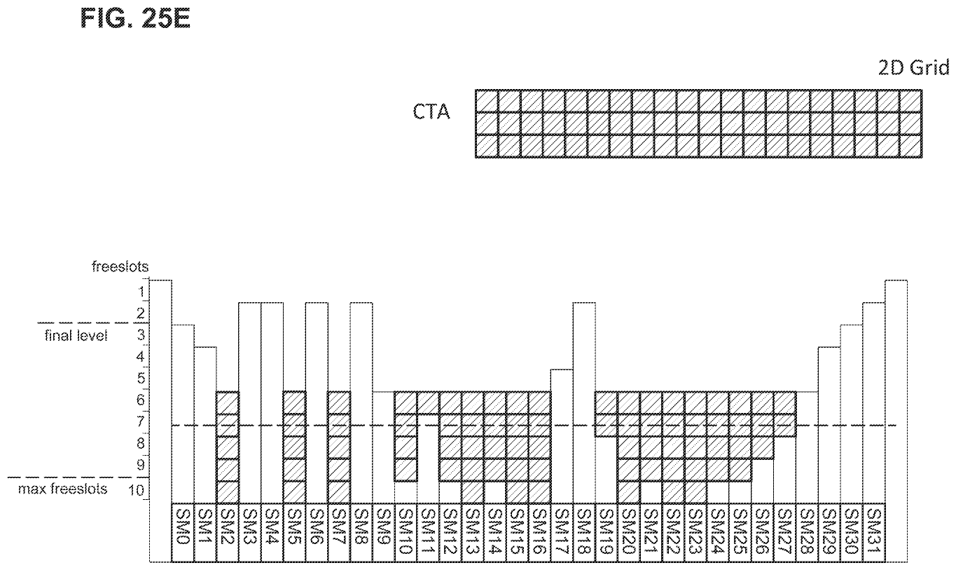

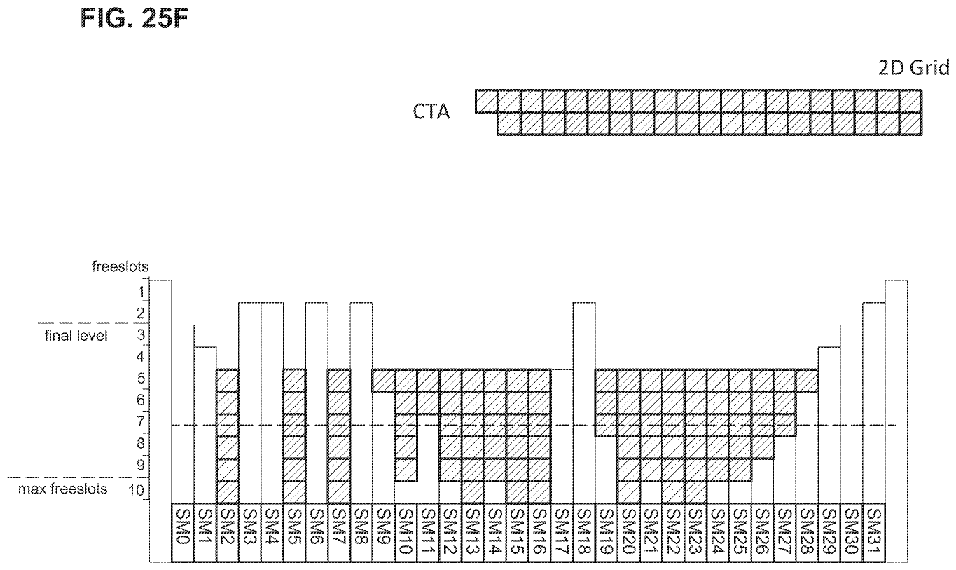

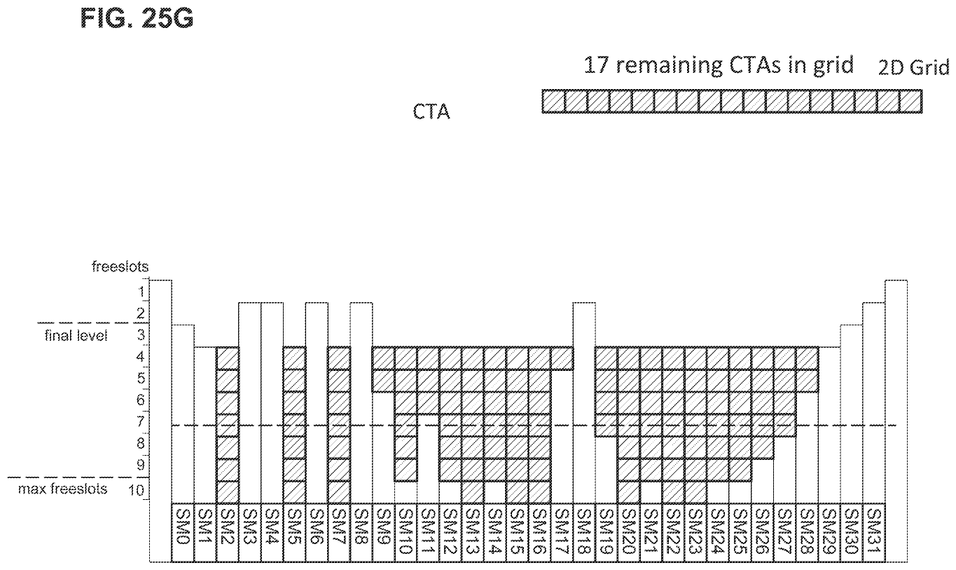

That is, in one embodiment, all GPCs with the same maximum speed receive a CGA at once. In FIG. 25C, both GPC2 and GPC3 are receiving CGAs simultaneously. On top of that, each CGA launch consists of simultaneous multiple CTA launches. It can thus be seen that in example embodiments, multiple CTAs are scheduled at once (at the same time) as opposed to one at a time.

Scaling Based on Multi-Dimensional IDs and Grid Rasterization

As discussed above, for various reasons, each CTA in the example embodiment is assigned a multi-dimensional ID that the CTA and the GPU can use to identify the CTA and associate the CTA with data and other resources. For example, as described above, for a data parallel programming model, each CTA is associated with data that supports execution of the CTA. The CTA may for example query a multi-dimensional ID to find the data assigned to it. For example, if an image filter grid is applied to a 3D image, each CTA may query a XYZ tuple to figure out which part of the image it should process. If hardware provides only an integer value as the ID, each CTA must perform costly divisions to decompose it to XYZ. Thus, it is helpful for hardware to generate multi-dimensional (e.g., XYZs) IDs as CTAs are launched to SMs. This multi-dimensional ID generation can be called “grid rasterization” because it resembles the act of scanning out pixels from a triangle on the screen in computer graphics algorithms.

Such grid rasterization becomes more complex when CTAs are part of CGAs since the multi-dimensional IDs assigned to CTAs should now also encode or identify or otherwise be associated with the CGA of which the CTA is a part.

Once the load balancing problem is solved with a centralized CWD 420 as described above, there can arise a problem of rasterization throughput; the mathematical operations to generate many multi-dimensional IDs at launch time may become a bottleneck. A related problem is CTA transmission bandwidth; even if the above problems are solved, it would be hard to transmit many IDs to SMs that are physically far from the centralized CWD 420. For example, in compute APIs like CUDA, a CTA ID is 3D and expressed as a 32b-16b-16b tuple. Transmitting 64b data to many SMs would require massive bandwidth.

The technology herein addresses both of these issues by distributing rasterization to the SMs rather than requiring the CWD 420 or other centralized hardware to perform rasterization. In particular, upon the SMs being informed by CWD 420 that they are being assigned new CTA work, the MPCs 404 within the SMs can be informed by broadcast information from other SMs of the XYZ ID assignments of all CTAs for all SMs. In one embodiment, the generation of these XYZ coordinates by the SMs is deterministic; for example, the X coordinate value may be incremented first, and then started again from an initial value once the Y coordinate is incremented, and similarly the Y coordinate value can be restarted from an initial value after incrementing the Z coordinate value. Each SM is programmed to perform this process independently based on broadcast launch packets it receives. This distributed ID coordinate assignment process relieves the CWD 420 of having to send any XYZ ID assignments to any SMs. The XYZ assignments are thus distributed across all SMs and can be performed concurrently by concurrently-executed hardware. The example embodiments further provide mechanisms described below for software to query the hardware to learn the XYZ ID assignments. This solution provides the best of both worlds: a centralized decisionmaking circuit for implementing the load balancing algorithm, and decentralized (distributed) circuits for performing detailed recordkeeping (CTA ID generation) once the CWD does schedule the CTAs for execution.

In one embodiment, the burden of ID generation is moved from CWD 420 to the SMs. CWD 420 performs load balancing and sends messages to the SMs selected by the load balancing algorithm to trigger CTA launch. In one embodiment, CWD 420 broadcasts all CTA launch messages to all SMs so that every SM can observe the entire sequence of CTA launches. Thus, each SM can tell the current rasterization location within the grid. This scheme solves the transmission bandwidth issue, because CWD-to-SM traffic does not have to carry multi-dimensional IDs anymore.

A naïve implementation of this idea would still leave a rasterization throughput problem because even if all SMs do rasterization in parallel, every SM would consume the same amount of time as the case where CWD did the same computation. To solve this problem, each SM calculates multi-dimensional IDs only once in a while. Most of the time, it simply counts the number of CTAs since the multi-dimensional ID was last calculated. Let's call the count delta (Δ). And when the multi-dimensional ID is absolutely required, namely when the SM launches a CTA or the delta (Δ) overflows, the SM decomposes the delta (Δ) into a multi-dimensional version, then add the decomposed delta (Δ) to the last calculated ID. This technique solves the rasterization throughput issue. Here is a 3D example.

a) Steps to decompose delta to XYZ. In the code, gridDim.X and Y are the X and Y dimensions of the grid, respectively. “%” is the modulo operator like C++. Note that, since we can keep the precision of delta low, these divisions do not require expensive logic.

Zdelta=delta/(gridDim.X*gridDim.Y)

delta_tmp=delta%(gridDim.X*gridDim.Y)

Ydelta=delta_tmp/gridDim.X

delta_tmp=delta_tmp%gridDim.X

Xdelta=delta_tmp

b) Steps to update the current X, Y, and Z

Xcurrent=Xcurrent+Xdelta

If Xcurrent>=gridDim.X then Xcurrent−=gridDim.X and C=1 else C=0

Ycurrent=Ycurrent+Ydelta+C

If Ycurrent>=gridDim.Y then Ycurrent−=gridDim.Y and C=1 else C=0

Zcurrent=Zcurrent+Zdelta+C

This algorithm is capable of realizing a peak CTA launch throughput for typical cases that is improved by the factor of 36×compared to prior approaches for assigning multidimensional IDs to CTAs in a centralized fashion.

Detailed Implementation of CWD 420

In one embodiment, CWD 420 receives tasks from a front end 212 for various processes executing on the CPU that is cooperating with the GPU. In example embodiments, each task may correspond to a CGA. Each process executing on the CPU can issues such tasks.

In example embodiments, a scheduler 410 receives tasks from the front end 212 and sends them to the CWD 420 (FIG. 16, blocks 502, 504). The CWD 420 queries and launches CTAs from multiple CGAs. It works on one CGA at a time in one embodiment but in other embodiments coordinated parallelism is possible. In one embodiment, for each CGA, CWD 420 speculatively launches all of the CTAs in the CGA against a shadow state defined by a query model, as described above (using a hardware-based model of the GPC rather than the actual GPC as shown in FIG. 16B), incrementing the “launch” registers to store the speculative/shadow state launch (see FIG. 16B). If all free slots in SMs or other processors in the hardware domain are exhausted before all CTAs of the CGA are speculatively launched against the shadow state the query model defines, the CWD 420 terminates the launch and may try again later. If, in contrast, there are sufficient free slots for all CTAs in the CGA, the CWD 420 generates sm_masks from the “launch” registers accumulated in the speculative/shadow state launch process (this sm_masks data structure stores reservation information (FIG. 16A, block 2010; see FIG. 16B) for each CTA to be run on each SM in the relevant hardware domain for the CGA launch), and moves on to a next CGA. The hardware allocates a CGA sequential number and attaches it to each sm_mask, which specifies which SM gets which CTA at launch. It also attaches an end_of CGA bit to the last one to prevent interleaving of sm_masks from different CGAs. In one embodiment, launch packets sent to SMs can contain multiple CTA launch instructions for each sm_mask—increasing performance by no longer requiring a one-to-one correspondence between launched CTAs and launch packets. It should be noted that in one embodiment, CWD 420 maintains two models of the entire GPU—one which is constantly updated, and another which is a snapshot of the constantly updated model which defines a shadow state and is used for speculative launch. This arrangement works so long as the speculative launch load balancing session occurs very quickly, i.e., before it is statistically likely that the snapshot becomes sufficiently outdated to cause major inefficiencies (CWD 420 controls all launches, so the only inaccuracies are that some CTAs may complete and the SMs that were executing them accordingly become available, and this is not taken into account in the ongoing load balancing session using the now-outdated model).

In one embodiment, a GPU CGA sequential number is attached to the launch command, and is prepended to the eventual sm_mask generated for each GPC CGA. This GPU CGA sequential number is used to map an sm_mask of every GPC CGA to the GPU CGA and is used by any reorder unit before sending masks to the M-Pipe Controllers (MPCs) 404 within individual SMs. The hardware thus may provide multiple iterative waves of masks to determine when all CTAs in the CGA are mapped to SMs such that the CGA can launch. Once the SM masks are ready, they are broadcast (with the associated CGA ID) to all SM work schedulers of the GPU (see FIG. 16B). Also broadcast are lmem_blk_idx packets which carry lmem_blk_idx (see LMEM block index table 432 of FIG. 14) from CWD 420 to the SMs. These operations accomplish the actual launch on real hardware.

FIG. 15 shows that in one embodiment, the CWD 420 comprises two levels of work distributors (WDs) to distribute GPU CGAs made up of GPC CGAs:
a GPU2GPC work distributor 420a
a plurality of GPC2SM work distributors 420b(0), 420b(1), 420b(2), . . . as described above, the first level 420a distributes GPC CGAs across GPCs. The second level (GPC-to-SM work distributors 420b) distributes CTAs to SMs within the GPCs. Another level that precedes or is higher than the GPU-to-GPC level could be used to distribute μGPU CGAs to μGPUs (in one embodiment when there is μGPU, a GPU is made up of μGPUs, μGPUs are made up of GPCs, and GPCs are made up of TPCs or SMs).

The GPU2GPC WD 420a distributes the potentially numerous (1 or more) constituent GPC_CGAs of a GPU_CGA to corresponding GPC2SM work distributors (FIG. 16, block 506). The GPC2SM work distributors 420b each distribute the CTAs of a GPC_CGAs to SMs within the GPC (using for example a load balance mode or multicast mode, as described below). The unified work distributor (UWD) 420a/420b of FIG. 15 guarantees that all GPC_CGAs in a GPU_CGA can be launched together and that all CTAs in each GPC_CGAs can be launched together. In other embodiments supporting deeper nesting of CGAs, this UWD can be expanded to any number of levels needed (or example, to add a GPC-to-CPC hierarchy) and any number of simultaneously-scheduled hardware scopes of any hierarchy.

In one embodiment, the UWD 420a, 420b performs the following processes:

I. Speculative Launch of a CGA (FIG. 16, block 508)

Phase 1:

The first step is a state snapshot: read the remaining number of GPU CGAs from task table 436 (FIG. 14), and clamp it based on remaining_GPU_CGAs. A load balance session can be limited to one GPU_GPC_CGA at a time in one embodiment.

Phase 2:

For a GPC CGA, the CWD 420 performs a query+launch process until there are no more remaining GPC CGAs, where “query” constitutes a “speculative” (“shadow state”) launch against a query model and “launch” constitutes the actual launch. Thus, in one embodiment, the “speculative” or “query” launch is performed on shadow state against a query model but no actual launch is yet performed (in other embodiments e.g., with duplicate hardware, “speculative” may refer to an operation which is actually performed, but which is done so before it is known whether or not it will be valid, such as in “speculative execution”). In one embodiment, the “query” is completed for all CTAs in the CGA structure before any CTAs are launched. For example, in the case of a GPU CGA with multiple GPC CGAs, the CWD 420 will launch the GPU CGA only if all of its constituent GPC CGAs are guaranteed to receive free slots across the GPU. In order to ascertain that, each constituent GPC CGA (of the GPU CGA) is speculatively launched and checked (but not actually launched to SMs) before any CTA is launched.

In one embodiment, each GPU CGA may be processed in two passes:

Pass I: Speculative Launch to “Check if all Constituent GPC CGAs Will Find a Home”

Say the number of GPC CGAs in a GPU CGA is “N”. To ascertain the above, the CWD 420 speculatively launches N GPC CGAs.

Referring to FIG. 15, GPU2GPC WD 420a sends query commands to all GPC2SM WDs 420b. Each individual GPC2SM performs speculative scheduling for all CTAs of a GPC CGA assigned to it and generates a speedy and valid response for the query. In an example embodiment, since the speculative launch test will be repeated for each GPC CGA within a GPU CGA, each GPC2SM includes a free slot register and a launch slot register per SM to store its prior responses. In implementations that have a single free slot and launch slot register per SM, the free slot value per SM used in an iteration after the first speculative scheduling of a GPC CGA may be “free slot value”-“current launch slot value” to account for already speculatively scheduled CGAs.

GPU2GPC WD collects the responses from the GPC2SM WDs, counts the number of “valids” and accumulates to a counter. This completes a first query iteration. The GPU2GPC WD continues to query all GPC2SM WDs again until the counter reaches the number of GPC CGAs per GPU CGA. If the GPU2GPC WD fails to collect enough “valids”, the GPU2GPC WD will terminate the session because there are not enough free slots to guarantee all CTAs in all GPC CGAs in the GPU CGA can be launched together (FIG. 16-2, “no” exit to decision block 510).

In some embodiments, different GPCs can have different numbers of SMs. In one embodiment, CWD 420 may also implement a counter per GPC to track the number of GPC CGAs that can simultaneously execute on a given GPC. Each counter is initialized based on the number of SMs in a corresponding GPC (e.g., for a given chip number). CWD 420 decrements the appropriate GPC counter whenever a new GPC CGA is launched, and increments the appropriate counter whenever a cga_complete packet arrives from a given GPC.

In example embodiments, CWD 420 may distribute CTAs in a GPC_CGA to SMs/cores within GPCs using different hardware-based modes described above:
LOAD_BALANCING—(described above) CTAs are sent to the least loaded SMs/cores within a GPC or other hardware domain. This mode allows the CWD 420 to place the CTAs anywhere within the GPC or other relevant hardware domain. For example, this may result in more than one CTA (or even all CTAs for small CTAs) from the same CGA running on the same SM.
MULTI CAST—CWD 420 distributes CTAs across SMs/cores within a GPC or other relevant hardware domain with at most one CTA per SM from the same CGA. This mode guarantees that each CTA will run on a different SM—meaning that all the interconnections and resources provided by those plural SMs can be brought to bear on executing the CGA. In one embodiment, CTAs are scheduled first onto partitions where both (all) SMs/cores can take a CTA, then onto partitions with only one (less than all) SM(s) available.

MULTI_CAST mode guarantees CTAs are well distributed across SMs/cores (rather than allowing multiple CTAs on the same SM) which provides the maximum interconnect resources for the CGA. MULTI_CAST mode may for example be used on GPC_CGAs that want to take advantage of the new multicast hardware and software in the SM and generic network interface controller (GNIC), for example the Tensor Memory Access Unit (TMA) as described in above-identified U.S. application Ser. No. 17/691,276 (Atty. Dkt. No. 6610-91//20-SC-0403US01) filed Mar. 10, 2022, titled “Method And Apparatus For Efficient Access To Multidimensional Data Structures And/Or Other Large Data Blocks”. More information about the MULTI_CAST approach may be found in above-identified U.S. application Ser. No. 17/691,288 (Atty. Dkt. No. 6610-97//20-SC-0612US01) filed Mar. 10, 2022, titled “Programmatically Controlled Data Multicasting Across Multiple Compute Engines”.

Pass II: “Reset. Then, Query+Launch”—Actual Launch of the CGA (FIG. 16-2, Block 512)

If Pass 1 (speculative launch) succeeds, guaranteeing enough free resources for the entire GPU CGA, the CWD 420 begins Pass 2=> which is the actual launch. This involves:
resetting all GPC2SM WDs' launch slot registers;
allocating a GPU CGA sequential number (for reordering);
launching the constituent GPC CGAs (of the GPU CGA) one by one; and
repeat “query” and “launch” for each of the GPC2SM WDs to launch the CTAs in each GPC CGA on the SMs.

In example embodiments, the CWD 420 is also responsible for allocating CGA memory slots in a linear memory pool and flushing and recycling slots. Assuming CWD 420 determines there are enough resources and phase 2 above is completed or is proceeding, CWD 420 passes information to GPM function circuit blocks which reside within the GPCs. Each GPM allocates a barrier slot, and also allocates the CGA id and tracks when all CTAs in a GPC CGA complete. The MPC (M-Pipe Controller) circuit 404 within each SM meanwhile tracks slots per CTA, and participates in launching the CTA onto an associated SM to actually do the work. In this context, the CWD 420 in one embodiment acts like a dealer in a card game, and the SMs are participants in the card game. It's the job of CWD 420 to distribute the “launch” cards to each SM “player” in the game. Meanwhile, all of the SMs are watching the cards being distributed to each other SM, so that when an SM finally receives its own launch card, it can scribble the XYZ ID value it comes up with onto the card based on broadcasts it has received previously during the game. Any new SM can participate in the game just by being told what the current XYZ ID value last assigned by another SM is. In one embodiment, there is also a state synch where the CWD 420 sends down certain dimensions of the bundles or grids, and then at time of launch the CWD communicates the current XYZ offsets to any new SMs and their associated internal MPCs. In other embodiments, each new arriving grid could prompt a reinitialization of the XYZ ID coordinates.

When the work is done, the SM reports CTA complete status to GPM. When the GPM circuit receives status information that all the CTAs in the CGA have completed (FIG. 16-2, block 514) and all memory allocations to the CGA have been flushed (FIG. 16-2, block 516), the GPM circuit can signal the CWD 420 to free the CGA memory slot in the pool so it can be allocated to another CGA (FIG. 16-2, block 518).

Using the above technique, the application program can launch many small CGAs in a GPC or other hardware partition but the number diminishes as the size of the CGA grows. At a certain point (depending on the hardware platform), no CGA can fit in the GPC or other hardware partition anymore, which may compromise code portability. If one assumes that every platform has at least one GPC with 4 TPCs, the maximum CGA size that guarantees compatibility across future architectures is 8 CTAs. A given application program could dynamically adjust CGA size based on querying the platform to determine the number of CGAs that can run concurrently in the GPU as a function of 1) CTA resource requirements and 2) number of CTAs per CGA.

CTA Allocation and Tracking

Example hardware implementations provide a new S2R register in each SM that helps to track CTAs within a CGA (i.e., to allow a CTA to determine which CTA within a CGA it is). In one embodiment, the SM implements S2R (Special Register to Register) operations to return a linear CTA ID within CGA. In particular, an additional hardware-based multi-bit identifier called gpc_local_cga_id (the number of bits used may depend on the number of simultaneously active CGAs that are supported) is used to identify the CGA within the namespace of the GPC and to track the number of active CTAs for that CGA. This same value gpc_local_cga_id may for example be used to index distributed shared local memory, to reference barriers and other inter-CTA communications mechanisms.

The S2R register enables the shader software to read the gpc_local_cga_id for this thread. The Gpc_local_cga_id is allocated on every GPC_CGA launch to local GPC, and is broadcast across the relevant hardware domain upon CGA launch. It is tracked during the lifetime of the CGA and will be freed when the last thread group in the CGA completes. In one embodiment, hardware allocates a unique gpc_local_cga_id whenever it sees the first packet of a GPC CGA launch (see below), and then tracks all active GPC CGAs within its local GPC. The hardware recycles the gpc_local_cga_id whenever it receives shared memory flush indications for all the CTAs in the GPC_CGA. The hardware maintains a free list or free vector of available gpc_local_cga_id's, and stalls CGA launches if it runs out of gpc_local_cga_id's.

In the example grid discussed above and shown in FIG. 12A, the CTA labeled “C” needs to be able to tell (learn) which CTA it is within the six-CTA CGA once assigned by hardware (i.e., each cooperative thread array is now part of an ordered cooperative group array). Knowing the dimensions of the whole grid and the dimensions of the various locality grid hierarchies discussed above, it is possible to convert the coordinates of the CTA within the whole grid to the coordinates of that CTA within its CGA. In example embodiments, each Grid or CGA is defined in term of the next level in the hierarchy using 3 dimensional coordinates. Each CTA exposes its CTA id (X,Y,Z) to software in the shader via hardware registers as discussed above. For GPC_CGAs, the new S2R hardware register may be used to determine or discover the 1-dimensional CGA_CTA_id within the GPC_CGA that is preset by the launch procedures. In one embodiment, this CGA_CTA_id may be used directly for a shared memory index (this is useful when addressing shared memory, since each segment of shared memory may be referenced using its corresponding CGA_CTA_id).

The FIG. 12A example is for CTA #C within a grid containing GPC_CGAs, with the coordinate for the CTA within the whole grid being (7, 3, 0) but the CGA_CTA_id within the GPC_CGA being the one-dimensional coordinate CgaCtald=4. The programming model based on a 3D coordinate within the whole grid is thus maintained, while providing an additional coordinate for the CTA within its CGA.

CGA Tracking

In one embodiment as shown in FIG. 13, GPM tracks the total number of active CTAs in the CGA. For example, when the CGA launches, GPM sets a count to the total number of CTAs in the CGA that have launched. When MPC indicates that a CTA has exited, GPM decrements the count. When the count has decremented to zero (meaning that no more CTAs in the CGA are active), GPM determines the CGA has completed. But in example embodiments, GPM does not yet release the CGA ID to the pool for reuse. This is because even though all CTAs in the CGA have completed, it is still possible that some outstanding DSMEM (distributed shared memory) access requests may exist. Accordingly, the example embodiments provide protocols to make sure the CTAs in a CGA have completed all their DSMEM memory accesses (and other accesses) prior to releasing a CGA ID associated with those CTAs. In one embodiment, the GPC does not release the CGA ID until every CTA in the CGA has exited and all of their memory instructions/accesses have completed.

This is done to prevent a new CGA from reading or writing (or receive a read or write from) a defunct CGA that previously used the same CGA ID. In one embodiment, the gpc_local_cga_id provides protection against this because there can be no DSMEM accesses in flight from a non-current user of the CGA ID when a new CGA launches.

As discussed above, when a CGA finishes executing, the hardware based scheduler (GPM) releases the resources (e.g., shared memory, warp slots needed to run on an SM, etc.) formerly used by the CGA so the CWD 420 can reassign the resources to launch new CGAs. Similarly, when a CTA finishes executing, the hardware based scheduler (GPM) releases the resources (e.g., shared memory, warp slots needed to run on an SM, etc.) formerly used by the CTA. Once a CTA finishes, a protocol is used to fault any DSMEM memory accesses to that CTA's shared memory. In one embodiment, when the all of the CTAs in a CGA finish executing, the hardware based scheduler retains the CGA ID and sends a DSMEM memory flush (FIG. 16-2, block 516) to each of the SMs that was running a CTA in that CGA and then waits for a response. Once all of the SMs that were running CTAs in the CGA confirm the memory flush of shared memory formerly allocated to the CGA, GPM finally can release the CGA ID to a reuse pool.

On the launch side, each CTA in a CGA needs to know where all the other CTAs in the CGA are executing so the CTA can send transactions to those other CTAs. This mapping information is programmed during launch.

Mapping Tables within SMs

Gpc_local_cga_id

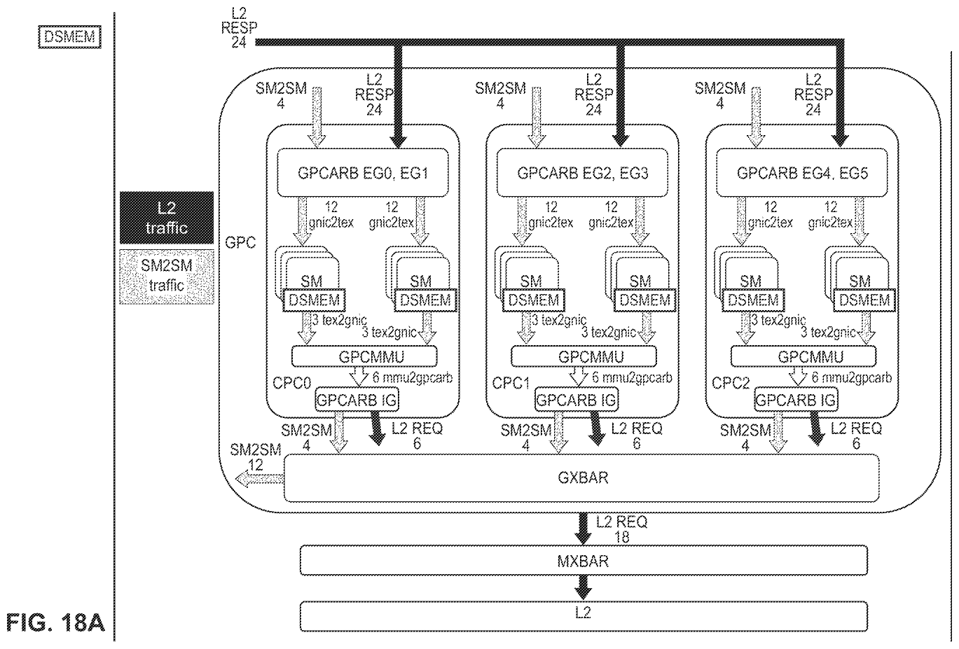

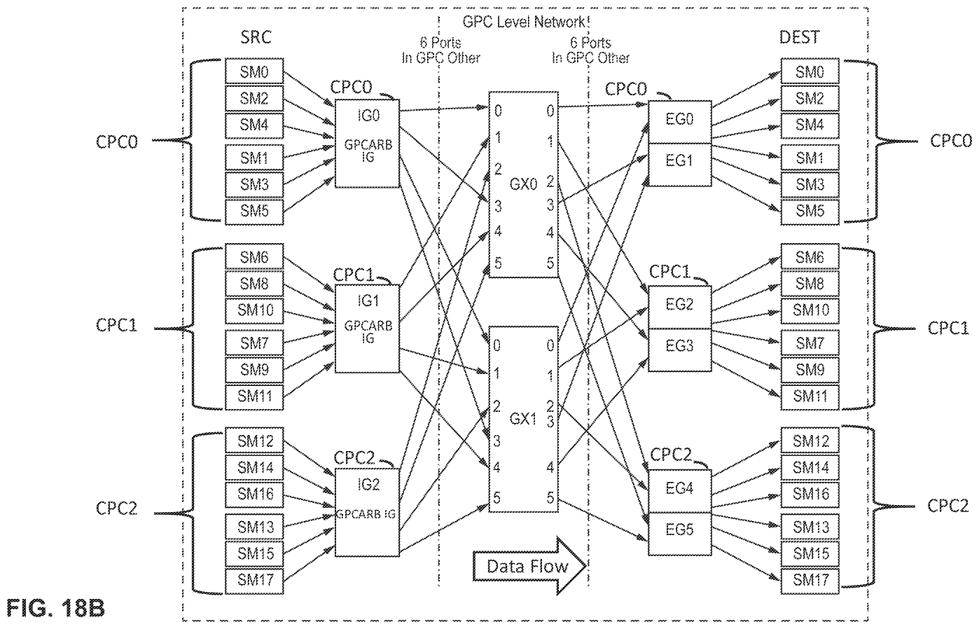

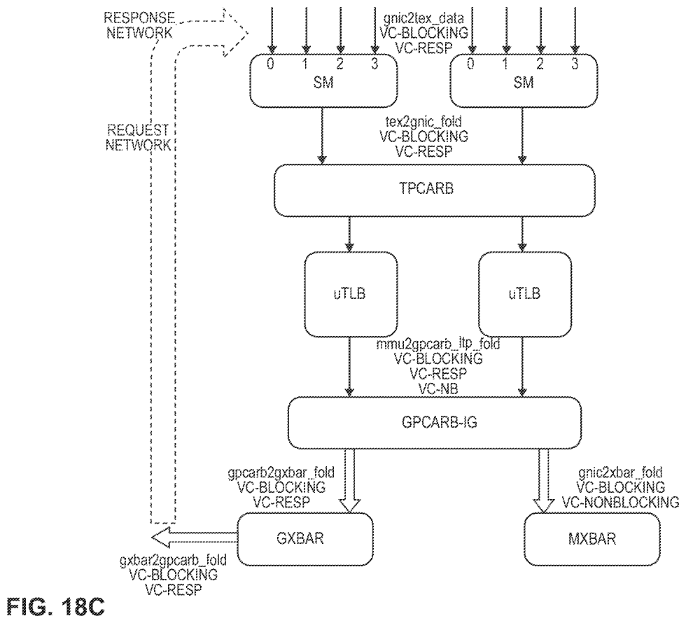

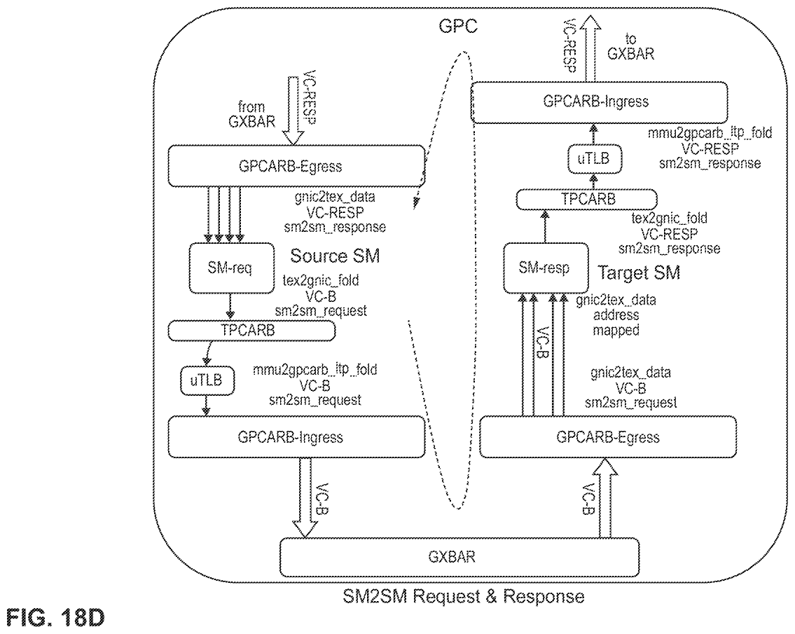

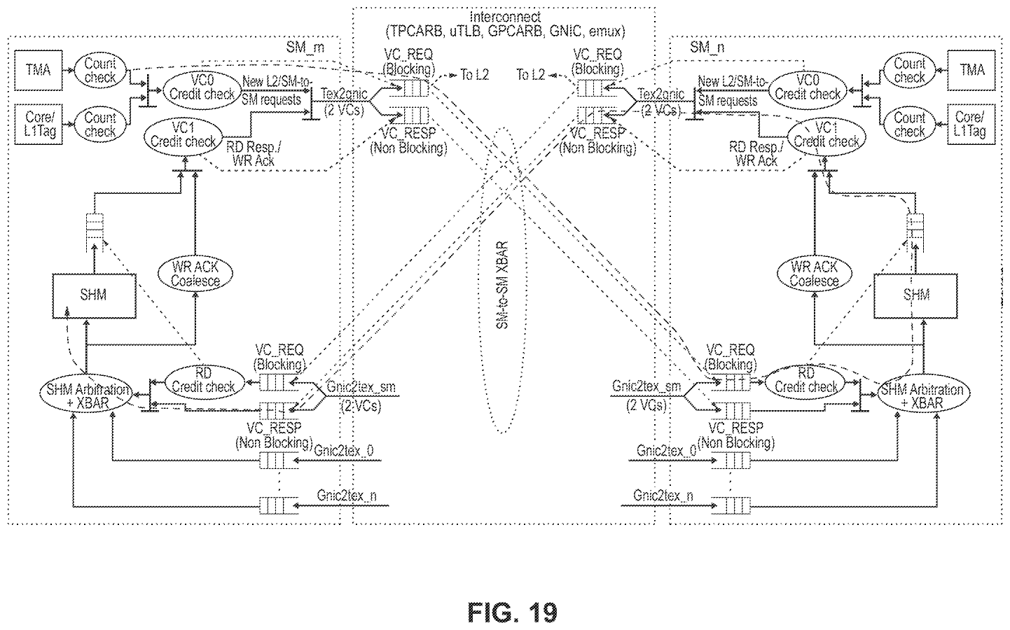

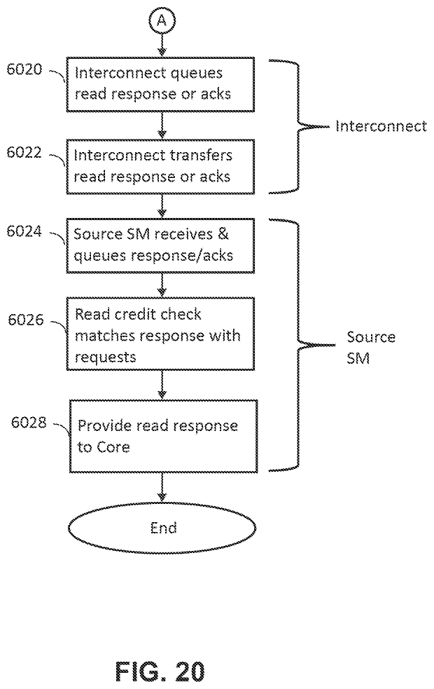

FIGS. 18A-18B and 19 show different views of the example embodiment architecture used to allow SMs to communicate with other SMs. One of the messages that an SM can communicate to another SM is the local_cga_id of a CTA the SM is executing. In one embodiment, the packet format of such an SM-to-SM message includes a U008 field “gpc_local_cga_id”. Each GPC has its own pool of CGA IDs, and GPM allocates one of those numbers to a CGA upon launch of that CGA. This assigned number then serves e.g., as a pointer into the DSMEM distributed memory segments that are being used by the various CTAs in the CGA. In one embodiment, the “gpc_local_cga_id” also serves as the id for tracking barrier state for each GPC_CGA.

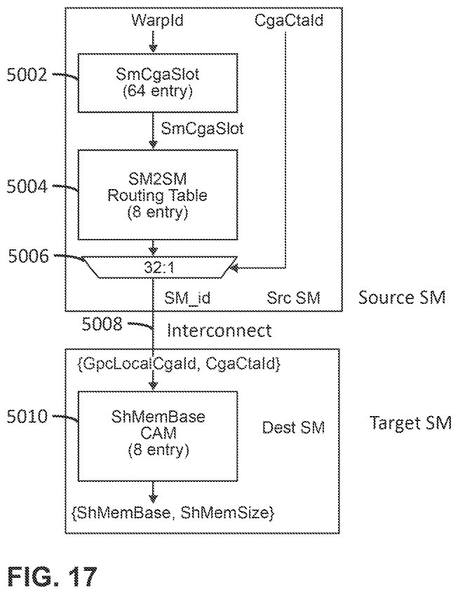

FIG. 17 shows an example mapping table arrangement maintained by each SM. In one embodiment, the SM determines the target based on the segmented address and then chooses the correct packet type to let the interconnect know this is a SM2SM transaction, and provides the physical SM id based on lookup in the routing table as shown in FIG. 17. In one embodiment, the SM maps the logical CTA ID within the GPC_CGA to the physical SM on which the CTA is running, and that CTA's physical shared memory on the SM. Each time a CTA launches, all of the SMs on the GPC may need to know about it because any one of those SMs might be executing a CTA that is part of the same CGA. In one embodiment, MPC 404 informs (broadcasts a message to) all of the SMs each time a new CTA is launched. In response, each SM updates the mapping table it maintains. In one embodiment, a CAM structure is used for this mapping to allow DSMEM addressing from remote (other) SMs. As FIG. 17 shows, the CAM structure is stored in RAM as an SM-to-SM mapping table 5004 that is indexed by a SMCGAslot value. Mapping table 5004 identifies to the SM which other SMs the other CTAs in the CGA are executing on. Pseudocode defining the 5004 example table is shown below:

CTA_ID −> CGA_ID, SM_ID, and TPC_ID
// Directory to find SM ID in GPC from CTA ID in CGA
// Source SM looks up this directory to find destination SM
struct {

| | |
|---|---|
| U008 gpc_local_cga_id; | // GPC local CGA id |

```
    struct {
        U004 tpc_id;
        U001 sm_id_in_tpc;
```

| | |
|---|---|
| } sm_id_of_cta_in_cga [j]; | // at most j CTAs per CGA |
| } cga_cta2sm_dir [k]; | // at most k CGAs per SM |

In this example, gpc_local_cga_id is thus used as a local CGA ID that all of the SMs in the CGA can refer to. The table allows each SM to look up the tpc_id and the sm_id_in_tpc, which is effectively the address of another SM. The index to this structure is the (logical) CTA ID in the CGA (this ID is local to each CGA). Thus, given the slot ID indicating which CGA (of all the CGAs that might be running) and a logical CTA ID, the SM can look up the SM_id of that other SM that is running that CTA so it can communicate across the interconnect with that other SM for a transaction involving for example the DSMEM segment allocated to that CTA on that other SM.

The table 5004 continues to be updated as additional CTAs are launched and complete, with each SM maintaining its own mapping table 5004 over time. Meanwhile, hardware (MPC and GPM in cooperation with the SMs) prevents a CGA synchronization barrier from being active until all CTAs in a CGA have launched and all SM's have received broadcast information to construct their mapping tables 5004 in order to prevent any CTAs in the CGA from being left out of the barrier synchronization regime.

In one embodiment, a second table 5002 as shown in FIG. 17 is maintained by each SM to map warps to CGA slots. In particular, the SMs own internal warp scheduler schedules execution slots in terms of warps (for example some number such as 64 warps may be running on any given SM at the same time). The SM maintains mapping information to map the warp number to the CGA_slot information. Thus for example, a warp on one SM can issue an LD instruction that is mapped into DSMEM of another SM that is executing other warps (CTA(s)) of the same CGA. It first identifies a CGA_slot using table 5002, and then uses the table 5004 to determine which SM to pass the instruction to. In summary, in the source SM, when a CTA (SM's physical warp ID=X) accesses shared memory of another CTA (addressed by logical cta_id=A in the same CGA), the CTA first looks up bl_table to obtain sm_cga_slot, then looks up cga_cga2sm_dir to obtain gpc_local_cga_id and sm_id of the destination SM (a tuple of tpc_id and sm_id_in_tpc), per the following pseudocode: gpc_local_cga_id=cga_cta2sm_dir[bl_table[X].sm_cga_slot].gpc_local_cga_id; destination_sm_id=cga_cta2sm_dir[bl_table[X].sm_cga_slot].sm_id_of_cta_in_cga[A];

The source SM then uses gpc_local_cga_id and sm_id per the instruction format above to direct an instruction across the interconnect 5008 to a location within the target SM's DSMEM.

FIG. 17 also shows the request as received by the target SM across the interconnect 5008. When the target SM receives the request, it can perform a lookup using table 5010 as described in the pseudocode below to find the DSMEM base and size:

| | |
|---|---|
| • | Incoming to SM, CAM match [gpc-local CGA_ID and CTA_ID in the CTA] to |
| | find shared memory base and size |

//Table in remote (destination) SM
//CAM to look up shared memory base from gpc_local_cga_id and cta_id_in_cga
struct {

```
  struct {
    U008 gpc_local_cga_id;
    U005 cta_id_in_cga;
```

U001 is_valid;

| | |
|---|---|
| } look_up_tag; | // tag of CAM look up |

U011 shared_memory_base;
U018 shared_memory_size;

| | |
|---|---|
| } shmem_base_CAM[k]; | // at most k CGA enabled CTAs per SM |

The target SM matches on the gpc_local_cga_id and the cta_id_in_cga (note: the cta_id_in_cga is included because there can be more than one CTA of a CGA running on a given SM). If there is a match, a valid lookup tag is generated (if there is no match, this may mean the CTA is no longer running on the SM and the receiving SM accordingly generates an error notification which it sends to the originating SM). Assuming a valid lookup tag, the table is then used to look up the DSMEM base and size in the physical storage that holds shared memory (DSMEM allocations are relocatable and so could be anywhere in the physical store). As noted above, the table 5010 (which may be a content addressable memory or CAM in some embodiments) can be replicated in hardware to provide multiple concurrent lookups. The target SM will then check the offset that came with the instruction, ensure it is within range, and then perform the read, write, atomic operation or other requested action on the specified DSMEM memory offset. If the instruction specifies an offset that is out of range, the error is detected and the source SM is notified of the error.

CGA/CTA Exit and Error Handling Protocols

In one embodiment, certain kinds of errors are not attributable to the program counter (PC). Normally, embodiments would retain a FIFO of past PCs and can associate any memory error with a given warp, thread and PC. The PC can fall off the end of the FIFO when it is determined that there are no errors attributable to that PC. However, some types of errors are detected or detectable at a target SM but are not detected or detectable by the source SM and thus cannot be associated with the PC of the source SM. Such errors for example may include “CGA/CTA not found” at the target or in particular the target SM detecting gpc_local_cga_id and cta_id_in_cga is not in the shmem_base CAM (usually because the CTA has already exited), or the target SM detects out of bound addresses such as Address Offset>shmem_base+shmem_size (e.g., due to early release by the target SM of part of its DSMEM shared memory allocation to the CGA). To handle such errors, one embodiment does not report errors to the target or destination SM but instead makes the target SM responsible for reporting such errors to the source SM using error messaging similar to the acknowledgement messaging. Upon receipt of an error packet, the source SM posts the error and attributes it to the CGA but does not necessarily attribute it to a particular warp and/or PC because this information may no longer be available. At the source SM, a trap handler can read gpc_local_cga_id and cta_id_in_cga of the bad warp using the SR registers. If the CGA has already exited (which is possible for stores and atomics), the error may be ignored/dropped since it is now moot.

Other types of errors detectable on the source SM side can provide a valid warpID and PC, for example:
Cta_id_in_cga>max number of CTAs in a CGA
Cta_id_in_cga has an invalid SM_id in the SM2SM table
Address offset>maximum shared memory size possible

CGA Exiting

In one embodiment, a CGA exiting is a multi-step process. First, the SM running a CTA detects that a warp has sent a Warp_exit command. This means the CTA wants to exit, but as discussed above, DSMEM SM-to-SM writes and CGA writes to L2 linear memory may still be inflight. Accordingly, the CTA does not actually exit but instead MPC is notified and the CTA waits for MPC to grant permission to exit. When all warps in a CTA complete, MPC sends an inval_cta_entry to the SM to invalidate the CGA shared memory sm_cga_cta_slot CAM entry shown in FIG. 17. MPC then sends a cta_complete to GPM and CWD and marks the CTA as needing a memory flush. When all CTAs in the CGA complete, MPC deallocates CGA resources including sm_cga_slot, and issues a DSMEM flush to the SM. After receiving an acknowledgement that the flush is complete, MPC sends a dsmem_flush_done. In response, GPM recycles gpc_local_cga_id after dsmem_flush_done is received from all CTAs in the CGA, and sends cga complete to CWD.

Thus, while the CGA thread block grouping construct is useful for guaranteeing concurrency and load balancing across SMs, other techniques for guaranteeing concurrency could be used instead or in combination. For example, some embodiments might use a software arrangement such as Cooperative Groups API to arrange for concurrency and load balancing across a collection of thread blocks, or still other techniques could be used to provide or guarantee concurrency within and load balancing across the same relevant hardware domain or partition of the GPU hardware (e.g., all the threads that make use of the distributed shared memory are not just running concurrently, but can be launched and found on SMs all of which are within a particular hardware domain such as a sub-portion of a GPU referred to as a GPC for example, as individual threads could test for by querying which GPC the threads have been launched on). While such other techniques are possible, the CGA hierarchy provides certain advantages in terms of efficiency and certainty.

All patents, patent applications and publications cited herein are incorporated by reference for all purposes as if expressly set forth.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A processing system including:
a set of processors, and
a work distributor that distributes thread blocks to the set of processors for execution, the work distributor being configured to:
(a) balance loading of the thread blocks across the set of processors, and
(b) guarantee the set of processors can execute the thread blocks concurrently,
wherein the respective thread blocks are assigned identifier coordinates for execution on the processors.

2. The processing system of claim 1 wherein the thread blocks are represented by a grid, and each of the processors is configured to rasterize a respective portion of the grid.

3. The processing system of claim 2 wherein the grid comprises a three-dimensional grid.

4. The processing system of claim 1 wherein the processors comprise streaming multiprocessors and the work distributor comprises a hardware circuit.

5. The processing system of claim 1 wherein the work distributor comprises a first work distributor configured to distribute work across a collection of processors, and a plurality of second work distributors structured to assign work to individual processors.

6. The processing system of claim 1 wherein the work distributor includes a query model of the set of processors and uses the query model to launch the thread blocks against a shadow state of the set of processors to test whether the thread blocks can launch concurrently.

7. The processing system of claim 6 wherein the work distributor maintains a live query model that is updated continually, and a further query model that stores a shadow state.

8. The processing system of claim 6 wherein the work distributor uses the query model in an iterative or recursive manner to test launch of multiple hierarchical levels of thread block groups.

9. The processing system of claim 1 wherein the work distributor load balances the thread blocks across the set of processors by simultaneously selecting more than one processor to launch thread blocks onto.

10. The processing system of claim 1 wherein the respective thread blocks are part of a Cooperative Group Array (CGA).

11. The processing system of claim 10 wherein the work distributor selectively does not launch more than one thread array that is part of the common array on any one of the processors.

12. The processing system of claim 1 wherein the set of processors each comprise hardware that independently derives or calculates a unique thread block identifier.

13. The processing system of claim 1 wherein the work distributor is configured to determine, based on respective loading levels of the processors, which processors are likely to execute new work the fastest.

14. A processing method comprising:
receiving a grid representing a cooperative group array of thread blocks;
speculatively launching the thread blocks including load balancing the thread blocks across a set of processors based on occupancy level; and
if the speculative launching reveals the grid will execute concurrently on the set of processors, launching the thread blocks on the set of processors.

15. The processing method of claim 14 further including each of processors rasterizing the grid in a distributed manner.

16. The processing method of claim 15 further including broadcasting thread block assignments to processors, each processor rasterizing the grid by determining a global progression of multi-dimensional identifiers in response to the broadcasting and generating a multi-dimensional identifier in the global progression for its own thread block assignment.

17. The processing method of claim 14 wherein the speculative launching is performed by a hardware circuit.

18. The processing method of claim 14 including performing the load balancing across the processors.

19. The processing method of claim 14 wherein grid is three-dimensional and the identifier is three-dimensional.

20. A processing system comprising:
a launch test circuit connected to receive instructions to launch a thread group array, the launch test circuit configured to determine whether all thread groups in the thread group array can execute concurrently on a set of processors at least some of which are already executing other tasks; and
a launch circuit that, conditioned on the determination by the launch test circuit that all thread groups in the thread group array can execute concurrently, concurrently launches all the thread groups in the thread group array while balancing loading of the processors across the set.
